(19) United States
(12) Patent Application Publication
(10) Pub. No.: US 2024/0413858 A1
(43) Pub. Date: Dec. 12, 2024

(54) Apparatus and Method Configurable to Change Components of a Wireless Link

(71) Applicant: Fraunhofer-Gesellschaft zur Förderung der angewandten Forschung e.V., München (DE)

(72) Inventors: Jasmina MCMENAMY, Berlin (DE); Lars THIELE, Berlin (DE); Thomas HAUSTEIN, Berlin (DE); Paul Simon Holt LEATHER, Berlin-Schlachtensee (DE)

(21) Appl. No.: 18/810,849

(22) Filed: Aug. 21, 2024

Related U.S. Application Data
(63) Continuation of application No. PCT/EP2023/054698, filed on Feb. 24, 2023.

(30) Foreign Application Priority Data
Feb. 25, 2022 (EP) 22159039.1

(51) Int. Cl. H04B 7/04; H04L 45/24; H04W 24/10

(52) U.S. Cl. CPC H04B 7/04013; H04L 45/24; H04W 24/10

(57) ABSTRACT

A wireless communications network providing for wireless communication between a first entity and a second entity, the wireless communications is adapted to include a reconfigurable intelligent surface, RIS. The network comprises a controller unit preconfigured, configured or configurable for organising a contribution of the RIS to the wireless communication network.

### CROSS-REFERENCE TO RELATED APPLICATIONS

This application is a continuation of copending International Application No. PCT/EP2023/054698, filed Feb. 24, 2023, which is incorporated herein by reference in its entirety, and additionally claims priority from European Applications Nos. 22159039.1, filed Feb. 25, 2022, which is also incorporated herein by reference in its entirety.

Embodiments of the present application relate to the field of wireless communication, and more specifically, to wireless communication that is influenced by a reconfigurable intelligent surface, RIS. Some embodiments relate to using a reconfigurable intelligent surface, RIS, in a wireless communications network.

### BACKGROUND OF THE INVENTION

FIG. 1 is a schematic representation of an example of a terrestrial wireless network 100 including, as is shown in FIG. 1(a), a core network 102 and one or more radio access networks RAN1, RAN2, . . . RANN. FIG. 1(b) is a schematic representation of an example of a radio access network RANn that may include one or more base stations gNB1 to gNB5, each serving a specific area surrounding the base station schematically represented by respective cells 1061 to 1065. The base stations are provided to serve users within a cell. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles (UAVs), the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RANn may include more or less such cells, and RANn may also include only one base station. FIG. 1(b) shows two users UE1 and UE2, also referred to as user equipment, UE, that are in cell 1062 and that are served by base station gNB2. Another user UE3 is shown in cell 1064 which is served by base station gNB4. The arrows 1081, 1082 and 1083 schematically represent uplink/downlink connections for transmitting data from a user UE1, UE2 and UE3 to the base stations gNB2, gNB4 or for transmitting data from the base stations gNB2, gNB4 to the users UE1, UE2, UE3. Further, FIG. 1(b) shows two IoT devices 1101 and 1102 in cell 1064, which may be stationary or mobile devices. The IoT device 1101 accesses the wireless communication system via the base station gNB4 to receive and transmit data as schematically represented by arrow 1121. The IoT device 1102 accesses the wireless communication system via the user UE3 as is schematically represented by arrow 1122. The respective base station gNB1 to gNB5 may be connected to the core network 102, e.g., via the S1 interface, via respective backhaul links 1141 to 1145, which are schematically represented in FIG. 1(b) by the arrows pointing to “core”. The core network 102 may be connected to one or more external networks. Further, some or all of the respective base station gNB1 to gNB5 may connected, e.g., via the S1 or X2 interface or the XN interface in NR, with each other via respective backhaul links 1161 to 1165, which are schematically represented in FIG. 1(b) by the arrows pointing to “gNBs”.

For data transmission a physical resource grid may be used. The physical resource grid may comprise a set of resource elements to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB), the physical downlink shared channel (PDSCH) carrying for example a system information block (SIB), the physical downlink, uplink and sidelink control channels (PDCCH, PUCCH, PSSCH) carrying for example the downlink control information (DCI), the uplink control information (UCI) and the sidelink control information (SCI). For the uplink, the physical channels, or more precisely the transport channels according to 3GPP, may further include the physical random access channel (PRACH or RACH) used by UEs for accessing the network once a UE is synchronized and has obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix (CP) length. All OFDM symbols may be used for DL or UL or only a subset, e.g., when utilizing shortened transmission time intervals (sTTI) or a mini-slot/non-slot-based frame structure comprising just a few OFDM symbols.

The wireless communication system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g., DFT-s-OFDM. Other waveforms, like non-orthogonal waveforms for multiple access, e.g., filter-bank multicarrier (FBMC), generalized frequency division multiplexing (GFDM) or universal filtered multi carrier (UFMC), may be used. The wireless communication system may operate, e.g., in accordance with the LTE-Advanced pro standard or the NR (5G), New Radio, standard.

The wireless network or communication system depicted in FIG. 1 may by a heterogeneous network having distinct overlaid networks, e.g., a network of macro cells with each macro cell including a macro base station, like base station gNB1 to gNB5, and a network of small cell base stations (not shown in FIG. 1), like femto or pico base stations.

In addition to the above described terrestrial wireless network also non-terrestrial wireless communication networks exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the NR (5G), new radio, standard. In mobile communication networks, for example in a network like that described above with reference to FIG. 1, like an LTE or 5G/NR network, there may be UEs that communicate directly with each other over one or more sidelink (SL) channels, e.g., using the PC5 interface. UEs that communicate directly with each other over the sidelink may include vehicles communicating directly with other vehicles (V2V communication), vehicles communicating with other entities of the wireless communication network (V2X communication), for example roadside entities, like traffic lights, traffic signs, or pedestrians. Other UEs may not be vehicular related UEs and may comprise any of the above-mentioned devices. Such devices may also communicate directly with each other (D2D communication) using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are not within one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

When considering two UEs directly communicating with each other over the sidelink, e.g., using the PC5 interface, one of the UEs may also be connected with a BS, and may relay information from the BS to the other UE via the sidelink interface. The relaying may be performed in the same frequency band (in-band-relay) or another frequency band (out-of-band relay) may be used. In the first case, communication on the Uu and on the sidelink may be decoupled using different time slots as in time division duplex, TDD, systems.

FIG. 2 is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 3 is a schematic representation of an out-of-coverage scenario in which the UEs directly communicating with each other are either not connected to a base station, although they may be physically within a cell of a wireless communication network, or some or all of the UEs directly communicating with each other are to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 3 which is the out-of-coverage scenario does not necessarily mean that the respective mode 2 UEs (in NR) or mode 4 UEs (in LTE) are outside of the coverage 200 of a base station, rather, it means that the respective mode 2 UEs (in NR) or mode 4 UEs (in LTE) are not served by a base station, are not connected to the base station of the coverage area, or are connected to the base station but receive no SL resource allocation configuration or assistance from the base station. Thus, there may be situations in which, within the coverage area 200 shown in FIG. 2, in addition to the NR mode 1 or LTE mode 3 UEs 202, 204 also NR mode 2 or LTE mode 4 UEs 206, 208, 210 are present.

Naturally, it is also possible that the first vehicle 202 is covered by the gNB, i.e. connected with Uu to the gNB, wherein the second vehicle 204 is not covered by the gNB and only connected via the PC5 interface to the first vehicle 202, or that the second vehicle is connected via the PC5 interface to the first vehicle 202 but via Uu to another gNB, as will become clear from the discussion of FIGS. 4 and 5.

FIG. 4 is a schematic representation of a scenario in which two UEs directly communicating with each, wherein only one of the two UEs is connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204, wherein only the first vehicle 202 is in the coverage area 200 of the base station gNB. Both vehicles 202, 204 are connected directly with each other over the PC5 interface.

FIG. 5 is a schematic representation of a scenario in which two UEs directly communicating with each, wherein the two UEs are connected to different base stations. The first base station gNB1 has a coverage area that is schematically represented by the first circle 2001, wherein the second station gNB2 has a coverage area that is schematically represented by the second circle 2002. The UEs directly communicating with each other include a first vehicle 202 and a second vehicle 204, wherein the first vehicle 202 is in the coverage area 2001 of the first base station gNB1 and connected to the first base station gNB1 via the Uu interface, wherein the second vehicle 204 is in the coverage area 2002 of the second base station gNB2 and connected to the second base station gNB2 via the Uu interface.

A wireless communication system as described above, may have the general purpose of establishing, operating and maintaining a communication link between a transmitter and a receiver in a wireless fashion. This is usually done by transmitting signals modulated on an electromagnetic carrier (carrier frequency within a communication band) over e.g. an antenna, wherein the electromagnetic wave carrying the message to be communicated via e.g. the modulated signal propagates from the transmitting source into the space/environment around the transmitter. Such surrounding is often referred to as radio propagation environment describing the environment and the objects within which influence the radio link between the transmitter and the receiver. Such objects like walls, buildings, streets cause reflections, diffractions, refractions and/or transmission of the radio waves emitted from the transmitter. In case of many objects being of impact on the overall wireless link between a transmitter and receiver one may refer this to be a multi-path radio propagation environment.

A wireless communication system, WCS, consisting of at least a transmitter and a receiver can improve the data throughput or communication range in a given propagation environment by means of adapting its transmission and/or receive strategy to the given properties of the radio propagation environment.

Transmission and receive strategies in the context of modern wireless systems includes in particular beamforming at the transmitter and/or receiver in order to transmit energy to and receive energy from directions with multi-path components (MPC) which are beneficial to be used in the wireless communication link. Such MPCs which are related to RIS may be configured by tuning reflection angle, phases and/or attenuation in order to achieve specific performance targets for one or more wireless links, these include but are not limited to: Range extension, coverage extension, capacity increase by improving SNR and/or MIMO rank, interference reduction by avoiding or cancelling interference leakage from other cells, improved secrecy by cancelling or camouflaging signals towards an eavesdropper's receiver etc. (see application scenarios and use case section).

Therefore, RIS deployed in a network allow an improved degree of freedom to shape, tune, configure MPCs and in combination with existing transmit and receive beamforming strategies to achieve a new level of flexibility in radio environment structuring, deployment options and cost reduction.

In this context, RIS offer a further solution space by allowing to reconfigure certain objects within the radio propagation environment to actively influence, e.g. reflection properties matching certain targets (capacity, coverage, interference) by controlling the properties of one or more RIS.

Changing radio propagation properties of objects in the environment around and in between a transmitter and receiver allows to shape or influence the radio propagation environment to specific needs. Of course such changes in the radio propagation environment have to match geometries of radio links and capabilities of the devices involved in the wireless communication therefore the properties of the RIS have to be controlled by the wireless communication link, i.e., one of the involved devices, the wireless system or the wireless communication network.

With the introduction of RIS a number of problems in wireless communication could be tackled and/or solved which cannot be solved by measures at the transmitter(s) and/or receiver(s) alone.

The operation of RIS within a WCS requires the control of RIS properties to be matched to radio propagation environment relevant for the operation of the WCS, therefore the RIS has to become a controllable element of the WCS since as a MPC it is part of the radio channel the wireless communication is operated on.

Therefore, there is the need of enhancing wireless communication of a wireless communication network that uses RIS. There is also a need in known systems for enhancing network operations.

It is noted that the information in the above section is only for enhancing the understanding of the background of the invention and therefore it may contain information that does not form conventional technology and is already known to a person of ordinary skill in the art.

### SUMMARY

An embodiment may have a device such as a user equipment, UE, configured for operating in a wireless communications network that provides wireless communication between a first entity and a second entity, the wireless communication adapted to include a reconfigurable intelligent surface, RIS; wherein the device is configured or configurable for determining a RIS specific parameter to obtain a feedback information; wherein the device is to report, to the wireless communication network, a feedback that includes the feedback information.

According to another embodiment, a method to determine a communication setting in a wireless communications network that provides wireless communication between a first entity and a second entity, the wireless communication adapted to include a reconfigurable intelligent surface, RIS, may have the steps of: operating the first entity to use a multipath component, MPC, of the wireless communication network provided or contributed by the RIS; operating the second entity to use the MPC; changing at least one of a first operation parameter of the first entity with respect to the use of the MPC; a second operation parameter of the second entity with respect to the use of the MPC; and a configuration parameter of the RIS to change the MPC; and evaluating a result of the changing to determine the communication setting that matches a predefined communication criterion.

According to another embodiment, a wireless communications network providing for wireless communication between a first entity and a second entity, the wireless communication adapted to include a reconfigurable intelligent surface, RIS, may have a controller unit preconfigured, configured or configurable for organising a contribution of the RIS to the wireless communication network.

According to another embodiment, a reconfigurable intelligent surface, RIS, device, may have: a reconfigurable intelligent surface configured for providing a multipath component in a wireless communication network; a RIS panel control unit configured for controlling a property of the reconfigurable intelligent surface; wherein the RIS panel control unit is configured for indicating RIS information including at least one of: a RIS identifier, serial number, model number, SKU, date of manufacture, MAC address; a position of the RIS in space; a property, capability, availability, accuracy, reliability or function of the RIS a pointer pointing towards further information elements related with the RIS device, e.g., a database entry, a coded information such as a QR code pointing to an IP address or uniform resource locator, URL.

According to another embodiment, a wireless communication system may have at least one wireless communication network and a centralised or decentralised controller entity for organising a contribution of at least one reconfigurable intelligent surface, RIS, to wireless communication in the wireless communication system.

Another embodiment may have a device or network entity configured for operating corresponding to a wireless communication network, a RIS device and/or a wireless communication system described herein; or for cooperating with a wireless communication network, a RIS device and/or a wireless communication system described herein.

Another embodiment may have a method for operating a wireless communication network, a RIS device and/or a wireless communication system described herein.

Another embodiment may have a non-transitory digital storage medium having a computer program stored thereon to perform the above method to determine a communication setting in a wireless communications network that provides wireless communication between a first entity and a second entity or the method for operating a wireless communication network, a RIS device and/or a wireless communication system described herein, when said computer program is run by a computer.

Another embodiment may have a signal for performing the operation of a wireless communication network, a RIS device and/or a wireless communication system described herein.

Another embodiment may have a computer readable digital storage medium having stored thereon an inventive signal.

### BRIEF DESCRIPTION OF THE DRAWINGS

Embodiments of the present invention will be detailed subsequently referring to the appended drawings, in which:

FIG. 1 shows a schematic representation of an example of a wireless communication system;

FIG. 2 is a schematic representation of an in-coverage scenario in which UEs directly communicating with each other are connected to a base station;

FIG. 3 is a schematic representation of an out-of-coverage scenario in which UEs directly communicating with each other receive no SL resource allocation configuration or assistance from a base station;

FIG. 4 is a schematic representation of a partial out-of-coverage scenario in which some of the UEs directly communicating with each other receive no SL resource allocation configuration or assistance from a base station;

FIG. 5 is a schematic representation of an in-coverage scenario in which UEs directly communicating with each other are connected to different base stations;

FIG. 6 is a schematic representation of a wireless communication system comprising a transceiver, like a base station or a relay, and a plurality of communication devices, like UEs, according to an embodiment;

FIG. 7 is a simple overview of major differences between RIS and relays/repeaters;

FIG. 8a-h show schematic representations of differences between different types of RIS architectures;

FIG. 9 shows a schematic representation of a RIS in connection with embodiments having an active surface and a passive surface;

FIG. 10a-b depict two different types of RIS architectures that may be used according to embodiments;

FIG. 11 shows a schematic illustration of a time line how the radio channel was handled by different generations of mobile communication systems according to an embodiment;

FIG. 12a-b show an example of a simple RIS/RRS element that may be used in embodiments, suitable to change reflective properties of a meta-surface;

FIG. 13 shows a schematic block diagram of a wireless communication network or system according to an embodiment;

FIG. 14 shows a schematic block diagram of a RIS installation according to an embodiment;

FIG. 15 shows example parts taken from the LMF specification 3GPP TS 38.305 version 16.6.0 release 16;

FIG. 16 shows a schematic block diagram of a part of a wireless communication network according to an embodiment that has a database storing information about available, identified and/or identified RIS;

FIG. 17 shows a schematic block diagram of at least a part of a wireless communication network according to an embodiment, the wireless communication network having a plurality of RIS;

FIG. 18 shows a schematic block diagram of at least a part of a wireless communication network according to an embodiment, illustrating a scenario of a distributed RMF/RIS-C architecture showing the logical interfaces between functional components;

FIG. 19 shows a schematic block diagram of at least a part of a wireless communication network according to an embodiment, the wireless communication network 190 having a plurality of RIS, each independently implemented;

FIG. 20 shows a schematic known representation of a wireless communication scenario relating to influence EM waves traveling through a propagation environment;

FIG. 21 a schematic representation of topics related to RIS according to embodiments; and

FIG. 22 illustrates an example of a computer system on which units or modules as well as the steps of the methods described in accordance with the inventive approach may execute.

### DETAILED DESCRIPTION OF THE INVENTION

Equal or equivalent elements or elements with equal or equivalent functionality are denoted in the following description by equal or equivalent reference numerals.

In the following description, a plurality of details are set forth to provide a more thorough explanation of embodiments of the present invention. However, it will be apparent to one skilled in the art that embodiments of the present invention may be practiced without these specific details. In other instances, well-known structures and devices are shown in block diagram form rather than in detail in order to avoid obscuring embodiments of the present invention. In addition, features of the different embodiments described hereinafter may be combined with each other, unless specifically noted otherwise.

As already indicated in the introductory portion, RIS may support wireless communication in a WCS.

Embodiments described herein allow for enhancing a use of RIS in wireless communication networks or systems.

It is to be noted communication systems described herein and in particular wireless communication systems such as mobile communication system may comprise any number of at least two devices communicating. In an infrastructure network at least a third node, e.g., an access point or a base station, may be used to forward a signal from one node to another. In a different configuration such as a peer-to-peer network, two (or more) devices may also communicate in absence of an infrastructure, however not excluding it, e.g., when using a relay or the like. Another example, is a user equipment, UE, that communicates with a base station in absence of another UE participating the communication. In connection with embodiments described herein, a number of two devices that communicate are considered a sufficient number of devices to generate a communication network or system.

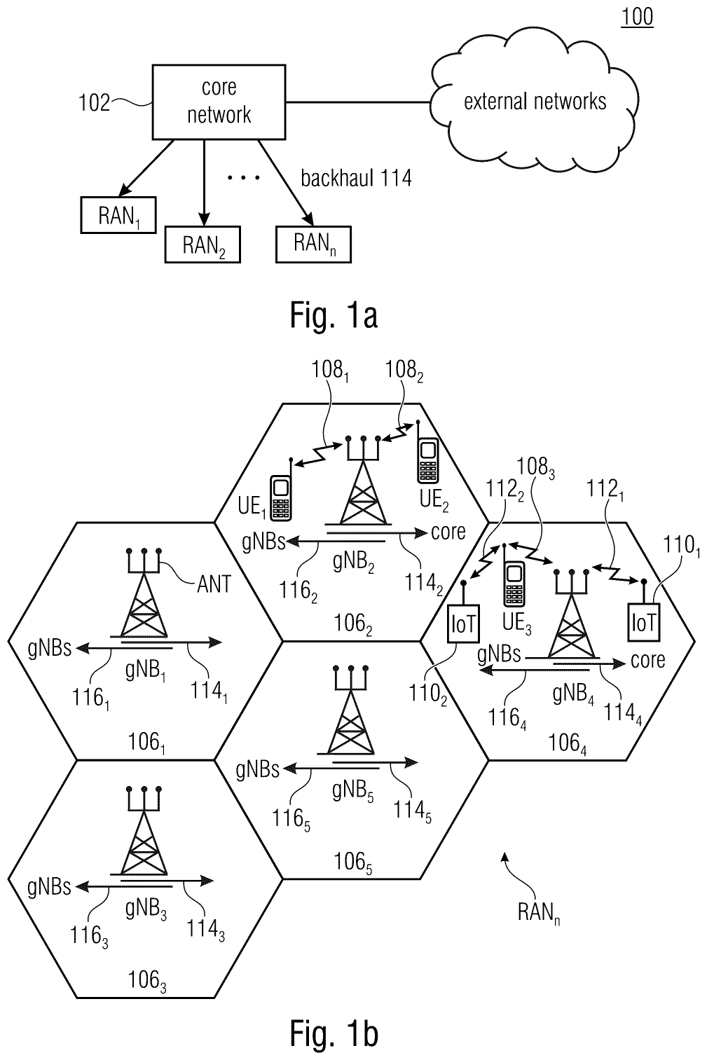

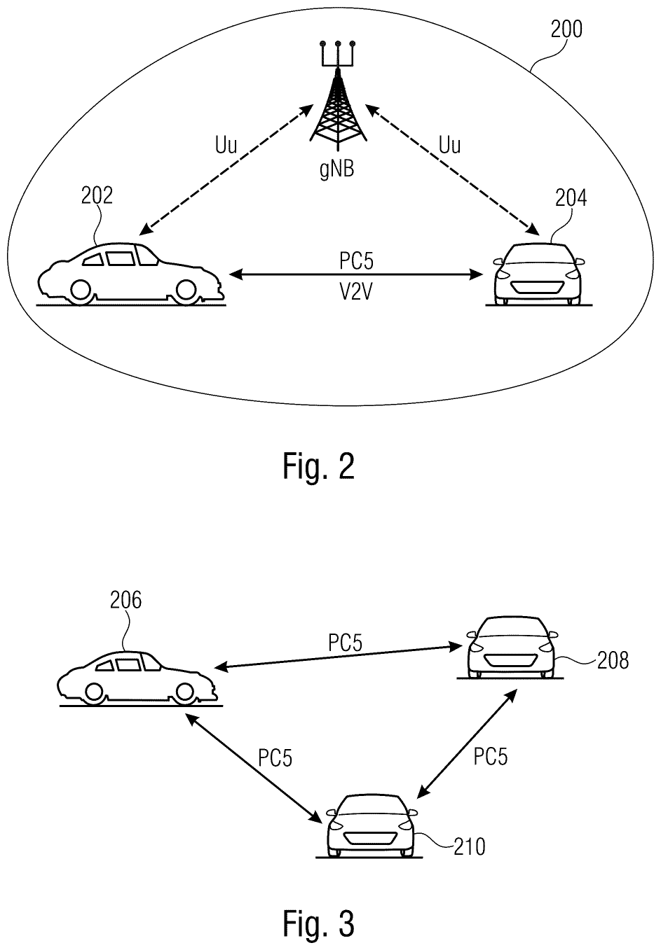

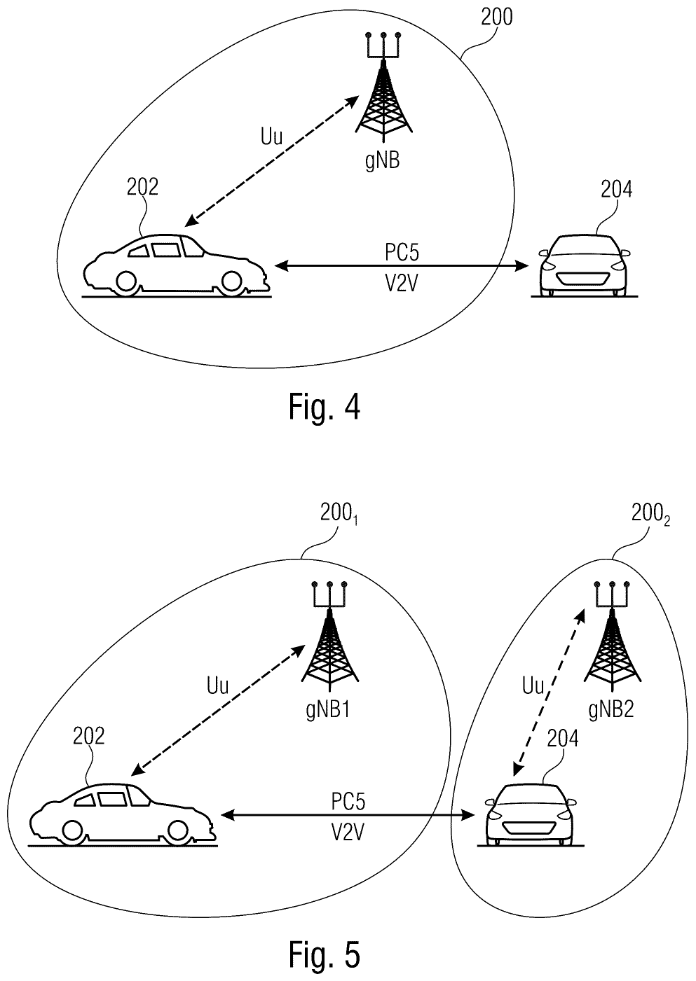

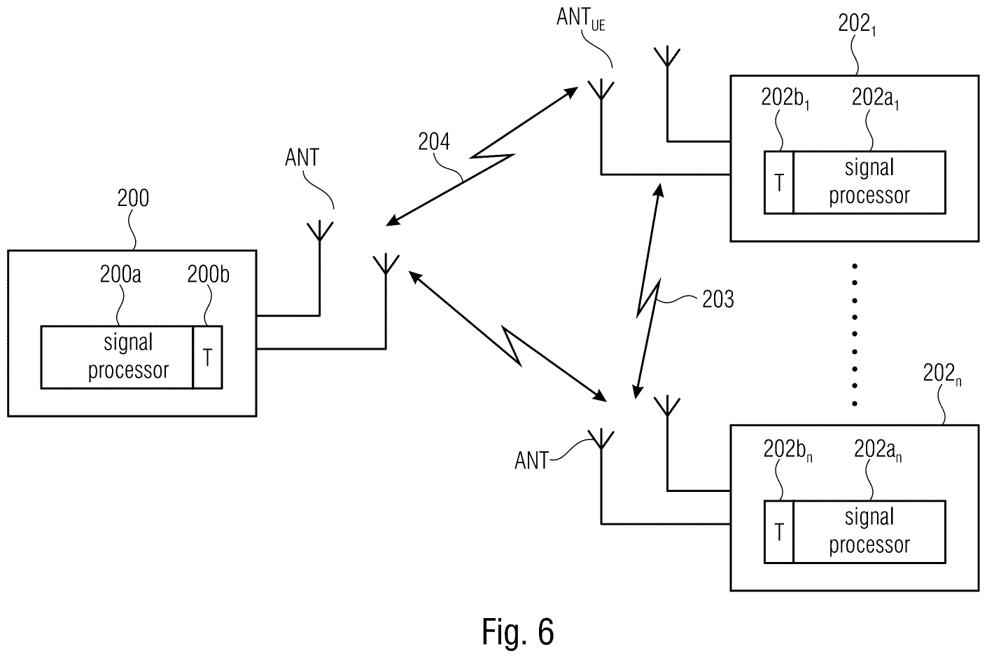

Embodiments of the present invention may be implemented in a wireless communication system or network as depicted in FIGS. 1 to 5 including a transceiver, like a base station, gNB, or relay, and a plurality of communication devices, like user equipment's, UEs. FIG. 6 is a schematic representation of a wireless communication system comprising a transceiver 200, like a base station or a relay, and a plurality of communication devices 2021 to 202n, like UEs. The UEs might communicated directly with each other via a wireless communication link or channel 203, like a radio link (e.g., using the PC5 interface (sidelink)). Further, the transceiver and the UEs 202 might communicate via a wireless communication link or channel 204, like a radio link (e.g., using the uU interface). The transceiver 200 might include one or more antennas ANT or an antenna array having a plurality of antenna elements, a signal processor 200a and a transceiver unit 200b. The UEs 202 might include one or more antennas ANT or an antenna array having a plurality of antennas, a processor 202a1 to 202an, and a transceiver (e.g., receiver and/or transmitter) unit 202b1 to 202bn. The base station 200 and/or the one or more UEs 202 may operate in accordance with the inventive teachings described herein.

Starting from this, WCS such as the ones described above may benefit from a use of RIS. Embodiments of the present invention relate to enhance a use of a RIS in a WCS. A RIS may also be referred to as a reconfigurable reflective surface, RRS, or a frequency selective surface, FSS. Embodiments may be beneficial for the fields of wireless communication.

RIS has recently attracted a lot of attention in academia and industry as it is seen as a new paradigm to achieve a reconfigurable wireless propagation environment for beyond 5G wireless communication systems. Although the commercialisation of RIS remains immature, several pilot projects have been launched to further progress research. The works deal with various aspects in the research domain, ranging from deployment and use cases to channel estimation. Several surveys summarise these main aspects dealt with until now. Applications of a RIS relate to bypassing obstacles that cause blockages or significantly degrade signals, managing interference in dense networks and providing energy-efficient communication by deploying RIS structure instead of active small cells/base stations. A key challenge in RIS deployment is the deployment in relation to users' positions and APs to be considered, including the requirements on cooperative communication between multiple APs.

Furthermore, channel estimation is highlighted as one of the major challenges to obtaining the CSI of an AP-user direct channel and an AP-RIS-user cascaded channel. Further, they also identify major research opportunities associated with the integration of RISs into other emerging technologies, such as NOMA, SWIPT and UAV networks, and discuss potential solutions. In [1], the authors also present a survey of RIS-related works. They provide a comprehensive summary of works that focus on SNR or capacity maximisation (by increasing channel rank), for both—point-to-point communications and multi-group/multi-cell MU cases. Besides these use cases, the authors survey the work in other two major application scenarios—maximising energy efficiency and RIS-assisted PHY layer security. In terms of RIS structure and control mechanism, the authors describe main aspects, which include integration of a RIS controller and tuneable chips, inter-cell communication among the tuneable chips so that the elements of meta-surface can be controlled, and a phase tuning mechanism, which achieves the reconfigurability.

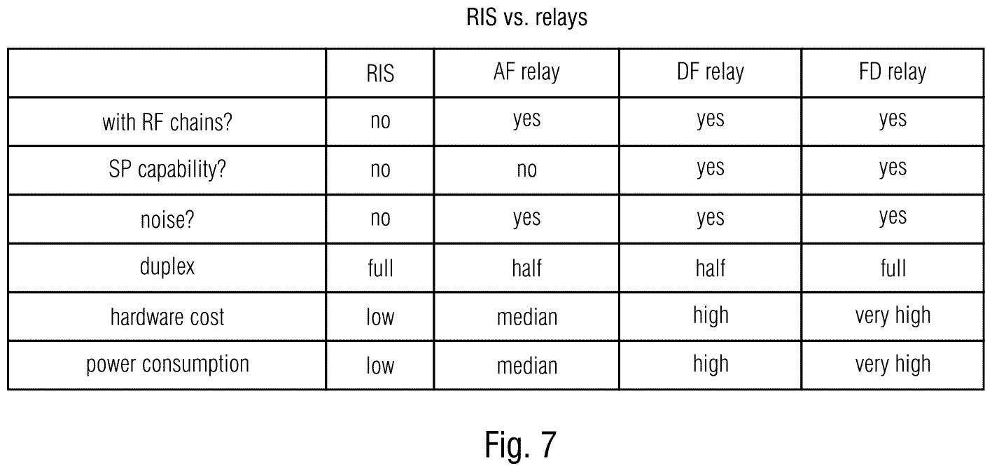

Beside considering different types of RIS architectures, it is also worth noting the main differences pointed out in literature between RIS and relays/repeaters. For example, the authors in [2] provide a simple overview of major differences between RIS and relays/repeaters, as depicted in the FIG. 7. They consider passive RIS architecture and compare it with Amplitude and Forward (AF), Decode and Forwards (DF) and Full Duplex (FD) relays. Hence, the first difference is that all of the relays contain active elements, which affects their HW cost and power consumption. Another difference between RIS and some relays (DF and FD) is the presence of signal processing capability, which, again, impacts HW cost and power consumption. The authors also point out that RIS naturally operates in full duplex (FD) mode without self-interference or introducing thermal noise.

An overview of a comparison between a passive RIS and a relay/repeater according to [2] is shown in FIG. 7.

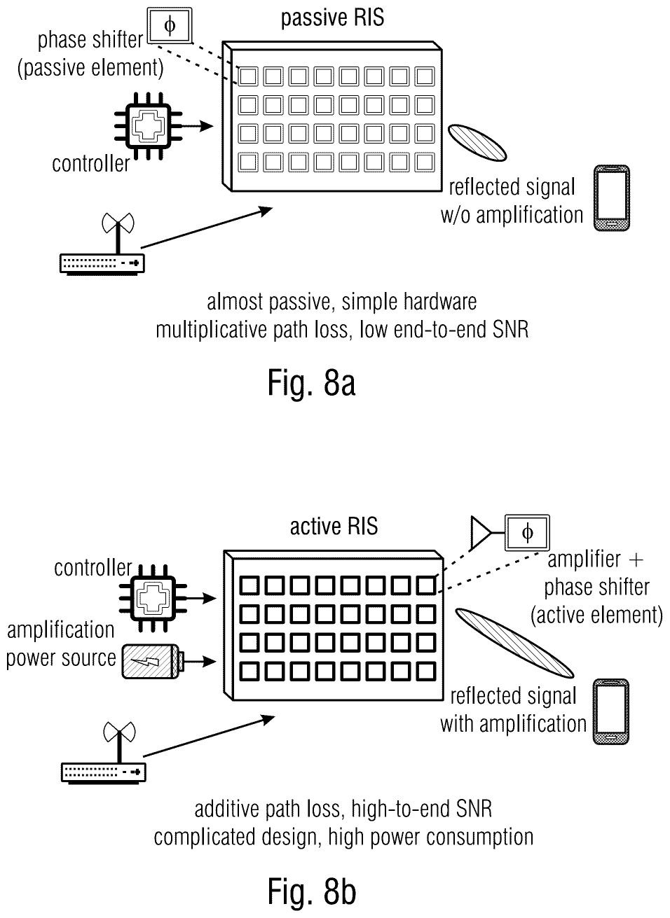

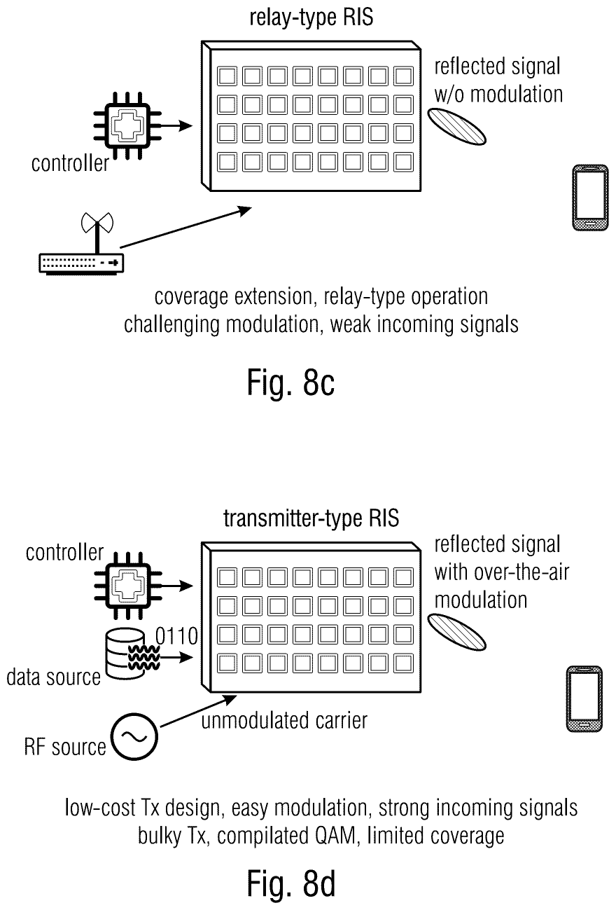

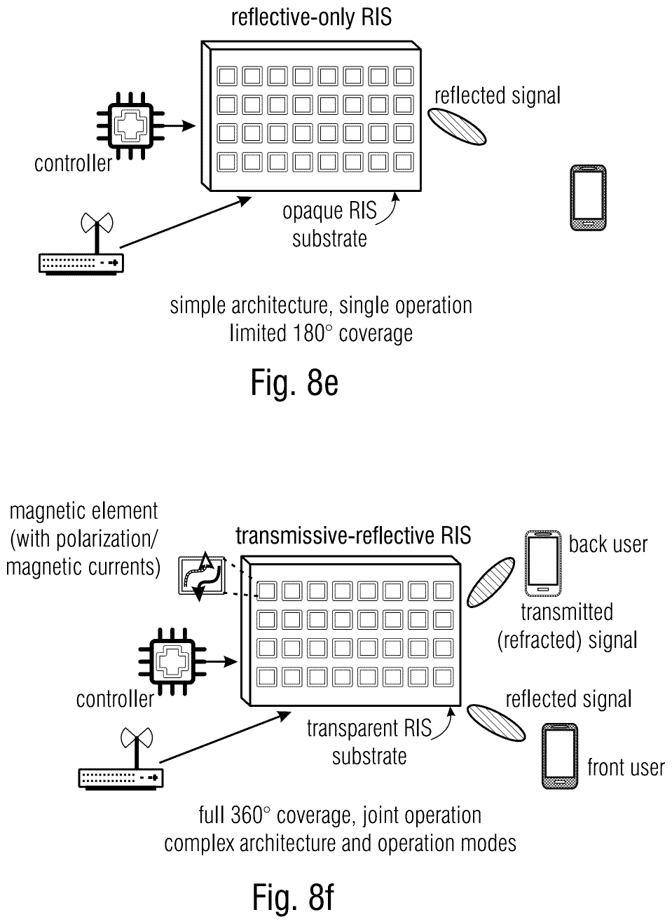

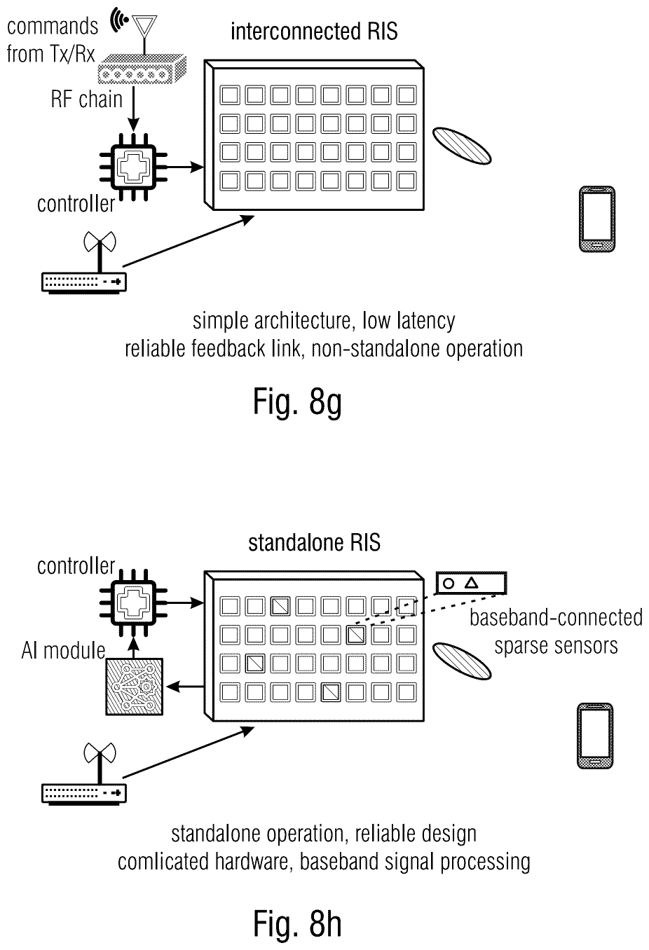

Research community is now also turning towards active RIS, where some RIS elements are equipped with active RF electronics to boost reflected signals. Previously different types of RIS architectures were discussed, as depicted by FIG. 8a-f. Here, besides passive and active RIS, the authors also distinguish other types of RIS:
in relay mode, see, e.g., FIG. 8b and/or FIG. 8c, the RIS (whether active or passive) is placed somewhere between the source and the destination to assist the communication when the direct link is very weak or blocked, and hence RIS is used to overcome blockage/improve SNR
transmitter-type operation, see, e.g., FIG. 8d, FIG. 8e or FIG. 8f, where passive RIS is a part of the transmitter and plays an active role in signalling and modulation; in other words, RIS can manipulate the incoming unmodulated carrier signal to encode information bits. It consists of only passive reflector elements and can be connected to the network over a wired link or optical fibre. By feeding the RIS with an unmodulated carrier, it is possible to create virtual signal constellations over-the-air, notable examples include spatial modulation, media-based modulation, and the more general index modulation. Transmitter type RISs can be regarded as reflection modulation, where we embed information into reflection states of an RIS.
transmissive—reflective RIS operation as shown, e.g., in FIG. 8f allows simultaneously to reflect and transmit (in principle, refract) the incoming signals to provide full 360c coverage
fully passive but interconnected RIS as shown, e.g., in FIG. 8a and FIG. 8g, have a dedicated communication link, that is, a fully functional unidirectional or bidirectional communication link, which handles critical information to be forwarded to or from the microprocessor controlling the RIS. This link might be between the RIS and the source, destination, or a central control unit and acts as a guide for the RIS when adjusting its reflection state
passive RIS with a receiver functionality have a dedicated communication link receiver, that is, a fully functional RF chain, which receives critical information to be forwarded to the microprocessor controlling the RIS. This link might be between the RIS one of the transmitters using the RIS as a reflector or any other transmitting device within reception range of the RIS. Such device can use the wireless link as a control channel directly to control the RIS, e.g. as an actively reconfigurable radio propagation element or as proxy for another entity which controls the RIS and its properties, e.g. adjusting its reflection state
a stand-alone RIS as shown in FIG. 8h is equipped with sparse sensors embedded among passive RIS elements and has a number of RF chains for background baseband signal processing to acquire knowledge about the wireless environment.

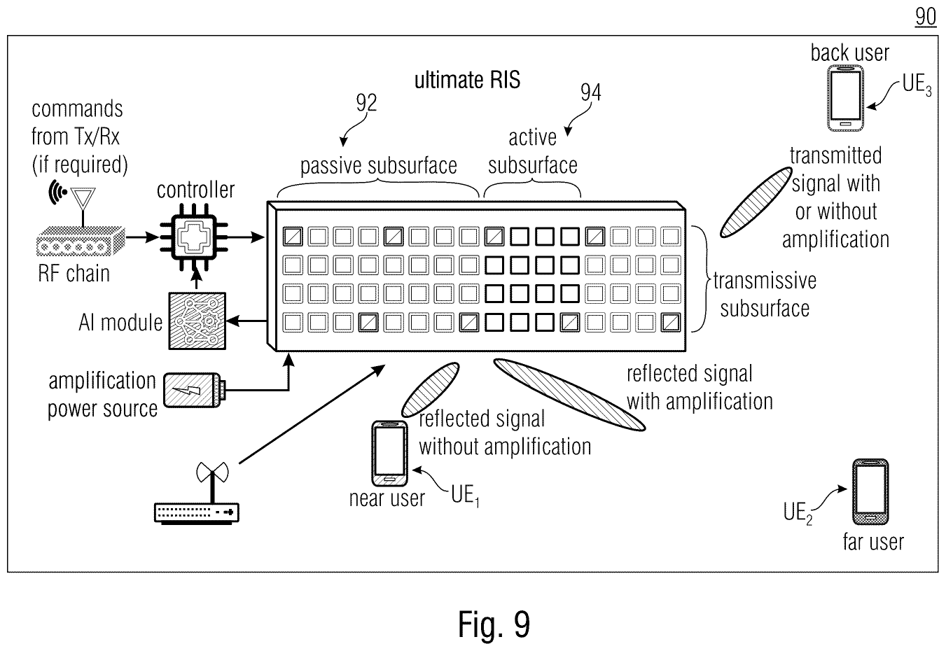

A RIS architecture 90 represents a combination of different types of RIS architectures for maximum flexibility for supporting communicating between UE1, UE2 and/or UE3, depicted in FIG. 9 having an active surface 92 and a passive surface 94. Embodiments of the present invention start from interconnected RIS as the base architecture. Interconnected means to be connected with other network entities which require explicit change of particular MPCs.

The authors identify the following major questions:
How might an RIS obtain knowledge of channel phases? How can the RIS adjust itself in real time?
Is it possible to perform channel estimation at the RIS?
How realistic is it to assume fully passive RISs?
Where does the intelligence of RIS come from?

The successful deployment of Reconfigurable Intelligent Surface (RIS) technology in cellular networks is highly dependent on the availability of existing frameworks to allow the integration and operation of RIS panels in real world propagation environments, with low standardization impact to ensure high acceptance and low market entry barriers. This paper focuses on low PHY aspects and, in particular, on the suitability of the existing 5G-NR frameworks for channel estimation and link control while considering the impact on reference signal (RS) design, statistical channel state information (CSI) analysis and CSI reporting. Beam management and link control might need enhancements when today's cellular networks will be extended to include RIS to actively shape multi-path components between base stations and user equipment. The authors also address the related challenges in RIS control, when RIS infrastructure are deployed in a radio environment used by several mobile network operators. The impact of adjacent bands and RIS operation that includes inter-cell links of another network will be studied. The wideband reflective properties of the RIS are considered non-separable amongst operators.

Wireless communication links rely on the principle of electromagnetic (EM) wave propagation to transport information, without wires, from a transmitting station to a receiving station-such stations can be stationary or mobile. For unidirectional links, a transmitter and antenna are arranged at one end of the link while a receiver and antenna are organized at the other end of the link. Bidirectional links employ receiving and transmitting equipment and antennas at both ends of the link. Depending on the antenna arrangement used at the transmitting station, the direction of departing EM waves can be influenced to a greater or lesser extent. Similarly at the receiving station, certain antenna arrangements might allow the spatial region from which EM waves are collected, to be shaped. Multiple antenna techniques—for example MIMO—can also be used to deliberately transmit and/or receive a multiplicity of EM waves while other transmission and reception techniques can be used to mitigate the effects of fading, interference, distortion and so on.

After an EM wave has been emitted by the transmitting antenna, little can be done however to affect the direction or manner in which it travels through the propagation channel—an environment that can contain buildings, structures, vehicles, vegetation, people and other objects (not forgetting sources of interference and noise). Indeed, the presence of such objects and obstructions is responsible for a variety of propagation mechanisms including reflection, diffraction, attenuation, diffusion, polarization and transmission. Such mechanisms can, either individually or in combination with one another, create so-called multi-path components (MPCs) and an environment comprised of many objects or obstacles (and hence propagation mechanisms) is known as a multi-path (radio) propagation environment.

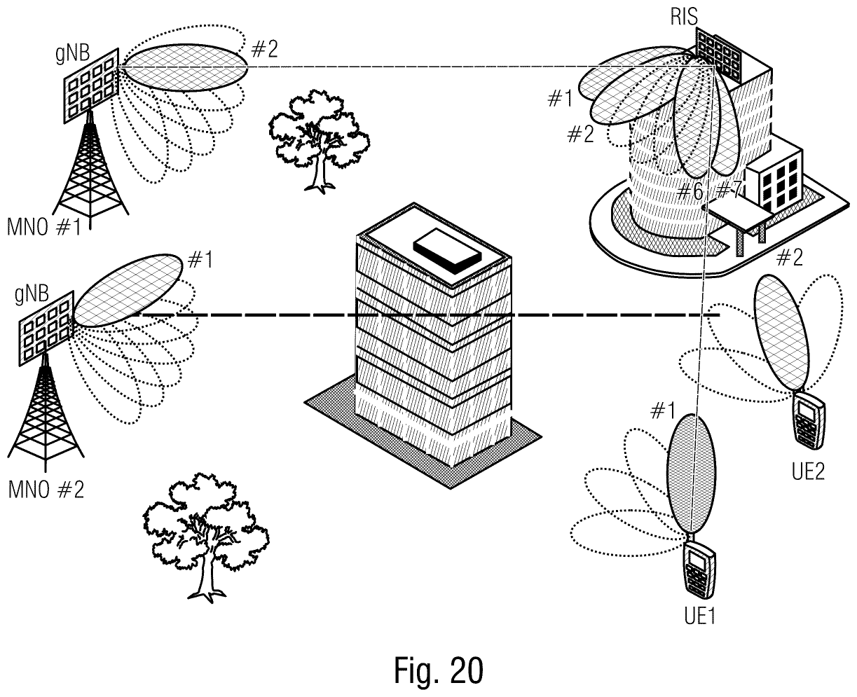

Notwithstanding the above, the advent of RIS technologies, refer to FIG. 20, promises the possibility to influence EM waves as they travel through the propagation environment [4]-[6] thus offering many benefits to wireless communication systems (WCSs) and specifically mobile network operators (MNOs). This is especially true when the control of RIS infrastructure is harmonized with the operation of the radio equipment and antennas that comprises the wireless connection. For example: by appropriately directing reflected waves (redirection), coverage infill, range extension or reduced levels of interference can be achieved; by coordinating multiple reflections (collimation), an increase in signal-to-noise ratio or channel rank offers improved capacity; or by cancelling or camouflaging signals in the direction of an eavesdropper, call integrity can be improved. Consequently, the radio channel will be comprised of a mixture of MPCs—those that are affected by the RIS deployment (RIS-MPCs) and those that are not (MPCs). The number of MPCs in either category (RIS-related or otherwise) will depend not only on the characteristics of the radio propagation environment and the RIS infrastructure deployed in it but also on the manner in which the RIS technology is controlled. The equipment used to control the behaviour or operation of the RIS infrastructure—the RIS controller-thus forms an integral part of the WCS.

The electromagnetic spectrum is a natural resource within which specific frequency ranges or bands are allocated to wireless communications. Since these bands are often crowded by a plethora of users and services, spectrum resources should be shared both wisely and fairly. Moreover, when considering the deployment of RIS technology in cellular networks, the benefits enjoyed by the subscribers of one MNO should not be at the detriment of those subscribed to another MNO—especially when competing service providers make use of similar propagation environments. As it is in the interests of all such MNOs to cooperate and coordinate their RIS deployments and hence the manner in which they create RIS-MPCs, a standardized means of ensuring inter-MNO RIS cooperation and coordination is required. This will necessitate a framework of interactions between the traditional members of a WCS—such as basestations (gNB), terminals (UE) and repeaters (IAB)—and the RIS infrastructure including RIS controllers.

The introduction of RIS technologies into emerging 5G-Advanced networks will undoubtedly represent a sizable stride towards the next generation of cellular network deployments. The first small steps however, have to carefully address the topic of RIS integration into existing 5G NR frameworks.

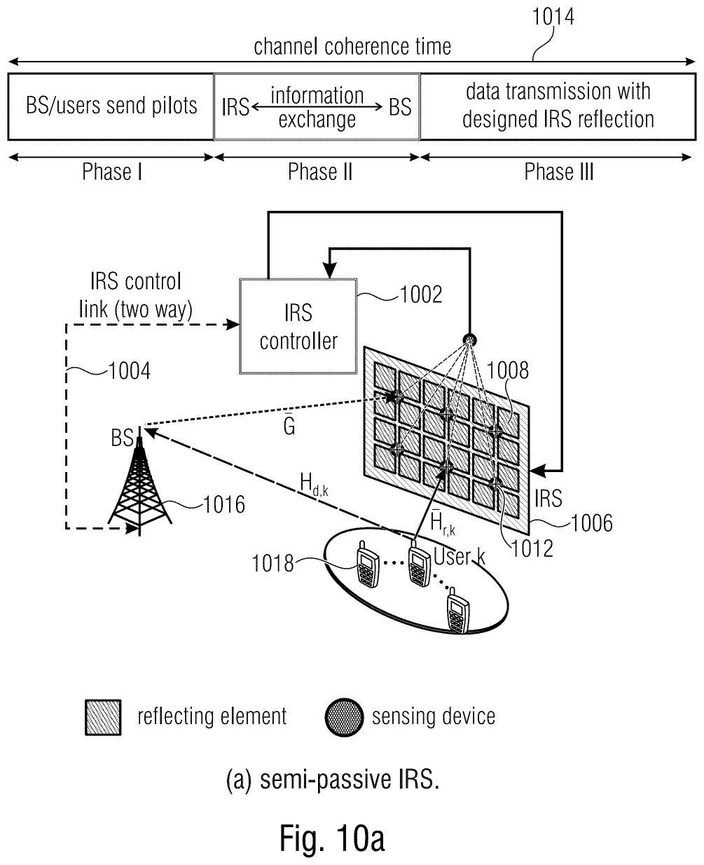

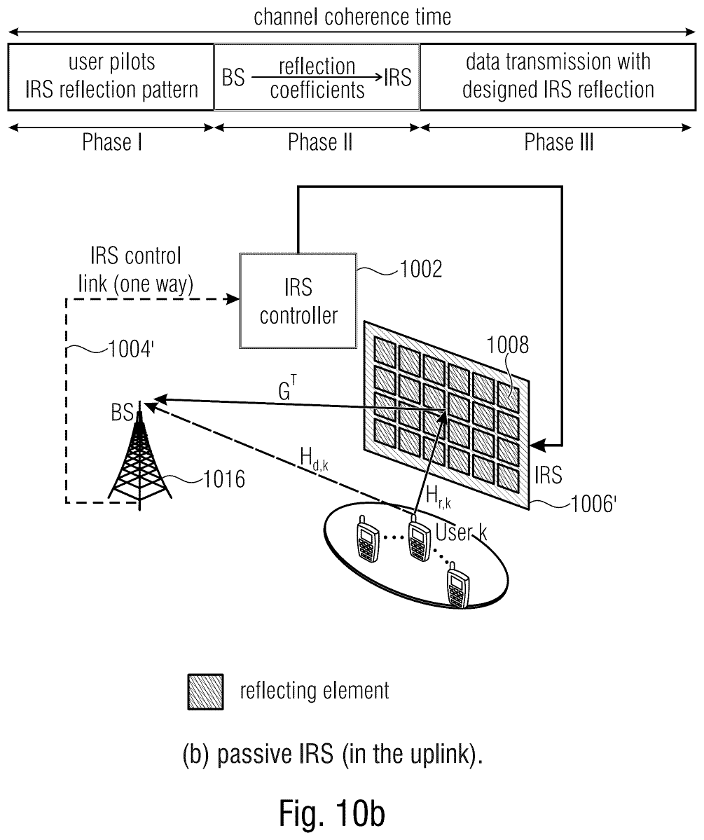

FIG. 10a shows a schematic block diagram of a part of a wireless communication network in which an IRS (intelligent reflective surface) controller 1002 receives information via an IRS control link that is bidirectional. The IRS controller may control an IRS 1006 wherein IRS may be understood as a synonym for RIS. The IRS 1006 may comprise reflecting elements 1008 along with sensing devices 1012. During a channel coherence time 1014 a base station 1016 and/or one or more users 1018 may send pilot symbols during a Phase I of the channel coherence time 1014. During a following Phase II, the IRS and the BS may exchange information, e.g., using the IRS control link 1004. A remaining time, e.g., Phase III may be used for data transmission with the design/controlled IRS reflection.

FIG. 10b shows a schematic block diagram of a scenario in which an IRS 1006′ comprises reflecting elements whilst possibly being implemented without sensing devices 1012 being illustrated in FIG. 10a. This may allow to implement the IRS control link as unidirectional control link 1004′, e.g., as feedback being provided based on sensing results of devices 1012 is not required to be transmitted towards base station 1016. Whilst IRS 1006 may be referred to as semi-passive IRS, the IRS 1006′ may be a passive IRS, at least in the uplink. When compared to the scenario of FIG. 10a, a transmission of pilots during Phase I may relate to user pilots and during Phase II the base station may transmit reflection coefficients to IRS 1006′ to IRS controller 1002, respectively.

In other words, FIG. 10a-b depict two different types of RIS architectures (note the naming of RIS as IRS—Intelligent Reflecting Surface). FIG. 10a depicts the RIS with sensing capability for channel estimation. Namely, additional sensing devices (such as low-power sensors) can be combined with reflecting elements, as shown in FIG. 10a, each equipped with a low-cost receive RF chain (e.g., low-resolution analogue to-digital converter (ADC)) for processing the sensed signal. Semi-passive RIS operates in channel sensing mode to sense pilots and estimate channel from BS/users to RIS and in a reflector mode to reflect the signals from the BS/users. In passive RIS shown in FIG. 10b, it is generally infeasible to acquire the CSI between the RIS and BS/users directly. Here, users first transmit orthogonal pilots to the BS and meanwhile the RIS varies its reflection coefficients according to a pre-designed reflection pattern, based on which the BS estimates both the user-BS direct channels and the cascaded user-RIS-BS channels. Second, based on the estimated CSI, the RIS reflection coefficients for data transmission are designed at the BS jointly with its receive beamforming and then sent to the RIS controller through the backhaul link. In the third phase, the controller sets the reflection coefficients accordingly for assisting independent data transmissions from the users to BS.

In the domain of standardization, RIS was discussed. Aspects such as definition/classification of RIS, use case(s), expected gain, required functionalities, channel modelling and signalling enhancement to support RIS have been highlighted.

Common aspects between RIS and smart repeaters have been pointed out, particularly regarding the design of the interface between the gNB and the RIS/smart repeater. Functions typically associated with this interface are time synchronization, UL/DL split information, spatial information for beamforming, bandwidth and frequency response configuration, and power control.

Some of the identified questions/aspects according to embodiments include:
Which functions are common to RIS and smart repeaters, and which ones are specific to either of them? How to design as common as possible an interface?
Beam management. At least the mechanism enabling beam acquisition and refinement of gNB RIS/smart repeater and, specially, RIS/smart repeater-UE beams should be considered. The legacy mechanism can be used as a starting point. Due to the potentially large number of beam combinations, enhancements of the RS measurement and CSI reporting mechanisms to improve network efficiency and reduce feedback overhead can be considered. Similar enhancements to beam management may also be needed for the RACH procedure.
Interference-related issues from RIS/smart repeaters.

One problem addressed and solved by this invention is how to recognize, control and/or reconfigure a RIS and the associated MPCs within a WCS suitably to provide benefit to the exploitable radio channel. This includes but is not limited to a framework of interactions of the traditional members of a WCS (devices like base stations (gNB) and terminals (UE) with transmit and/or receive functions) and the RIS which belong to the multi-path propagation environment and can influence the performance of one or more wireless links within the WCS.

By the use of configurable RIS deployed in a WCS also referred to as wireless communication network, WCN, MPCs belonging to an end-to-end, e2e, wireless link become tunable and therefore the overall e2e link can be shaped and optimized exploiting the configurability of the RIS and its properties.

Such a UE or a different device operating accordingly, i.e., being able to participate in the wireless communication or to operate as a source of information to support the communication may feedback to the wireless communication network, e.g., the controller unit, a database, central entity or the like, that contains information about a RIS specific functionality, a RIS specific service, a RIS specific component and/or any other parameter associated with the RIS and/or an MPC of the RIS. Such information may serve as an input to a database described herein. Therein, information may be stored indicating, amongst other information, a location of the RIS, a direction or angle of one or more MPCs or beams (Rx and/or Tx) a behavior of the RIS or other information such as a virtual beacon provided by the RIS. Each of this information may be proved as a feedback by the device.

According to an embodiment, such a device is configured for operating in a wireless communications network that provides wireless communication between a first entity and a second entity, the wireless communication adapted to include a reconfigurable intelligent surface, RIS. The device is configured or configurable for determining, a RIS specific parameter to obtain a feedback information. Determining the RIS specific parameter may relate to perform a measurement, e.g., on a wireless electromagnetic signal or an optical signal or an image but may, as an alternative or in addition, relate to perform calculations, e.g., to determine a position information, a time information or the like.

The device may report, to the wireless communication network, a feedback that comprises the feedback information.

The feedback information may be reported to a communication partner, e.g., the second entity, first entity respectively. Alternatively or in addition, the feedback information may be reported to any other network entity, e.g., a central function such as or similar to the LMF. For example, when providing the feedback information to the communication partner, e.g., first entity, such feedback may incorporate information about a channel property and/or about a link quality of the wireless communication link used for the communication. Such a device may be configured or configurable, e.g., by a mobile network operator and/or a base station, to provide the feedback information to indicate a channel property and/or about a link quality of a wireless communication link used by the device.

Such a feedback information may, according to an embodiment, relate, e.g., in view of the channel property indicated in the feedback information, to a multipath component, MPC, associated with the RIS used for the communication and/or a different RIS, i.e., associated with a use of a RIS of the wireless communication network. Alternatively or in addition, the link quality indicated in the feedback information may relate to a link comprising a multipath component, MPC, associated with a use of the RIS or a different RIS of the wireless communication network.

The feedback may enhance operation of the wireless communication network, at least of a link thereof. For example, the feedback of a device of the wireless communication network being one of the first and second entity that determines a RIS specific parameter to obtain a feedback information; and that reports, to the wireless communication network, a feedback that comprises the feedback information; may be configured or configurable to provide the feedback information to indicate a channel property and/or about a link quality of a wireless communication link used by the device. The wireless communication network or an entity thereof may use said information to determine a configuration parameter of a wireless communication link between the first entity and the second entity using the RIS and/or to perform link optimization of the link. The optimization may be a local optimization of the link but may also relate to a global optimization, both, e.g., in view of throughput, energy consumption, bit error rates, interference or the like.

For example, the device may adapted that the RIS specific parameter is related to a RIS-specific function or a multi-path component, MPC, of the wireless communication provided or contributed by the RIS.

For example, the device may adapted that the RIS specific parameter comprises at least one of a reflection state of the RIS;
a position of the RIS;
an orientation of the RIS
a direction of a multi path component provided or contributed by the RIS;
a polarization or frequency translation capability
a capability of the RIS.

For example, the device of claim may adapted that the feedback is at least a part of a measurement report provided by the device.

For example, the device of claim may adapted to determine the RIS specific parameter to indicate a beam generated or reflected by the RIS.

For example, the device of claim may adapted, i.e., configured or configurable to participate in a procedure to determine a communication configuration of the wireless communication in which the device is the first entity and according to which an optimization of a communication parameter is obtained at least for a wireless communication between the second entity and the RIS; between the device and the RIS; and/or between the first entity and the second entity via the RIS; to obtain the RIS-specific parameter as indicating a result of the procedure.

An example of such a procedure is described as an embodiment in the following. The example embodiment relates to a configuration between two entities described herein, e.g., entities 12₁ and 12₂ one of both being, according to an example implementation, a device/UE and the other a base station that communicate over a nLoS path vie a RIS. However, also two UEs or two base stations may implement such a method. For example, one of both entities, e.g., the UE may try to evaluate a best beam configuration in view of a predefined criterion, e.g., data throughput, energy consumption, interference caused, or others. For such a determination the base station may change an operation condition, e.g., it may perform a beam sweep, a change of a beam power/gain and/or a change of another operation parameter. The UE may examine, which of the configurations matches the predefined criterion and may provide feedback to a given network entity accordingly. Alternatively or in addition, the RIS may change its operation condition, e.g., a direction of reflection/beam provision/polarization, amplification parameters or the like.

For example, the base station, the UE, another network element and/or the RIS may mark their beams, e.g., using a beam ID. The UE may report back a beam ID that matches the predefined criterion. The UE may also report back any other information that allows to conclude the RIS and/or the beam and/or the MPC, i.e., information that is associated, correlated or that corresponds to a reflection state of the RIS. The report may be provided directly or indirectly. This may allow the base station, a UE, another network element and/or the controller entity to determine a configuration, e.g., of the RIS, that allows a good communication with the UE, base station or another network element.

Such a method to determine a communication setting in a wireless communications network that provides wireless communication between a first entity and a second entity, the wireless communication adapted to include a reconfigurable intelligent surface, RIS, may comprise:
operating the first entity to use a multipath component, MPC, of the wireless communication network provided or contributed by the RIS;
operating the second entity to use the MPC;
changing at least one of a first operation parameter of the first entity with respect to the use of the MPC; a second operation parameter of the second entity with respect to the use of the MPC; and a configuration parameter of the RIS to change the MPC; and evaluating a result of the changing to determine the communication setting that matches a predefined communication criterion.

Broad identification of problems
1) A significant amount of research and standardisation activities have been surrounding RIS in recent years. Considering that already a number of different types of RISs are identified as described above, some challenges may be applicable only to a certain type of RIS. Regardless of the type of RIS, it can be broadly classified as a non-regenerative and full-duplex repeater, as it will not regenerate the original signal (to decode and forward), and it is by its nature a full-duplex reflector. Note that the terms “relay” and “repeater” are interchangeably used in the document unless otherwise stated. Some challenges identified for such a repeater will also apply to RIS. Specifically, recent developments in 3GPP 5G standardisation have focussed on the use of Smart Repeaters (SR), whereby SR is a type of an amplify and forward (AF) repeater with the additional capability to process side control information to enable cost-efficient beamforming in 5G TDD (and FDD) networks. From that perspective, many challenges identified for SR apply to RIS. Hence, embodiments are based on the finding that within a single wireless communication system (WCS), a challenge is to determine (based on a type of RIS)
   control information required between RIS/RIS controller and BS/UE to enable beamforming/MPC control
   how is such control information to be conveyed (e.g. format, messages etc.)
   how to identify a RIS and sub-structures (e.g. sub-panels) in the network
   how to control/orchestrate operation of multiple RIS

These challenges span various aspects of control, which include required signalling, channel estimation at the gNB, resource allocation and scheduling.
2) RIS surfaces will likely be shared in a variety of scenarios. For this purpose, the operators may rent a subset of the pre-deployed RISs in two principal ways: i) orthogonal, via reserving a certain sub-area of each RIS; or ii) non orthogonal, where joint use of the whole RIS area is allowed and the RIS resources are allocated through spatial tuning according to the policies set by the RIS owner [3].

Such scenarios lead to a number of challenges, many of which are identified in 1), but now need to be mapped onto multi-operator environment.

### Reformulated Problem Statement Categorized in Application and Deployment Scenarios for RIS/RRS Wherein the Modification of One or Multiple MPCs is in the Focus.

Embodiments relate to several aspects of the above identified challenges that may be formulated as:
P2P communication links between a network node A and a network node B may comprise or consist of one or more multi-path components (MPC) which allow to convey signal energy und data from a transmitter to a receiver located at A and B, respectively, wherein those MPC may suffer from amplitude or phase changes and therefore as a single MPC and/or as a combination of multiple MPCs may create destructive signal superposition in frequency domain.
   According to an embodiment, an active change of one or multiple MPCs by a RIS may allow to provide stable and tracible MPCs between A and B.
P2P communication links may suffer from blockage of dominant MPCs, therefore becoming suffering from link gain degradation.
   According to an embodiment, an active change of one or multiple MPCs by a RIS may allow to create alternative paths to overcome the blockage problem.
Location A and B might not be connected well over single or multi-bounce scatterers due to low reflection or unfavourable diffraction coefficients on object surfaces belonging to the radio propagation environment in the area around A and B and in between.
   According to an embodiment, an active change of one or multiple MPCs by a RIS may allow to extend the communication range between A and B.
A transmitter at location A and a receiver at location B might have a suitable communication link of MPCs between A and B but is super-imposed by co-channel or adjacent-channel interference from another communication source/link which cause interference via radio signal clusters/surfaces which are the same or different.
   According to an embodiment, an active change of one or multiple MPCs by a RIS may allow to manage interference in spatial domain.
A transmitter at location A and a receiver at location B may have a radio channel with MPCs in between, wherein the rank of such channel is low or even too low to operate MIMO-Multiplexing efficiently.
   According to an embodiment, an active change of one or multiple MPCs by a RIS may allow to change/increase the rank of the radio channel.
A transmitter at location A and a receiver at location B want to communicate but certain MPCs allow an unwanted eavesdropper to listen into this communication.
   According to an embodiment, an active change of one or multiple MPCs by a RIS may allow to reduce the received signal strength at the eavesdropper.
Range or coverage extensions by repeaters are usually only available for the band of the operator who has deployed the repeater, while repeating other bands requires further permission of another operator (MNO).
   According to an embodiment, an active change of one or multiple MPCs by a RIS may allow to influence radio waves propagating without permission/license of one or multiple MNOs.
   According to an embodiment, using a passive RIS/RRS may allow to configure and provide one or more suitable MPCs without the classical reception and transmission process involved by a repeater (Amplify and Forward, digitize and amplify and forward) or decode and forward—relays.
MPCs belonging to a particular radio link between a transmitter at location A and a receiver at location B may not easy to identify in space described by a direction or location.
   According to an embodiment, an active change of one or multiple MPCs by a RIS may allow the identification of a RIS induced MPC and explicit and targeted configuration and optimization of such MPC.

While the above-mentioned problem statements refer to the use of RIS/RRS and associated benefits, embodiments are based on the finding to solve further problems arising with the control of RIS/RRS to serve the above-mentioned purpose and therefore identified the need for a control framework for RIS/RRS.

One of the aspects of the present embodiments is on the control and control framework around the use of RIS/RRS.

Framework is this context may be understood as:
Interfaces
Protocols, Formats, commands, Bit structures, code books,
Measurements and reports
Feedback
Control loops
Orchestration
Prioritization, Scheduling
Capabilities and capability reports
Validation, verification, authenticity, and/or
RIS control in this context is about controlling the “property” which is related to the MPC

In the following detailed problem statements and solutions are described that are tailored to address the control mechanisms (methods) of one or more RIS/RRS
deployed in a radio propagation being a part of the radio channel between a transmitter at location A and a receiver at location B.
1. According to embodiments RIS/RRS deployed in a radio propagation environment are identifiable in order to make them become part of a channel measurement and reporting procedure and/or an optimization of one or more links between network node in a wireless communication network.
   a) Embodiments relate to how to identify existence/signature of a MPC which is related to a RIS/RRS
      i. This may be realized by measurement, RS, validation, verification, . . .
   b) Embodiments relate to how to discover that RIS related MPCs are existing
      i. This may be realized by measurements, reference signals, RS, a data base or the like
   c) Embodiments relate to how to discriminate RIS related MPCs from other non-RIS related MPCs and determine their interaction/entanglement
      i. This may be realized by measurements, RS or the like
   d) Embodiments relate to how to identify a RIS/RRS and sub-structures (e.g. sub-panels) within
      i. This may be realized by measurements, RS, an exposure function or the like
   e) Embodiments relate to information of configuration states (e.g. to infrastructure, to neighbouring cells, or even to groups of UEs)
   i. This may be realized by a measurement, signalization, orchestration or the like
   ii. This information could be used by, e.g. a base station to configure BF weights, or by UEs to decide on how to report on channel state
2. According to embodiments, solutions are provided how to control the effect of RIS/RRS on MPCs, e.g., in an open loop and/or a closed loop manner
   a) Embodiments relate to a control of RIS that could be done in a static way, semi-static (using predefined or calculated phase shift values) or dynamic (using predefined or calculated phase shift values)
      i. Embodiments relate to switching between different operation modes such as coverage enhancements (RSRP-based), signal-processing based e.g. beam tracking (a few milliseconds) and tight interaction with connected gNB e.g. enhanced zero-forcing/MMSE/MRT/CoMP (symbol duration) (interface, protocol). Furthermore, we embodiments consider the cases where a RIS:
         has no sensing/channel estimation capability; or
         has sensing/channel estimation capability.
   b) Embodiments relate to measurement procedures between transmitter(s) and receiver(s)
   c) Embodiments relate to how to distinguish between reconfigurable MPC and non-configurable MPC contribution from collocated scatterers
      i. This may be realized by measurements, RS, an exposure function, a data base or the like
   d) Embodiments relate to how to control (desired/useful) signals in a multi-user scenario, e.g. one user in the middle and the other at the edge of coverage
      i. This may be realized by considering and/or distinguishing RIS sub-panels, perhaps frequency band dependent, by measurements, by scheduling, by using a data base or the like
   e) Embodiments relate to impediments to bandwidthparts, BWP, switching or frequency band switching
   f) Embodiments relate to considerations whether there are implications/actions/functionality required I a case of the WCS/WCN when Channel State Information, CSI, delay is beyond an acceptable or predefined level
   g) Embodiments relate to how to collect measurements from receivers belonging to more than one MNO
      i. This may be realized by using a configured interface and/or a protocol or the like
   h) Embodiments relate to a single RIS being shared between or used by different operators, e.g., using a different interface, protocol, scheduling or the like
      i) Embodiments relate to functionality or actions that are to be controlled in the WCS/WCN. Amongst them there may be a complete RIS entity, or multiple RIS in parallel or in series, or any combination thereof, sub-panels, e.g. forming co-prime structures etc. For example, a selection of codebooks to be applied to the structures or other more adaptive ways similar to digital beamforming
3. Embodiments relate to how to control one or more RIS/RRS, e.g., via a protocol, orchestration and/or messages
   a) Embodiments relate to an identification and registration of the RIS to the network and/or a network entity
   b) Embodiments relate to control who is the master (controller) of a RIS/RRS and an impact thereof to several links or the same of different MNOs
   c) Embodiments relate to a control or decision or consideration which entity can request an action from a RIS. For example, this may relate to users similar to DL-beamforming or MNOs similar to a repeater configuration
      i. This may be realized by implementing priorities, installing an authority or the like
   d) Embodiments relate to an orchestration of multiple RIS/RRS deployed by the same or different MNOs. According to an embodiment, a wireless communications network or a controller thereof may be being configured for orchestrating a plurality of RIS contributing for a communication between a plurality of entities in the wireless communication network. For example, this may be implemented for orchestrating the plurality of RIS to achieve an overall optimisation result for the wireless communication, e.g., according to one or more optimization criteria such as throughput, reliability, interference or the like. This may be done regardless whether the plurality of RIS are deployed by same or different mobile network operators, MNOs.
   e) Embodiments relate to an implementation of a static/quasi-static (slow) vs. fast reconfiguration of MPCs
      i. This may be realized by scheduling, coordination or the like
   f) Embodiments relate to a calibration of RIS, evaluation of the process of aging of metasurface or the impact of the environment on the accuracy
      i. The information that, for example, UEs may have on where they are can be used to assist in calibration of RIS, or determining whether RIS is properly calibrated.
4. Embodiments relate to scenarios where a data base in which RIS/RRS are registered in is available or not
   a) This may be realized by considering who is operating it
      i. This may comprise a validation, verification, authenticity or the like
   b) This may be realized by considering what protocols are used
      i. This may comprise a consideration of interfaces, protocols or the like
5. Embodiments relate to what information/descriptive data is available/disclosed via a data base or via the RIS/RRS itself. For example, this may include a consideration of an exposure and/or a discovery, capabilities and capability reports, validation, verification, authenticity or the like
6. Embodiments relate to sending commands to a RIS/RRS, e.g., using one or more protocols
   a) This may be realized by using existing messages broadcasted by the gNBs e.g. MIB, SIB. Embodiments relate to a mapping of such messages to transport channels
   b) Embodiments allow to distinguish whether the RIS/RRS is able or unable to reply or transmit signals or messages indicating
      i. a registration, identification of a RIS/RRS to a gNB and/or UEs
      ii. a confirmation of commands/configurations
      iii. a request of coordinated actions with a gNB and/or other RIS/RRS
      iv. a disclose/exposure capabilities to the network (gNBs and/or UEs)
7. Embodiments relate to how to inform other network elements e.g. gNBs about actual and potential configuration states of one or more RIS/RRS
a) Embodiments relate to a tightness between the interaction of beamforming of a gNB and the settings of RIS/RRS
b) For example, embodiments relate to a consideration, be the transmitter, the receiver or different node, when to focus on small scale (fast) or large scale (slow) fading in the WCS MPC
8. Embodiments relate to control loops/requests/inputs that may come from:
   a) UEs, gNB, regulators, OTT, other MNOs, scheduled or event based instructions, or the like

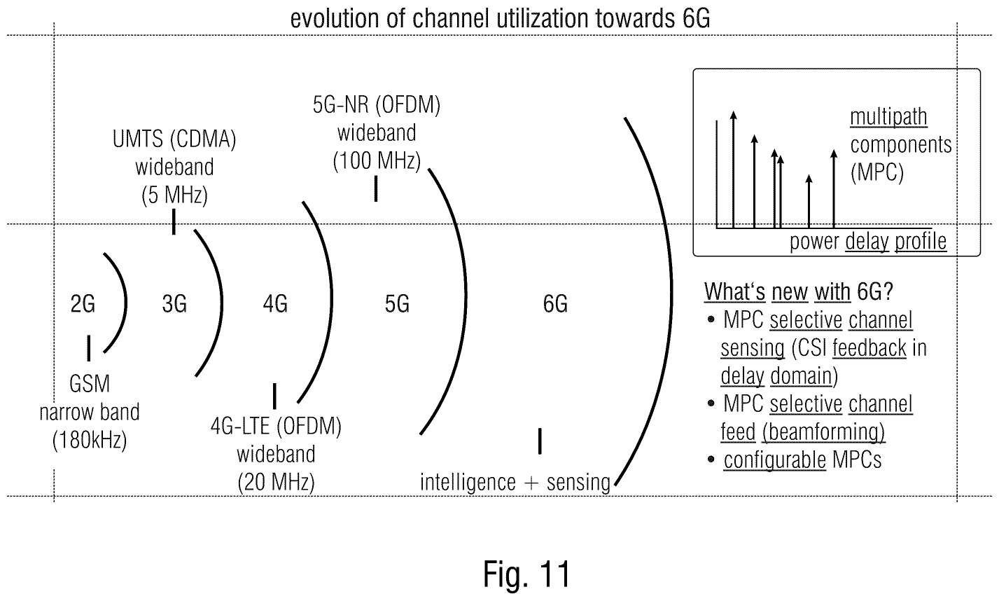

FIG. 11 shows a schematic illustration of a time line how the radio channel was handled by different generations of mobile communication systems. 2G: narrow band transmission→fading of uplink or downlink; 3G-wideband signal to average out small scale fading using CDMA→cell breathing with load, inefficient use of resources; 4G: using wider channels (20 MHz) and MIMO-OFDM for higher spectral efficiency→very sensitive to small scale fading; 5G: even wider channels (100 MHz) MIMO-OFDM and higher frequencies C-band and FR2)→super sensitive on fast fading changes, fading can become wideband in case of only few MPCs, blockage becomes a significant issue. Beamforming in 5G allows to match signal power to selected MPCs; delay domain channel feedback is supported from release 16. MISSING pieces addressed in this invention disclosure: identification of MPCs associated to RIS/RRS and suitable control of such RIS/RRS.

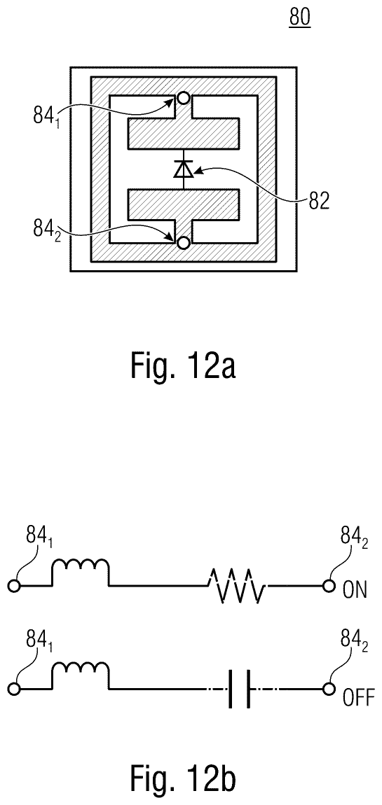

FIG. 12a shows a schematic top view of an example tunable reflecting element 80 that is based on a PIN diode and that may be used in a RIS used in WCN/WCS according to an embodiment. The tunable reflecting element 80 may comprise, for example, a PIN diode 82 coupled between DC feeding locations 84₁ and 84₂.

FIG. 12b shows a schematic equivalent circuit diagram of the tunable reflecting element 80 in a first state “ON” and a second state “OFF” between which the tunable reflecting element may be switched based on the DC voltage between locations 84₁ and 84₂ to control the behavior of the PIN diode 82.

In other words, FIG. 12a and FIG. 12b show an example of a simple RIS/RRS element suitable to change reflective properties of a meta-surface.

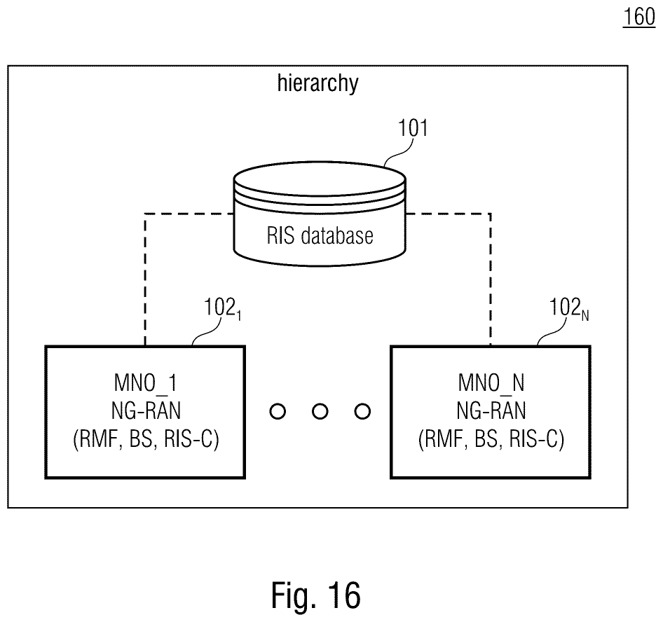

In the following detailed solutions tailored to address the control mechanisms (methods) of one or more RIS/RRS deployed in a radio propagation being or becoming a part of the radio channel between a transmitter at location A and a receiver at location B is described to explain several embodiments of the present invention.
a) According to an embodiment, a control of RIS could be done in a static way, semi-static (using predefined or calculated phase shift values) or dynamic (using predefined or calculated phase shift values)
   i. Switching between different operation modes such as
      1. coverage enhancements (RSRP-based),
      2. signal-processing based e.g. beam tracking (a few milliseconds)
      3. tight interaction with connected gNB e.g. enhanced zero-forcing/MMSE/MRT/CoMP (symbol duration) (interface, protocol)
      4. Self-operation of RIS panel or RIS-Controller, e.g. based on AI methods or other data-driven mappings
      5. other methods are not precluded
         Furthermore, we can consider the cases where RIS:
      has no sensing/channel estimation capability
      has sensing/channel estimation capability.
   ii. the measurement parameters such as KPIs can be directly exchanged between transmitter and receiver or between transmitter and RIS panel/controller or between receiver and RIS panel/controller or between all entities involved in a communication path/link
   iii. Alternatively or in addition, a subset or additional measurement and configuration parameters can be exchanged via an additional network entity such as a RIS Management Function (RMF) similar to e.g. the LMF (in the context of positioning and sensing).
   iv. The additional network entity could be integrated with e.g. LMF
   v. The RMF can simply hold parameters and guide the exchange between transmitters and receivers or can provide AI-functionality
   vi. The RMF AI-functionality can be but not limited
      1. Measurement data collection, e.g. AoA/AoD/ZoA/ZoD, beam directions, RSRPs on subband/wideband (beam squinting) or on given beamforming configurations (see 2.a.i). All values can be observed on gNB (transceiver type1=fixed), UE (transceiver type2=mobile) or on RIS level.
      2. Configuration history
      3. AI-frameworks (neural networks, random forest, Bayesian, transfer learning, tensor-based, online/offline methods . . . )
      4. Interface for AI-training over time (feedback from gNBs/UEs/UAVs/sensors)
      5. Processing capabilities
      6. Auxiliary information such as lidar or non 3GPP, beacon signals
   vii. The RMF can be integrated fully centralized e.g. in Campus networks or distributed for a set of RIS panels/controllers in a given coverage region of a network (for a single MNO or multiple MNOs)
   viii. Embodiments relate to the usage/attachment to a specific transmitter-receiver pair for a given time/frequency slot. This especially holds for tight integration into the signal processing at the fixed or mobile transceivers. This can also be tracked and monitored with the RMF.
b) Embodiments relate to optimization among multiple RIS panels/controllers, fixed and mobile transceivers, MNOs How to report about between reconfigurable MPC and non-configurable MPC contribution from collocated scatterers This may include a use of measurement, RS, exposure function, data base
   Explained briefly in 1c). Embodiments relate to reporting aspects of configurable MPS but do not exclude the pilot design, channel estimation algorithms etc.
c) Embodiments relate to how to control (desired/useful) signals in a multi-user scenario, e.g., using the controller unit. This may include, e.g., one user in the middle and the other at the edge of coverage This may be done via RIS sub-panels, e.g., frequency band dependent, by using measurement, scheduling, data base, beam squinting, or the like
d) Embodiments relate to impediments to BWP switching or frequency band switching, e.g., using the controller unit
   ix. As RIS may display different reflection properties with respect to different frequencies, certain frequency-related RIS properties may be described in the DB/RMF to share with, e.g. other operators.
e) Embodiments relate to implications/actions/functionality required if CSI delay is beyond the acceptable. For example, transmitter and receiver may exchange their capabilities in handling CSI delay, e.g. prediction capabilities or delay tolerance. Therefore, the RMF can be used provide access to desired and/or guaranteed delay constraints/targets. These values can be directly connected to processing strategies at the transmitter and/or receiver side. Examples are also given in section as indicated above. Furthermore, the RMF may assist in selecting the appropriate processing strategy.
f) Embodiments relate to collect measurements from receivers belonging to more than one MNO. This may include a use of at least one interface and/or protocol. FIG. 16 shows a schematic block diagram of a part of a wireless communication scenario 160 in which a database 101 is accessible to one or more MNOs 102 and illustrates the manner in which the RIS database 101 is accessible to a plurality of MNOs 102₁ to 102_{N} and thus provides an example of the means for sharing/transferring measurements between receivers. In this example, a standardized interface together with standardized protocols might be needed to overcome the restrictions created through the disparate MNOs using proprietary equipment/interfaces/protocols for the collection, storage, analysis and or processing of measurement data.
g) Embodiments relate to a scenario in which a single RIS is shared between different operators by using at least one of an interface, a protocol, a scheduling.
h) Embodiments consider what to be controlled in a wireless environment. For example, a complete RIS, or multiple RIS in parallel or in series, or any combination thereof, sub-panels, e.g. forming co-prime structures etc. A selection of codebooks to be applied may be used, in embodiments, to the structures or other more adaptive ways similar to digital beamforming.

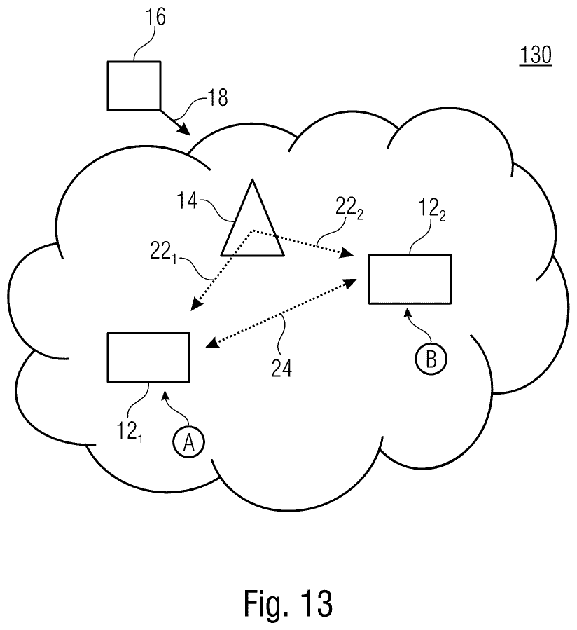

FIG. 13 shows a schematic block diagram of a wireless communication network or system 130 provided for wireless communication between a first entity 121 and a second entity 122. Entities 121 and 122 may, independently from one another, be configured as a user equipment, an IoT device, a base station, a relay, a repeater or a different device wirelessly communicating in the wireless communication network 130. The wireless communication is adapted to include a reconfigurable intelligent surface 14. The wireless communications network 130 comprises a controller unit 16 that is preconfigured, configured or configurable for organizing a contribution of the RIS 14 to the wireless communication network 130. The controller unit 16 may be a part of a base station, a user equipment may form a part of a centralized entity or may form a separate entity. Although the controller unit 16 forms a part of the wireless communication network 130, the RIS 14 is not necessarily a part of the network. That is, the controller unit 16 may be implemented at least in parts at the first entity and/or the second entity and/or a central entity of the wireless communication network.

Regardless whether the RIS is included into the network as a part thereof or not, it may be obtained a RIS enhanced wireless communication network, WCN. Examples, of such a network include, beside other entities,
a base station, BS, a UE and a RIS; or
a first UE, a second UE and a RIS
a first BS, a second BS and a RIS
a first UE, a second UE, a repeater/IAB node and a RIS, the repeater repeating a signal between the RIS and one of the UEs
a first BS, a second BS, a repeater/IAB node and a RIS, the repeater repeating a signal between the RIS and one of the Bss
a BS, a UE, a repeater/IAB node and a RIS; the repeater repeating a signal between the RIS and the BS or between the RIS and the UE
UE can include an MT part of an IAB node or serve as backhaul link for e.g. a WiFi router or access points using different RATs

It is to be noted that a UE may comprise, according to an embodied implementation, an MT part of an IAB node or serve as backhaul link for e.g. a WiFi router or access points using different RATs.

The RIS may comprise any location, e.g., mounted on a building, car, satellite, airborne platform, ship. That is, according to embodiment, a terrestrial network and a non-terrestrial network as well as combinations thereof may benefit from a RIS.

Each of those implementations relate to device such as UEs or BSs that are in accordance with embodiments and may operate, e.g., as an entity of a wireless communication network, WCN, described herein, i.e., devices being part of such WCN and being configured to operate with the WCN.

It should be note that the RIS may be actively controlled by the network or may belong to the MNO, i.e., it may form a part of a network. Alternatively, it may be arranged, at least logically, outside the WCN but nevertheless be used by the network so as to form a part of the overall system or scenario. A control request may be transmitted directly to the RIS controller or indirectly, e.g., via a service provider. However, embodiments also relate to scenarios where the RIS may at least temporarily not be controlled by the network, e.g., because the RIS control is unavailable or impossible. For example, a decision to not use the RIS at least temporarily, to at least temporarily substitute the RIS by one or more other RIS or to impinge the RIS with a different beam, e.g., a different frequency band, a different polarization or the like, may have a direct effect on the impact of the RIS on the radio propagation environment and/or the communication between two nodes.

The controller unit 16 preconfigured, configured or configurable for organizing a contribution of the RIS to the wireless communication network may be implemented to recognize the RIS, for identifying the RIS and/or for exchanging, at least to transmit towards the RIS, control signals.

The control unit 16 may transmit a signal 18 towards an entity or communication system 130 and/or to an entity controlling the RIS 14 and/or to the RIS to adapting the behavior of the wireless communication network 130. This may relate to inform an entity about a presence and/or location and/or capability of the RIS 14, to control a state or behavior of the RIS 14 and/or to control other entities to avoid interference towards a multipath component 22₁ and/or 22₂ being used by entities 12₁ and/or 12₂ in addition or as a substitute to a line-of-sight path 24 that may also form an MPC of the wireless communication network 130.

A RIS may have one or more capabilities, wherein the at least one capability may be subject of control or may remain uncontrolled. Within a set of capabilities, one, some or all capabilities may be controllable. For example, although having the ability to implement a specific control of a parameter or capability, the control may be restricted, e.g., with regard to levels of access, a controller being in a same or different network when compared to the RIS or the like.

The capabilities of the RIS may be known and/or determined and/or stored as capability information, e.g., in a database or another network entity described herein, e.g., similar to a location management function, LMF, used for positioning. For example, a feedback information provided by a device in accordance with an embodiment of the present invention can be directed to the first or second entity or to a different network entity, e.g., similar to the LMF and regardless whether the device providing feedback is one of the communication entities or a kind of external (with respect to the communication) observer or measuring entity. Such capabilities and associated parameters (e.g. beamforming codebooks) can be shared or signaled by the RIS or any other network entity having knowledge about the RIS.

With regard to a RIS described herein, an embodied RIS may, beside other capabilities, be capable of individually or selectively forwarding different parts of the electromagnetic spectrum, including radio frequencies, microwaves, mmW, THz, optical frequencies from infrared to higher frequencies. For example,
A RIS or specific parts of the RIS such as panels may be configured of forwarding different frequency parts jointly or separately, allowing joined or individual management of beams and/or multi path components, MPCs; such a capability may be controllable or remain uncontrolled by a controller unit.
Alternatively or in addition, a RIS may be configured for performing frequency band translation allowing for aggregation or disaggregation of incoming multiband signals; such a capability may be controllable or remain uncontrolled by a controller unit.
Alternatively or in addition, a RIS may be configured for changing/translating a multitude of input signals (bands in carrier aggregation, polarizations, orbital angular momentums) into different outputs, e.g. directions, polarization and/or band mappings. For example, the RIS may generate at least one dedicated output signal from at least one received input signal performing the described signal conversion; such a capability may be controllable or remain uncontrolled by a controller unit.

With regard to recognizing the RIS, the control unit 16 may be configured for discovering the RIS and to provide a signal such as signal 16 to the wireless 30 communications network 130 to include the RIS to the wireless communication to organize the contribution of the RIS. This may include, for example, informing entities 12₁ and/or 12₂ directly or indirectly. Alternatively or in addition, information about the RIS, i.e., RIS-related information or MPC-related information, may be stored in a database, the database accessible for one or more members of a wireless communication network 130.

With regard to the recognizing that may form one implementation of organizing the contribution of the RIS, for discovering the RIS, the controller unit may be adapted for accessing measurement results, e.g., based on a reference signal, validating and/or verifying a RIS or a multipath component, MPC, provided/contributed by the RIS to the wireless communication. Such measurement results may be obtained from one or more sensor units, wherein a sensor unit may be implemented by a dedicated device or by a base station, a UE or other communicating devices sharing their measurement results or performing measurements according to instructions.

According to an embodiment, for discovering the RIS, the controller unit may be configured for initiating, instructing, requesting measurements or measurement reports of the contribution of a RIS to the wireless communication, e.g., based on a reference signal, validating and/or verifying a RIS and/or an MPC provided/contributed by the RIS to the wireless communication. That is, the controller unit 16 may access existing measurement reports or may request or instruct an execution of requests to obtain required information.

According to an embodiment, the controller unit 16 may be configured for discovering an MPC provided by the RIS such as MPC 22₁ and/or 22₂ and may report the MPC to the wireless communication network 130. The wireless communication network may be configured for using the MPC responsive to the report. For example, entities 12₁ and 12₂ communicating via line-of-sight path 24 may be informed or may become aware of a presence or availability of RIS 14, of multipath components 22₁, 22₂, respectively, and may make use, based on an own decision or based on received instructions, of those MPCs 22₁ and/or 22₂. For example, entities 22₁ and/or 22₂ may redirect a corresponding beam, may adapt their filters and/or may direct an additional beam towards a direction corresponding to MPC 22₁, 22₂, respectively.

The controller unit 16 may be configured for discovering, identifying, recognizing and/or detecting the MPC based on at least one of:
a measurement performed by an entity internal or external to the wireless communications network;
a reference signal transmitted by an entity internal or external to the wireless communications network;
accessing a database;
perform a validation of the MPC;
perform a verification of the MPC.

The wireless communication network according to an embodiment may be provided such that the RIS 14, e.g., deployed in a radio propagation environment such as the network 130, is identifiable. The RIS 14 or an MPC 22₁ and/or 22₂ provided by the RIS 14 may be part of a channel measurement and reporting procedure in the wireless communication network 130 and/or of an optimization of one or more links between network nodes in the wireless communication network 130. The RIS 14 so as to be identifiable may provide information and/or a behavior that may be recognized and/or identified by other entities or that is at least reported to the network 130. Details about recognizing a RIS are provided later.

The controller unit 16 may be configured for evaluating an association of a detected MPC with the RIS 14 or a different RIS or with a plurality of RISs. For example, an MPC may be detected by an entity receiving wireless signals, e.g., when moving around and in case additional signal energy is received. However, a movement of the receiving entity is not necessary as, for example, also a movement of the RIS or of a scatterer or of a transmitter may be sufficient to provide for deviations in MPC availability. The availability of an MPC itself may also be detected without any movement or change of the availability.

According to an embodiment, the MPC 22₁ and/or 22₂ may form a part of a communication between entities 12₁ and 12₂ in the wireless communication network 130. MPC 22₁ and/or 22₂ may be based or dependent on a location of entity 12₁, of 12₂ and/or a location of the RIS 14 and/or on the locations of a plurality of RSs, e.g., in case one of multiple components 22₁ and/or 22₂ is reflected or redirected by another RIS and/or in case a RIS is located along a further path between entities 12₁ and 12₂.

As identified above, embodiments also relate to discriminate a RIS-related MPC from another, e.g., non-RIS-related MPC. According to an embodiment, the control unit 16 may be configured for discriminating between a RIS-related MPC and a non-RIS-related MPC. Such a discrimination may be based on a measurement performed by an entity internal or external to the wireless communication network 130, e.g., based on a reference signal, transmitted by an entity internal or external to the wireless communication network. Providing such information that allows to discriminate between the RIS-related MPC and the non-RIS-related MPC to entities 12₁ and/or 12₂ may allow at least one of entities 12₁ and 12₂ and/or the controller unit to decide about using the RIS-related MPC for the wireless communication based on the MPC-related information or not. For example, being aware that the RIS-related MPC is a stable MPC but provides, e.g., for a low data throughput may allow for an assessment whether to favor stability or data throughput. In the latter case, whilst risking other types of distortion, entities 12₁ and/or 12₂ may try to exchange information by using non-RIS-related MPCs, e.g., MPC 24 or a path that is reflected at a building or other scatterers.

The MPC-related information may comprise, according to embodiments, at least one of:
a capability information associated with the RIS;
an availability information associated with the MPC, e.g., a schedule related to availability, a time of availability, an ownership, a configuration state of the RIS, of the first entity and/or the second entity or the like
a characteristic of the MPC;
a cost for using the MPC;

The availability information associated with the MPC may relate, for example, to a schedule, a time, an ownership, a configuration state of the RIS, of the first entity 12₁, of the second entity 12₂, of the RIS 14 or the like.

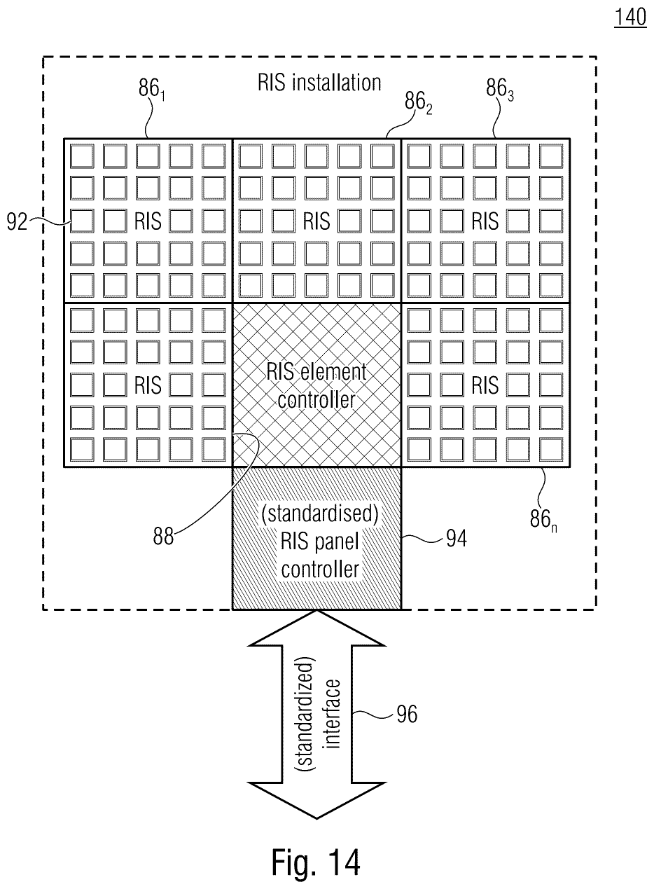

FIG. 14 shows a schematic block diagram of a RIS 140, e.g., a RIS installation having one, more or a plurality of RIS sub-structures 86₁ to 86ₙ. For example, each RIS sub-structure 86 may be formed as a sub-panel. The sub-structures 86₁ to 86ₙ may each be configurable as a separate or individual RIS. Each of the sub-structures 86₁ to 86ₙ may operate or function as individual RIS and may be associated with a sub-structure specific MPC that is identifiable, e.g., based on a reference signal. Embodiments allow to implement the RIS 140 as the RIS 14 of network 130 and/or each or groups of sub-structures 86 as an individual RIS 14. Using sub-structures 86 may allow to provide for one or more, e.g., a plurality of MPC at a specific location, e.g., a wall of a building or the like. The RIS 140 may comprise a RIS element controller configured for individually controlling a RIS element 92 of a RIS sub-structure 86 and/or a group of such elements, i.e., by individually controlling the RIS sub-structures. Optionally, a plurality of RIS element controllers 88 may be arranged in the RIS 140, e.g., one for each sub-structure 86 or one for a group of RIS sub-structures 86.

RIS 140 may comprise a RIS panel controller configured for controlling the RIS 140, i.e., the panel. The RIS panel controller 94 may be a standardized item to allow interconnectivity to other devices in the wireless communications network. This may allow to use a standardized interface 96 for communicating with the RIS 140, although standardization is not obligatory for the RIS panel controller 94 and/or the interface 96.

According to an embodiment, a predetermined activation pattern of at least one of sub-carriers, time-slots and RIS panels and/or their activation order may be implemented. A device in the wireless communication network may be configured, e.g., via a system information block such as SIB and/or via RRC to measure on these reference signal according to the predetermined activation patterns. In other words, FIG. 14 shows an example of a RIS installation comprising a plurality of RIS panels 86, each of which is connected to a RIS element controller 88. While the connection of panels to the element controller 88 may possibly be proprietary, a standardized RIS panel controller 94 is used according to the embodiment to allow the RIS installation 140 to be connected to other network entities via a standardized interface 96.

A RIS/RRS deployed in a radio propagation environment is advantageously able to be identifiable in order to make them become part of a channel measurement and reporting procedure and/or an optimization of one or more links between network nodes in a wireless communication network. According to an advantageous embodiment, the RIS is not only capable of providing a single MPC, e.g., as part of a single connection but may be adapted to provide for a plurality of MPC, e.g., of a same link between same entities or of links between different entities. For example, and as described in more detail with reference to FIG. 14, wherein the RIS may comprises a plurality of RIS sub-structures such as sub-panels that are configurable as separate RISs, wherein each sub-structure is associated with a sub-structure specific MPC identifiable e.g. based on a reference signal, RS.

A task on how to identify the existence/signature of an MPC which is related to a RIS/RRS is solved, according to embodiments, by implementing suitable measurements, reference signals, validation and/or verification procedures.

In order to identify the existence of a RIS-related path, RIS-specific reference signals may be used. RIS-specific reference signals may be transmitted on specific time-frequency resources and/or may use a special sequence or specific patterns. RIS-specific time-frequency resources may, as an alternative or in addition, in general coincide with, e.g., SI-RS.

Further, embodiments address how to discover that the RIS-related MPCs are existing. This may be achieved, e.g., by implementing measurements, reference signals and/or a data base.

### RIS Discovery by a UE

SIB and RIS-specific reference signals may be used. For example, a UE may be informed via a system message such as SIB, that one or more RIS is/are operating in the area. The operator may set up RIS-specific reference signals, which will allow UEs in the area to measure signals on these RSs. Conversely, the UE may be configured with RIS-specific uplink reference signals.

The measurement metric on RIS-specific reference signals are expected to include typical L1 measurement matrix, e.g., RSRP, RSSI, RSRQ and/or SINR.

A RIS can be configured according to different objectives such as coverage enhancement (increasing SNR), increasing in channel rank, interference mitigation (i.e., an intentional increase in fading of interfering signal) or the like. Therefore, the configuration of RISs can be changing, depending on a number of parameters, such as the number of users in the area, their position and/or mobility. With the change in configuration of RIS elements, there may be a need for a change in measurement of RIS-specific signals, of which UEs can be in front, again via an SIB or via dedicated signaling.

### RIS Discovery by an Operator (RIS not Owned/Configured by the Operator)

If the operator does not own the RIS, its base stations could be informed via a database, DB, if a RIS is installed or in case there has been a change in the element configuration. This may allow the operator to perform, e.g., interference measurements on specific RS.

Embodiments relate to discriminate RIS-related MPCs from other, e.g., non-RIS related MPCs and to determine their interaction/entanglement. This may be obtained via measurements and/or reference signals, for example.

A RIS-specific reference signal or a plurality thereof may be transmitted on specific time-frequency resources and/or use a special sequence or specific patterns. RIS-specific time-frequency resources may also, in general, coincide with other reference signals, e.g., CSI-RS. Using specific patterns, such as specific time-slots or antenna patterns or sub-carriers, RIS-specific MPCs may be extracted.

Embodiments relate to identify a RIS/RRS on sub-structures, e.g., sub-panels. This is done, according to embodiments, by using measurements, reference signals and/or an exposure function.

According to an embodiment, the controller unit of a RIS is configured for identifying the RIS and to associate a RIS identifier to the RIS so as to distinguish the RIS from a different RIS in the wireless communications network. The wireless communications network may be adapted for wireless communication by selectively using the RIS based on the RIS identifier to organize the contribution of the RIS.

According to an embodiment, the controller unit of a RIS may be configured for associating, as an alternative and/or in addition a capability information comprising at least one of
a position of the RIS;
an orientation of the RIS, e.g., as a an absolute and/or relative orientation;
an operating frequency range or frequency band of the RIS;
a phase shifting capability of the RIS including granularity of phase shifts;
a beamforming capability of the RIS;
a polarization capability of the RIS;
an operating mode of the RIS;
operating frequency;
an availability of the RIS;
an ownership of the RIS, e.g., in terms of a responsibility/provider
   with the RIS identified to organize the contribution of the RIS. For example, the ID may be dedicated information but may also be formed, partly or completely by the capability information, a, e.g., a location and/or orientation and/or orientation may allow for sufficient distinguishing of the RIS from other RISs.

At least one of the entities associated with the communication, e.g., the first entity or the second entity and/or the controller unit may be configured for controlling the communication and/or the RIS using the RIS identifier and dependent from the capability information. For example, this may include a selection of a RIS. One of the first entity, the second entity and the controller unit may have access to such a database having stored therein a plurality of RIS identifiers and associated capability information. Such a device may be configured for selecting a RIS for forming a part of the communication dependent from the capability information. The controller unit may be configured for identifying the RIS and at least one sub-structure, e.g., a sub-panel, thereof. The controller unit may be configured for providing the RIS identifier and for associating a sub-structure identifier with the sub-structure, wherein the controller unit is configured for providing the sub-structure identifier. With reference to FIG. 14, for example, each of the sub-structures 86 may be associated with an individual identifier.

According to an embodiment, each RIS may therefore have an associated ID. If the RIS is divided in sub-structures, each sub-structure may be associated with an ID, which may also be connected to the main ID of the overall RIS. The ID may uniquely identify the RIS in space, e.g., coordinates, and its configuration. For that, a RIS controller may use a standardized exposure function. The exposure function may provide the information on RIS capabilities to other network entities such as base stations, a data base, DB, or other entities. The exposure function may define different levels of functionality, depending whether the interface is intra-system (operator owned) or inter-system. Furthermore, the exposure function may enable a registration of a RIS. The exposure function may entail using standardized interfaces and protocols, regardless if such interfaces operate in-band or out-of-band. In the case of intra-system interfaces, besides providing the information on RIS capabilities, network entities may request a reconfiguration of a RIS/RIS sub-panel.

When different RIS sub-panels are configured as separate RISs, sub-structures specific RS may be used. In order to reduce overhead associated with introducing RS for each sub-panel, specific activation patterns of sub-carriers, time-slots, RIS-panels and their activation order may be used. As above, a UE may be configured via an SIB to measure on these RSs.

Embodiments relate to information of configuration states, e.g., to infrastructure, to neighboring cells, or even to groups of UEs. This may be achieved via measurements, signalization and/or orchestration.

The controller unit according to an embodiment may be configured for obtaining or performing a measurement result, e.g., based on a reference signal, a validation result and/or a verification result for identifying the RIS. Alternatively or in addition, the RIS may be associated with the RIS identifier in the wireless communication network, e.g., in a data storage and/or a database and/or via centralized or distributed knowledge. The RIS may comprise at least one sub-structure and the sub-structure may be associated with a sub-structure identifier. This sub-structure identifier is associated with the RIS identifier that forms a main ID for one or more sub-structures of the RIS.

As outlined above in connection with on how to identify the RIS, the exposure function can be used to provide configuration states to infrastructure/neighboring cells. Also, as described in connection with how to discover that RIS-related MPCs are existing, UEs can receive information on configuration states via a SIB or dedicated signaling. Embodiments relate to how this information may be used. For example, a base station may use such information to configure beamforming, BF, weights and/or UEs may use such information, e.g., to decide on how to report on a channel state.

### RIS Management Function (RMF)

According to an embodiment, a wireless communications network implements an RMF. Such an RMF may hold information which is important for both the transmitter and the receiver side. This information can be exchanged, e.g., based on pull and/or push methodology and may be at least or exclusively available to a specific transceiver side, a group of UEs (e.g., vehicles, UABs, AGVs or other equipment) or BSs (e.g., macro, small, pico-cell, satellite, relay, repeater or the like). The RMF may be a separate functional entity. It can be co-located or not with a RIS controller. It can also communicate with a RIS controller. A UE and/or a base station can find out whether a RIS operates in the area by communicating with the RMF.

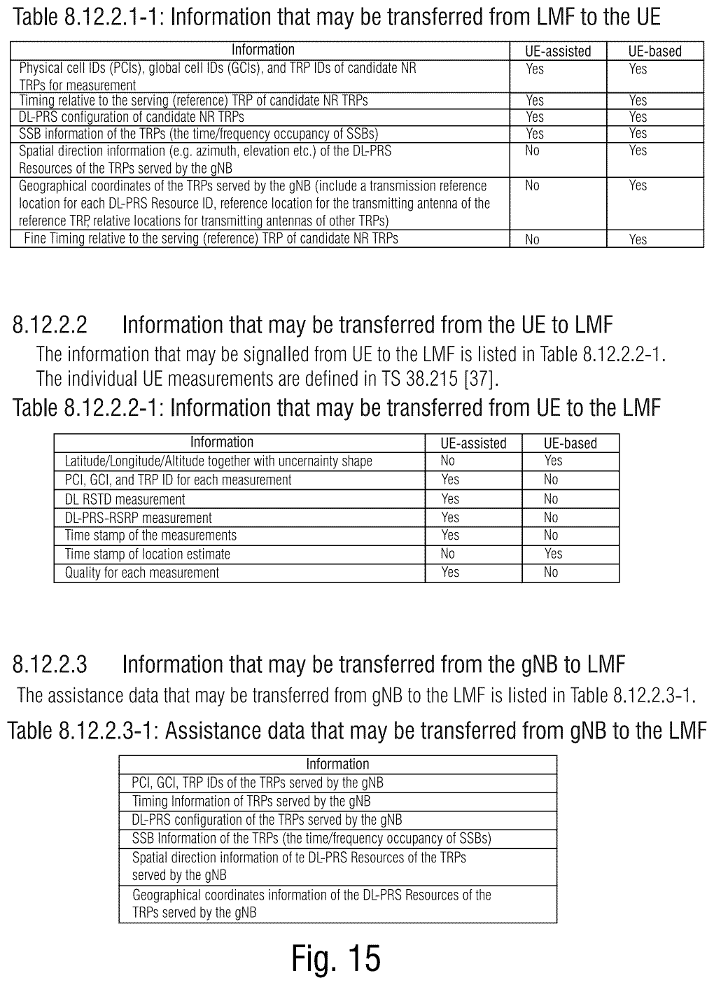

Further information on RMF functionality is described hereinafter. FIG. 15 shows example parts taken from the LMF specification 3GPP TS 38.305 version 16.6.0 release 16. Based thereon, embodiments provide for a solution on how to control the effects of a RIS/RRS on MPCs in an open loop and/or closed loop.

According to an embodiment, the controller unit is to organise the contribution of the RIS based on an implication/action/functionality associated with CSI reporting/availability delay or channel quality being unacceptable. Alternatively or in addition the controller unit may organise the contribution of the RIS based on measurements collected from receivers belonging to more than one mobile network operator, e.g., using corresponding interfaces and/or protocols.

The RMF may hold information on controllable entities, which can be mapped to RIS panel, subpanels or subsets of elements (such as co-prime, adaptive spacing, pure horizontal or vertical elements or 2D arrays or 3D arrays). Beyond the selection of RIS elements, a more specific selection of element combinations, similar to codebooks for precoding, or a very generic adjustment of combination weights can be controlled. This can be done directly over a given control channel or using given functionality in the RMF.

Alternatively or in addition, according to an embodiment, the controller unit is configured to obtain information about the RIS, e.g., based on an Id, an MPC, an availability, or the like and may provide the information to at least one of:
a base station;
a neighbouring cell;
at least one user equipment

Embodiments relate to how to control one or more RIS/RRS. This may include a use of a suitable protocol, orchestration and/or messages

a) Embodiments relate to an identification and registration to the network/a network entity.

For example, in order to become an active and configurable part of a wireless communication link a RIS may be known to other network elements e.g. gNBs, UEs to which the RIS may become or is contributing as an relevant MPC. A suitable procedure/mechanism has to be envisioned to support such feature in particular when a RIS panel is deployed in the network and is to be integrated in the operational procedures of such network.

According to embodiments, an identification and registration to the network may include but is not limited to the following:
The RIS communicates to the WCN via a channel which is, for example, either part of the WCS or not (not being part of could be an outband communication channel e.g. WiFi or cable, which allows the RIS e.g. to connect to the internet and request registration to the network via an IP address and appropriate registration commands), and
Using the communication channel the RIS panel will identify to a network entity as being a RIS using at least a RIS-type identification and a unique identifier associated with the RIS (such unique identifier could be validated e.g. via a data base operated by the manufacturer), and
Using the communication channel the RIS panel will request registration to a network, e.g. an MNO's network, where the RIS belongs to or when a particular gNB is received by the RIS panel's communication unit as the strongest gNB nearby.
The identification and registration procedure may contain further steps as discussed herein.
b) Embodiments relate to deciding who is the master (controller) of a RIS/RRS which has impact to several links of the same of different MNOs.

With regard to the registration, according to an embodiment, the RIS is configured, e.g., through a RIS controller, for providing at least one of:
a registration in the wireless communications network;
an identification in the wireless communication network;
a confirmation for confirming a received command and/or a configuration;
a request of coordinated actions with a gNB and/or other RIS
an exposure to the wireless communication network;
a capability of the RIS, e.g., using a capability report;
a validation of the RIS, e.g., using a validation report;
a verification of the RIS, e.g., using a verification report
an authenticity of the RIS, e.g., using an authenticity report

According to an embodiment, the RIS is configured for a provision via a database or via the RIS itself.

According to an embodiment, the controller unit is to organise the contribution of the RIS by controlling at least one of:
the complete RIS,
multiple RIS in parallel or in series,
sub-panels, e.g. forming co-prime structures etc., a selection of codebooks to be applied to the structures or other more adaptive ways similar to digital beamforming,
any combination thereof.

According to an embodiment, the RIS contributes to a communication in at least a first cell and a second cell being part of the same or of different wireless communication networks;
wherein the RIS is associated with one cell of the first and the second cells as a primary RIS cell and wherein the RIS is associated with the other cell of the first and the second cells as a secondary cell being subordinated to the primary cell, e.g., in terms of requesting and controlling reconfiguration of the particular RIS or its contribution.

According to an embodiment, the wireless communication network is configured for forwarding a configuration request from devices associated with the primary cell and/or the secondary cell directly or indirectly, e.g., using a gNB to gNB over e.g. X2, to the primary cell, e.g., a base station thereof; wherein the wireless communication network is configured for processing the configuration request;
wherein the controller unit associated with the primary cell is adapted for coordinating/orchestrating a RIS configuration considering inputs/requests from intra-primary-cell end-to-end links, intra-secondary-cell end-to-end links, inter-cell configuration requests and/or measurement reports.

According to an embodiment, the controller unit is configured for receiving a request for a RIS reconfiguration or a report about a multipath component, MPC, containing the RIS:
Initiated/provided by a first network device to which a RIS is being/became part of an e2e link in a wireless communication system, WCS
Initiated/provided by a second network device directly or indirectly connected to the first network device that acts as a forwarder/proxy for the second device, e.g., experiencing the RIS associated to at least one of its end-to-end, e2e, MPCs.

According to an embodiment, the RIS controller is adapted for considering inputs such as reports and/or requests from a plurality of bands and/or several MNOs for controlling and configuring the RIS.

According to an embodiment, the RIS is a first RIS, wherein the controller unit is for organising a contribution of a plurality of RIS including the first RIS, the plurality of RIS being operated by a same or by different mobile network operators.

According to an embodiment, the RIS is part of a first section of the wireless communication network and a second section of the wireless communication network; wherein the controller unit is configured for negotiating a use of the RIS for the first section and the second section, e.g., at multiple cells; and/or
wherein the RIS contributes to the wireless communication inside the wireless

communication network and to a communication outside the wireless communication network; wherein the controller unit is configured for negotiating with a controller unit at least influencing the wireless communication outside the wireless communication network about a use of the RIS.

According to an embodiment, the first section is controlled by a first network operator, wherein the second section is controlled by a second network operator.

According to an embodiment, the controller unit as adapted to negotiate at least one of an interface, a protocol and a schedule associated with the RIS between the network operators.

According to an embodiment, the wireless communications network is configured for identifying and/or registering the RIS to the network and/or a network entity, e.g., by the controller unit or the RIS itself as a network entity.

According to an embodiment, the wireless communications network is configured for determining a master controller of the RIS, e.g., having impact to several links of the same or different MNOs, e.g., by the controller unit.

According to an embodiment, the wireless communications network is configured for determining or controlling at least one entity to be able to request an action from the RIS, e.g., users similar to DL-beamforming or MNOs similar to a repeater configuration, priorities, authorities, e.g., by the controller unit.

According to an embodiment, the wireless communications network is configured for determining or controlling at least one entity to be able to request an action from the RIS and at least a further r network entity, e.g. a gNB or a UE or a further RIS.

A RIS deployed in network may be part of multiple e2e links wherein the ends of the links belong to different cells (gNBs) of the same MNO network or to cells (gNBs) of different MNOs. Since the RIS may have impact to MPCs for links belonging and operated/managed by different entities e.g. gNBs (base stations) the RIS controller has to be associated with one Primary Cell as being the Primary.RIS.Cell for a particular RIS panel or group of RIS panels, whereas other cells nearby wherein the RIS is part of at least one e2e communication link (either belonging to the same MNO or to a different) may be organized as Secondary.RIS.Cells subordinated to the Primary.RIS.Cell in terms of requesting and controlling reconfiguration of the particular RIS. I.e., If RIS can be frequency-dependent, it can be associated with frequency. A RIS may, e.g., be associated with Primary RIS cell. Secondary CC coverage/propagation will also be affected. Primary cell may decide to change reflections due to the impact on Secondary CC.

In this manner/structure each RIS is associated to only one Primary.RIS.Cell and several Secondary.RIS.Cells allowing flexible and reconfiguration of the Primary.RIS.Cell on demand.

Furthermore, the role of the Primary.RIS.Cell is valid across several frequency bands and/or BWP. Furthermore, in case of an inband wireless control channel between the Primary.RIS.Cell and the RIS this channel will be used to transfer all configuration signals while configuration request from devices associated to the Primary.RIS.Cell and/or Secondary.RIS.Cells are directly or indirectly (gNB to gNB over e.g. X2) transmitted/forwarded to the Primary.RIS.Cell, e.g., a base station thereof, more particular to the gNB responsible to emit the primary cell ID), and processed and the RIS configuration coordinated/orchestrated by Primary.RIS.Cell considering inputs/requests from intra-primary-cell e2e links, intra-secondary-cell and inter-cell configuration requests and/or measurement reports.
c) Embodiments relate to decide who can request an action from a RIS. For example, users similar to DL-beamforming and/or MNOs similar to a repeater configuration. Such decisions may include a use of priorities and/or an authority.
   A request for a RIS reconfiguration or a report about a MPC containing a RIS can be:
      Initiated/provided by any network element to which a RIS is being/become part of an e2e link in a WCS
      Furthermore, network devices directly or indirectly connected to a network device describe beforehand may act a forwarder/proxy for the device experiencing a RIS associated to at least one of its e2e MPCs.
   In case several devices/entities report about RIS induced MPCs or request a change in RIS configuration then these “input” can be processed by the RIS controller or a responsible entity for wireless link control and such input can be weighted, prioritized etc. before concluding an action resulting in a change of configuration of the RIS.
d) Embodiments relate to an orchestration of multiple RIS/RRS deployed by the same or different MNOs.
   If a RIS may affect wireless e2e links across multiple bands and/or MNOs the RIS control and configuration should consider inputs (reports, requests) from several bands and/or several MNOs.
   If several MNOs have control about own RIS deployed in their networks with impact across the networks, then the configuration of the RIS(s) belonging to different MNOs have to be orchestrated OR coordinated across the different bands and/or networks. This can be done in a centralized and/or decentralized manner.
e) Embodiments relate to static (slow) vs. fast reconfiguration of MPCs. This may include scheduling and/or coordination of the reconfiguration. According to an embodiment, the network or a controller thereof is configured for reconfiguring at least one multipath component, MPC in a static or slow manner and/or in a dynamic or fast manner, e.g., by the controller unit. Slow may relate to several days, hours or minutes, whilst a dynamic reconfiguration may relate to a shorter time between a reconfiguration.

In case of a RIS being associated with at least one MPC of a single e2e link then the adaptation of the RIS configuration should ideally follow at the speed of the path coherence time. That is, according to an embodiment, the network or a controller thereof may be configured for configuring one or more RIS for supporting one or more MPCs of at least one wireless link; and for updating a configuration of the one or more RIS at a time scale, e.g., static, slow, dynamic, fast, corresponding to a coherence time of the wireless signal transferred using the MPCs relevant to the wireless link(s), the update initiated by the controller unit.

Depending on the selected link adaptation scheme and beamforming the coherence time of the wireless signal transferred using a the MPCs with and without beam tracking at the TX and/or RX side can be in the order of a few milliseconds to several seconds. Thus, a fast reconfiguration or tracking of directions and/or phases by a RIS could be beneficial if one or a few MPCs are to be optimized. For example, the wireless communications network of one the embodiments described herein may be configured for reconfiguring a multipath component, MPC in Static or slow manner and/or in a fast manner, e.g., by the controller unit. According to an embodiment, the network may be configured for configuring one or more RIS for supporting one or more multipath components of at least one wireless link. Further, the entities may be configured for updating the configuration of the RIS(s) at a time scale, e.g., static, slow, dynamic, fast, corresponding to the coherence time of the wireless signal transferred using the MPCs relevant to the wireless link(s), the update initiated by the controller unit.

In another embodiment of a RIS being a contributor to MPCs belonging to many e2e links with one common or different end points any change or RIS configuration has impact on many MPCs therefore it appears more reasonable to align the rate of RIS configuration to changes on a more macroscopic scale e.g. user distribution, traffic distribution etc. and therefore static or semi-static RIS configurations which can be changed in regular intervals or sequences may offer reasonable observation and behaviour acquisition time/windowing to incorporate a known and repeated or predictable behaviour of a changing radio propagation environment into link management, link optimization and resource scheduling of one and/or many e2e links.

Therefore, embodiments propose to align the RIS configuration changes to be aligned and synchronized with at least:
Radio frame period
Slot period
Symbol period
Short symbol period
Or any combination of the above.
The sync can be referenced/anchored to the Primary.RIS.Cell and/or a Secondary.RIS.Cell.
f) Calibration of RIS, evaluation of the process of aging of metasurface or the impact of the environment on the accuracy
   x. The information that, for example, UEs may have on where they are can be used to assist in calibration of RIS, or determining whether RIS is properly calibrated.

According to an embodiment, a wireless communications network is configured for calibration of the RIS, for evaluation of the process of aging, e.g., of a metasurface and/or the impact of the environment on the accuracy, e.g., by the controller unit. According to an embodiment, that may be realized as an alternative or in addition, a wireless communications may be configured for providing information or instructions to at least one apparatus/entity of the wireless communication network, for example, UEs, where the apparatus may use a multipath component, MPC, wherein the apparatus is requested to assist in calibration or contribution of the RIS, or determining whether RIS is properly calibrated or contributing/performing correctly, e.g., by the controller unit.

According to an embodiment, that may be realized as an alternative or in addition a wireless communication network has a controller unit that is configured/adapted for changing the contribution of a RIS-created MPC statically; semi-statically and/or dynamically.

According to an embodiment, that may be realized as an alternative or in addition the controller unit is adapted for changing the contribution in intervals or sequences regularly or irregularly. According to an embodiment, that may be realized as an alternative or in addition the controller unit is adapted for changing the contribution of a RIS-created MPC based on a known or predicted behaviour of a changing radio propagation environment providing an impact to link management, link optimization and resource scheduling of one and/or a plurality of end-to-end, e2e links of the wireless communication network.

According to an embodiment, that may be realized as an alternative or in addition the controller unit is for aligning a RIS configuration to changes in accordance with an assignment of radio resources, e.g., aligned and/or synchronized with, at least one of:
a radio frame period of the wireless communication network;
a slot period of the wireless communication network;
a symbol period of the wireless communication network;
a short symbol period of the wireless communication network;
a combination of the above.

According to an embodiment, that may be realized as an alternative or in addition the alignment is with respect to a communication link within a primary cell or a secondary cell to which the RIS contributes.

Making reference again to FIG. 16, embodiments provide for a wireless communication network that has a database storing information about available, identified and/or identified RIS, i.e., there is database where RIS/RRS are registered. The database 101 of FIG. 16 may be considered as an example of RIS database accessible by one or a plurality of MNOs.

Embodiments also relate to implementations where a database is provided where RIS/RRS are registered in.
a) With regard to the RIS database, embodiments define who is operating it, e.g., by use of validation, verification and/or authenticity
   For example, A RIS/RRS database can be operated by:
   i. One or more mobile network operators (MNOs);
   ii. One or more RIS/RRS network operators (RNOs)—a new concept wherein the RIS/RR infrastructure is owned/installed/maintained/updated by an RNO rather than by an MNO;
   iii. One or more SOLAR+RIS/RRS network operators (SRNOs)—a new concept wherein the SRNO infrastructure is owned/installed/maintained/updated by an SRNO rather than by an RNO or by an MNO. The SRNO can provide a variety of services not limited to include: an energy harvesting; energy provision; energy distribution; energy storage; RIS/RRS network functions;
   iv. A member of a group of MNOs. For example MNO1 and MNO2 and MNO4 have agreed to disclose their database content—either in full or in part—to one another such that certain details of the RIS/RRS equipment installed by one MNO is available to the members of the group of MNOs;
   v. A member of a group of RNOs. For example RNO1 and RNO2 and RNO4 have agreed to disclose their database content—either in full or in part—to one another such that certain details of the RIS/RRS equipment installed by one RNO is available to the members of the group of RNOs;
   vi. A member of a group of SRNOs. For example SRNO1 and SRNO2 and SRNO4 have agreed to disclose their database content—either in full or in part—to one another such that certain details of the RIS/RRS equipment installed by one SRNO is available to the members of the group of SRNOs;
   vii. A member of a group that is any combination of one or more MNOs, RNOs and SRNOs;
   viii. A member of a group that is any combination of one or more groups of MNOs, groups of RNOs and groups of SRNOs;
   ix. A member of a group that is any combination of one or more MNOs or groups of MNOs, RNOs or groups of RNOs and SRNOs or groups of SRNOs;
   x. A RIS/RRS database provider;
   xi. A regulatory authority; and
   xii. A government agency.

The identity of a network entity that accesses a RIS/RRS database [the accessor] can be checked or validated or authenticated against a list of allowed or permitted or privileged or accepted or registered or authorized database users [accessors] before the content of the database is made available to the accessing network entity.
b) Embodiments relate to solve the issue what protocols to be used. This may include a definition of at least one interface and/or at least one protocol.
   For example, a RIS/RRS database can be accessed:
      i. using protocols and interfaces that are standardized—for example, 3GPP, IEEE, eCPRI, Open-RAN; and
      ii. using protocols that connect networks—for example, (non-3GPP access) 5G core to other backhaul networks; and
      iii. directly using interfaces that can be wired or wireless interface or combinations thereof or indirectly via an over-the-top connection and making use of a RIS management function (RFM).

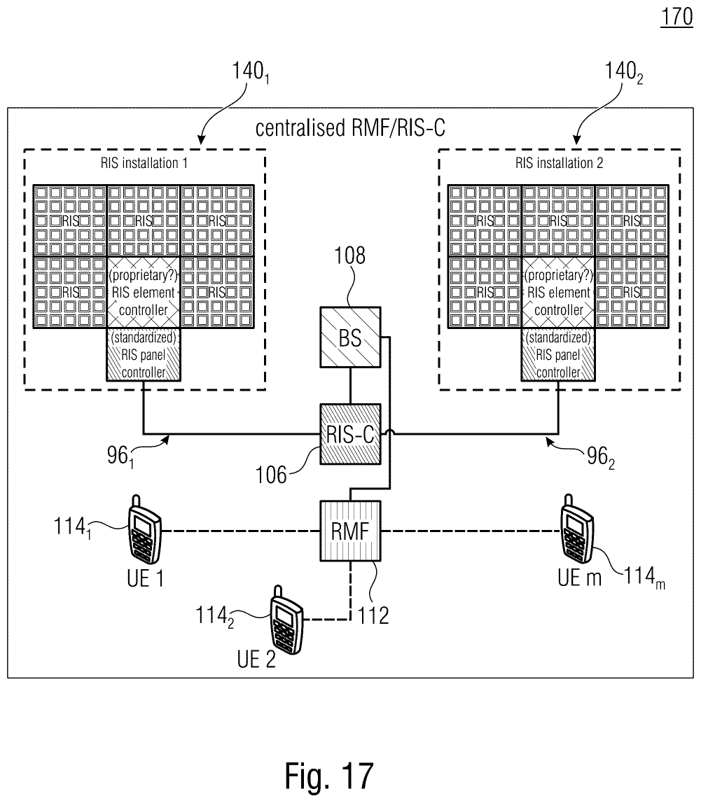

FIG. 17 shows a schematic block diagram of at least a part of a wireless communication network 170 according to an embodiment, the wireless communication network 170 having a plurality of RIS, e.g., each independently implemented as a RIS 140 or a different RIS described herein.

A RIS controller 106 may control the RISs 140₁ and/or 140₂ using the respective interface 96₁, 96₂ respectively. The RIS controller 106 may be in communication with a basestation 108 that may be in accordance with the basestation of FIG. 1 further being able to handle RIS-specific communication.

The basestation 108 may be in communication with a RMF 112 described herein, the RMF 112 accessible for UEs 114₁, 114₂ and/or 114ₘ of a same or different MNO. FIG. 17 is, thus, an example of a centralised RMF/RIS-C architecture showing the logical interfaces between functional components.

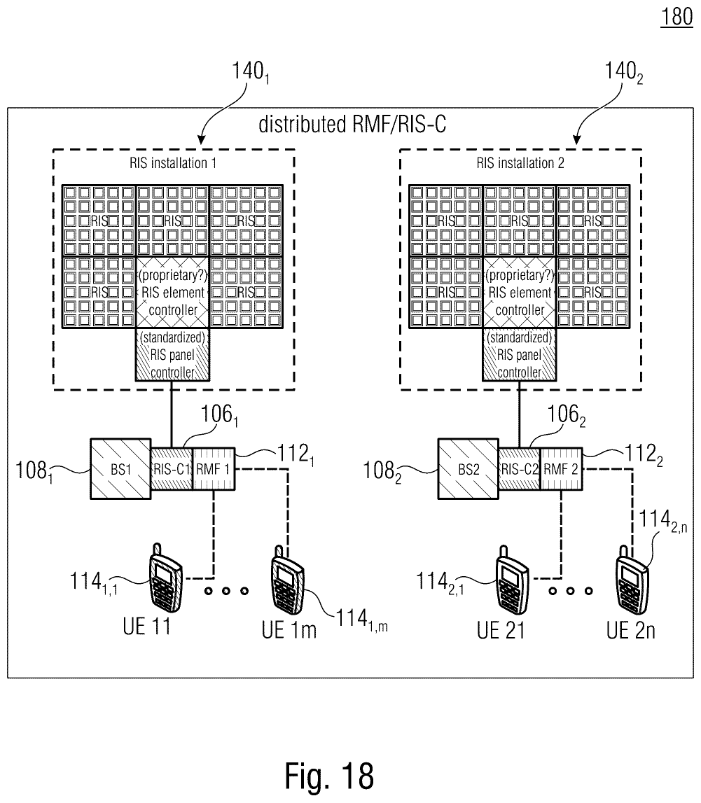

RIS-controller 106 and RMF 112 can be deployed in a centralised or in a decentralised manner, individually or jointly. FIG. 17 and FIG. 18 are the examples of centralised and distributed deployment by both entities. They can be separate entities, or can be a part of, e.g. a base station.

FIG. 18 shows a schematic block diagram of at least a part of a wireless communication network 180 according to an embodiment, the wireless communication network 180 having a plurality of RIS, e.g., each independently implemented as a RIS 140 or a different RIS described herein. FIG. 18 illustrates a scenario of a distributed RMF/RIS-C architecture showing the logical interfaces between functional components.

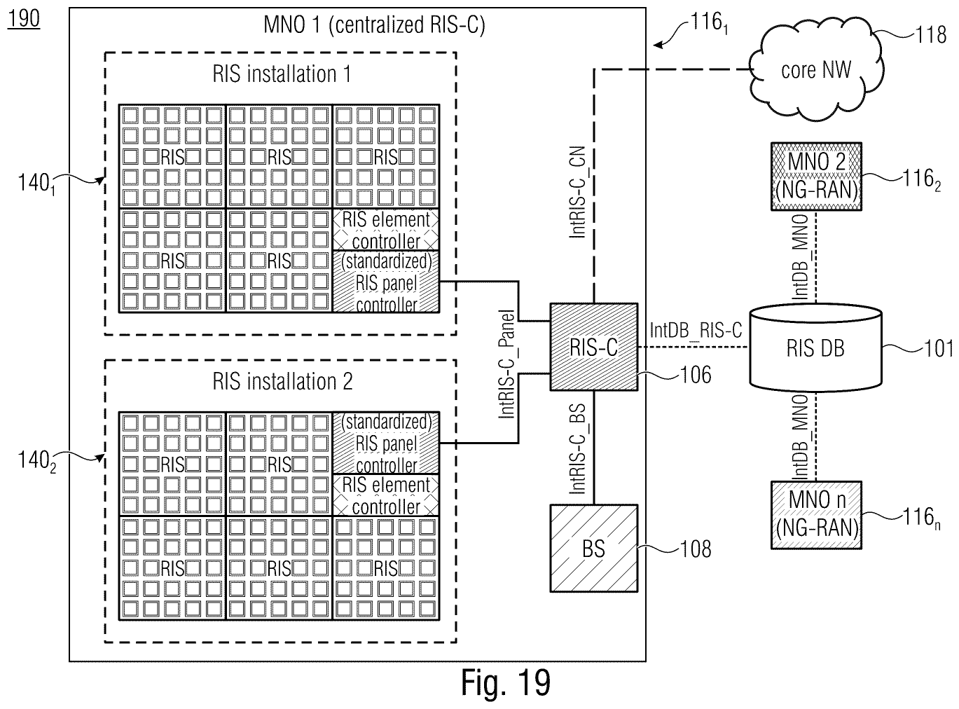

FIG. 19 shows a schematic block diagram of at least a part of a wireless communication network 190 according to an embodiment, the wireless communication network 190 having a plurality of RIS, e.g., each independently implemented as a RIS 140 or a different RIS described herein. The RIS 140₁ and 140₂ may be connected to a same RIS-Controller, RIS-C, 106 as described in connection with FIG. 17, the RIS-C 106 operated by a first MNO MNO₁ that uses a RAN 1162. RAN 1161 may have access to a RIS DB 101 that is also accessible for one or more other MNOs, e.g., via their respective RAN RAN₂ to RANₘ, which does not exclude the RIS-C 106 to communicate with a Core Network 118. In other words, FIG. 19 may be understood as an example of a controller hierarchy for controlling a RIS 140 or parts thereof.

Embodiments provide for a solution what information/descriptive data is or may be available/disclosed via a data base or via the RIS/RRS itself. For example, this may relate to exposure/discovery of a RIS, to capabilities and capability reports, to validation, verification, authenticity or the like.

The following list comprises embodiments related to the type of information or descriptive data that is available or is disclosed (directly) via the RIS/RRS itself or (indirectly) via the RIS/RRS database:
i. Geolocation of RIS/RRS—either absolute according to a known geological survey or mapping grid or relative with reference to a given locator or reference point (datum) or map coordinators;
ii. Altitude or RIS/RRS—with respect to a given reference, mean height above sea-level, street level, ground floor of a certain building;
iii. The direction or orientation of the RIS/RRS can be specified as a line normal or perpendicular to the plane of the RIS/RRS panel/infrastructure;
iv. The trajectory of the RIS/RRS specified according to a recognized coordination scheme—needed in applications where the RIS/RRS forms part of a moving object e.g. a vehicle, a UAV, a satellite;
v. The dimensions of the RIS/RRS installation—for example M metres in length by N metres in height;
vi. The area of the RIS/RRS installation—for example P square metres;
vii. The inclination angle of the RIS/RRS installation—for example Q degrees measured with respect to the horizon (i.e., a 0°-degree inclination angle describes a panel positioned in a plane perpendicular to flat earth or in other words, aligned parallel to the side of a vertical structure such as a building wall);
viii. The operating frequency range of the RIS/RRS—for example the range of frequencies that a RIS/RRS can be configured so as to reflect/transfer a radio wave (within the operating frequency range);
ix. The acceptance or incidence angular range—for example the span of angles over which the RIS/RRS can be configured so as to accept a radio wave (within the operating frequency range) for either reflection or transmission (within the operating frequency range);
x. The reflection angular range—for example the span of angles over which the RIS/RRS can be configured so as to reflect a radio wave (within the operating frequency range);
xi. The transfer angular range—for example the span of angles over which the RIS/RRS can be configured so as to transfer a radio wave (within the operating frequency range);
xii. The reflection polarization range—for example the span of polarization angles over which the RIS/RRS can be configured so as to change or rotate the polarization of a reflected radio wave (within the operating frequency range);
xiii. The transfer polarization range—for example the span of polarization angles over which the RIS/RRS can be configured so as to change or rotate the polarization of a transferred radio wave (within the operating frequency range); xiv. The maximum number of incidence/reflected wave pairs that can be created (within the operating frequency range);
xv. The maximum number of incidence/transferred wave pairs that can be created (within the operating frequency range);
xvi. The type of RIS/RRS panel—for example, RIS/RRS only or a hybrid solar photovoltaic and RIS/RRS combination.
xvii. The temperature of the RIS/RRS panel;
xviii. The date of manufacture of the RIS/RRS panel;
xix. The country of manufacture of the RIS/RRS panel;
xx. The manufacturer of the RIS/RRS panel;
xxi. The owner of the manufacture of the RIS/RRS panel;
xxii. The serial number of the RIS/RRS panel;
xxiii. Built-in self-test information;
xxiv. Operational information;

Embodiments relate to sending commands to a RIS/RRS, e.g., using a protocol
a. Embodiments provide for a concept to use, in some implementations, existing messages broadcasted by the gNBs e.g. MIB, SIB, e.g., by using a mapping to transport channels. For example, the controller unit may be configured for mapping commands for the RIS to transport and/or control channels of the wireless communications network, the commands, e.g., broadcasted by a gNBs of the wireless communications network e.g. in a master information block, MIB, or system information block, SIB.
   In the context of this invention disclosure a RIS/RRS has primarily reconfigurable reflective properties and such properties are controllable via a RIS controller. This leaves open how the connection between the RIS controller and the RIS panel is realized. At the one end of implementation options the RIS/RRS panel could be fully passive (not responding to control signals in the form of a message) and the RIS elements are reconfigured by an RIS element controller e.g. via a change of voltage, current etc., the RIS element controller might be connected via a cable to the RIS controller. At the other end of the implementation spectrum the RIS panel may have e.g. a wireless receiver embedded and a signal processing unit capable to process received messages and to reconfigure the RIS panel according to given instructions into a new configuration. In such case the RIS element controller can exchange (receive/transmit) messages between the RIS controller and the RIS element controller using a e.g. a wireless interface in between. This example is valid when the RIS controller is not collocated with the element controller.
   Such communication link between the RIS controller and the RIS panel (which includes the RIS element controller) can use either:
      At least one of the frequency bands or BWP being the same like the RIS is operating on in the e2e communication link(s),
      A frequency bands or BWP being different from the band or BWP the RIS is configurable for in the e2e communication links,
      The same RAT like the e2e communication link(s) where the RIS is part of,
         Using the same message formats as used to communicate between other non-RIS network elements in the WCN
         Using different message formats e.g. special messages according to a NRCC specification
      A different RAT than the e2e communication link(s) are using where the RIS is part of, OR
      Using a wireless communication network element e.g. a gNB or UE which belongs to the same or different MNO where the RIS panel belongs to (belonging refers in this context to either the MNO where the RIS panel may have impact to communication links operated by the MNO or network elements e.g. a gNB or a UE which a part of that MNO's network and which can directly communicate with the RIS panel).

In this context, according to an embodiment, a RIS may use a receiver which is tuned to at least one frequency/band where another network element, e.g. a base station is operating on using a standardized wireless protocol (3GPP including 5G-NR) and may send control signals to the RIS receiver. A further implementation in accordance with embodiments is that the receiver is using at least one band where the RIS operates on, wherein operates on means wherein the RIS provides a configurable MPC in a wireless link of a wireless network. The following list comprises options to inform the RIS about configuration (states) to be configured/adapted/selected/activated via a message originating from:
1. a RIS controller (in case the RIS controller is not collocated with the RIS panel)
2. a network element involved in the wireless link wherein the RIS controls a MPC of it and the RIS controller is at least partially collocated with the RIS panel. (examples: A RIS could be requested to emit a RS to be identified or to activate a particular configuration at a given time or particular configurations in a sequence, furthermore this could include type I or type II like feedback from a UE or gNB when the RIS is offering/using e.g. a beam/reflection direction 6 grid)

The following embodiments related to broadcast, multi-cast and unicast can be used to transmit the RIS control message by a network element to the RIS receiver, wherein the message is mapped at least onto, i.e., the RIS device may be configured for receiving the message in downlink direction and/or uplink direction:
DOWNLINK Direction from a gNB/base station to the RIS receiver
   I. PDSCH (Physical Downlink Shared Channel) using SIBs or User plane data mapped as unicast or multicast message
   II. PDCCH (Physical Downlink Control Channel)/DCI
   III. SSB (System Sync Block) via
      a) MIB (Master Information Block)
   IV. Control Information Elements (CORESET is a set of physical resources and it carries PDCCH/DCI)
   V. Coresets (coresets can contain information elements for individual users, a group of users or all users and can therefore be used to address an individual RIS or a group of RIS.
   VI. This does not preclude further options where to map the RIS control messages onto
Alternatively or in addition, in UPLINK Direction, e.g., from a UE to the RIS receiver
   VII. Message mapped into RACCH message space
   VIII. ACK/NACK or any other kind of response messages corresponding to a particular DL communication protocol, e.g. gNB and UE are establishing a bi-directional control link, wherein the RIS is in listening mode/role. The gNB could send control information/configuration messages to the RIS and the RIS follows. The UE is the observer of the resulting change in at least one MPC (e.g. measures phase and/or amplitude on a particular MPC) and provides measurement feedback into the opposite direction wherein such control-loop feedback is processed by the gNB and/or the RIS.
      The messages can be either encrypted or non-encrypted OR may or may not require feedback e.g. ACK/NACK from the recipient.
      As an alternative other RATs, e.g. WiFi, NB-IoT, optical or cable connections could be used to exchange control messages from and between the RIS controller and the RIS.
b) [Sending control and/or control-assisting messages towards the RIS controller: Such embodiments refer to measurement feedback and/or configuration requests from network elements involved in the wireless link]
   [Solution: what to send to RIS controller:]
   Since the RIS is an element to shape the wireless propagation environment by at least changing/controlling one MPC the effect on the DL and/or UL channel has either to be measured/observed end-to-end (e2e) between a wireless transmitted and a wireless receiver marking the start and end of a wireless link AND/OR “half-way” by spitting up the e2e wireless link into segments wherein receiver being part of particular segments will provide measurement/observation feedback. “half-way” may refer to a capability of the RIS to exploit at least some of its own properties to estimate e.g. angle of arrival (AoA) and or signal strength when processing a received signal from a gNB and/or a UE. Having said this, a RIS control framework will include measurement feedback and/or action request from receiving network elements wherein such element(s) may belong to a particular e2e wireless link or to another wherein another may refer to the same or another band, gNB/cell or MNO. According to an embodiment, in connection with changing/controlling one multipath component, MPC, at least one member of the wireless communication network is adapted for measuring/observing an effect on the DL and/or UL channel of a wireless end-to-end (e2e) link of the wireless communication network a wireless transmitter and a wireless receiver placed between the start and the end of the wireless link and/or a part thereof, e.g., a half-way.
   The measurements about the e2e wireless link or parts of it can be performed and/or reported by at least one of:
   I. a gNB/base station end of the wireless link, e.g. uplink
   II. a UE end of the wireless link, e.g. downlink
   III. a RIS along the e2e link
   IV. another network element, e.g. a repeater in the e2e link
   V. any other receiver equipped network element which is not part of the particular e2e wireless link to be optimized or reported about BUT being subject to a change of received signal originating from the transmitter (start) of the e2e wireless link itself or from a RIS involved in the e2e link.
      Beyond measurement reports to be processed by a receiving entity in the network, further control messages can be sent to the RIS controller or other network elements involved in the e2e wireless link with the RIS. These messages may include:
         I. selection of specific configurations or configuration parts (input angle vs. output angle at the RIS)→similar to type I feedback
         II. combination of specific configurations or configuration parts with and w/o particular weighting→similar to type II feedback
         III. requests to increase OR reduce a particular signal strength into a particular direction/sector/spatial segment
         IV. request to reduce interference power
         V. request to avoid or configure particular phase AND/OR amplitude of a reflected signal

According to an embodiment, the wireless communication network is configured for providing a measurement feedback and/or action request from a receiving network entity; wherein the receiving network entity is part of a particular e2e wireless link or of another link; operated in a same or different band, by a same or different gNB in a same or different cell or by a same or different MNO.

According to an embodiment, a measurement being subject of feedback is performed and/or reported by at least one of:
a gNB/base station end of the wireless link, e.g. uplink
a UE end of the wireless link, e.g. downlink
a RIS along the e2e link
another network element, e.g. a repeater in the e2e link
any other receiver equipped network element which is not part of the particular e2e wireless link to be optimized or reported about wherein such said receiver is subject to a change of received signal originating from the transmitter (start) of the e2e wireless link itself or from a RIS involved in the e2e link, e.g. as becoming a victim of interference.

According to an embodiment, the wireless communication network is configured for transmitting a control message or a further control message to a RIS controller or to a different network element involved in the e2e wireless link with the RIS.

According to an embodiment, the control message or the further control message comprises at least one of:
a selection of specific configurations or configuration parts (input angle vs. output angle at the RIS)→similar to type I feedback
a combination of specific configurations or configuration parts with and w/o particular weighting→similar to type II feedback
a request to increase or reduce a particular signal strength into a particular direction/sector/spatial segment
a request to reduce interference power
a request to avoid or configure particular phase and/or amplitude of a reflected
signal
[How to send to RIS controller:]
The above-described measurement report and/or request messages can be mapped to any available physical or logical transport channel for user and/or control data which provides a direct or indirect connectivity between the reporting/requesting network element and the RIS controller.
A further option includes a potential man in the middle agent or aggregation points where in case of feedback/requests from one or multiple entities such feedback/request is prioritized/ordered/merged/weighted/selected/combined or otherwise pre-processed before being forwarded to the RIS controller as input/feedback values.
c) [Solution: case of RIS/RRS be able to reply (transmit)] for
In SOTA configuration procedures and configuration setting activation the device receiving a configuration usually confirms receipt of the configuration and responds appropriately e.g. if and/or when the requested configuration can be executed. Following this rationale, the inventors see a need to enable a RIS to respond to control, feedback and/or configuration messages by proposing to introduce a transmit functionality the RIS panel. Such transmitter could operate outband via wireless or cable or in-band wherein in-band means that the RIS transmitter is using a frequency band and/or RAT which forms part of a receiver which belongs to the wireless network the RIS belongs to or is operated in or is appropriately connected to directly or indirectly, e.g. NB-IoT, WiFi, 3GPP, same or different MNO . . . .
Given such transmit functionality the RIS panel can send and/reply messages to other network elements directly or indirectly such messages may include but are not limited to the following:
i. Registration of a RIS/RRS to a network: an important feature to allow the RIS to advertise its existence to a network or a network element belonging to the network. This could include a kind of RACCH procedure like a UE (then the transmit functionality is partially similar to a IAB-MT) or very rudimentary, sending noticeable patterns/RS to be detected and processed by e.g. a gNB. Once registered by the network, the RIS could be listed in a data base to provide information about its existence, capabilities, properties, protocols, location, serving/controlling entity (RIS controller) etc. That is, a UE may comprise an MT part of an IAB node or serve as backhaul link for e.g. a WiFi router or access points using different RATs.
ii. Disclose/exposure capabilities to the network (gNBs and/or UEs): RIS can disclose/advertise its capabilities and properties the network and or the RIS controller. The RIS controller might be unambiguously associated or has to be selected by the network or in negotiation with the RIS or the RIS owner and to be allocated as the serving RIS controller. A RIS control can be realized over a single controller or multiple controllers, wherein a multi-agent control setup may benefit from e.g. priority rule mechanisms.
iii. Identification of a RIS/RRS to a gNB and/or UEs using e.g. RS or other clearly identifiable signals or pattern which can be directly or indirectly related/associated with the RIS, its properties and/or current or future configuration. This feature will allow receivers to identify the existence, presence, relevance of a RIS as a significantly contributing MPCs. Furthermore, it might help for beams to be formed, paired and/or tracked.
iv. Confirmation of commands/configurations: this enables standard configuration, de-activation of states etc. similar to the control of a UE and/or gNB
v. Request of individual or coordinated actions with a gNB and/or other RIS/RRS: this is in particular important for interference management within one or across multiple cells, within one or across multiple bands, within one or across multiple MNO networks/bands.

According to an embodiment the wireless communication network is configured for mapping a signal to a RIS controller to an available transport channel of the wireless communication network which provides a direct or indirect connectivity between the reporting/requesting network element and the RIS controller.

According to an embodiment, the wireless communication network comprises a middleman-like entity or an aggregation point device to receive feedback/requests from one or multiple entities, and configured for prioritizing/ordering/merging/weighting/selecting/combining or otherwise pre-processing the received signals before forwarding a result thereof to the RIS controller as input/feedback values.

According to an embodiment, the wireless communication network comprises a single controller or a multitude of controllers for controlling the RIS.

According to an embodiment, the wireless communication network is configured for changing a configuration of the RIS based on assignment of radio resources within a frame structure, a slot structure or a symbol length and/or structure or configuration of the wireless communication network.

According to an embodiment, the wireless communication network is configured for changing a configuration of the RIS synchronised and coordinated with beamforming at the at least one of the first entity and the second entity, e.g., a gNB, wherein the wireless communication network is adapted to control the RIS to serve as a distributed virtual Transmission/reception Point (TRP).

According to an embodiment, at least one of the first entity and the second entity comprises at least one of:
a base station;
a repeater;
an IAB node;
a relay node;
a user equipment;
a central entity of the wireless communication network, e.g. a third party controller, RNC, core network, CN.

Embodiments relate to how to inform other network elements e.g. gNBs about actual and potential configuration states of one or more RIS/RRS.
a) How tight has the interaction of beamforming of a gNB and the settings of RIS/RRS to be

As discussed in above, the change of RIS configuration should either be very slow (semi-static) to target large scale effects like coverage enhancement or interference reduction on a cell base rather than with respect to individual links.

According to an embodiment, the wireless communications network is configured for changing an operating mode of the RIS for the wireless communication.

According to an embodiment, the operating mode is changed to one of:
a coverage enhancement mode;
a signal-processing based mode;
an interface mitigation mode, e.g., zero-forcing, MMSE, MRT, CoMP;
a power optimization mode;
a sensing mode, e.g., this could include surveillance/observation

According to an embodiment, the wireless communication network is configured for changing the operating mode
statically;
semi-statically, e.g., using predefined or calculated phase shift values; and/or
dynamically, e.g., using predefined or calculated phase shift values

According to an embodiment, changing the operating mode is related to at least one of
coverage enhancements (e.g., RSRP-based);
signal-processing based, e.g., to perform beam tracking for a certain time duration such as a few milliseconds; and/OR
tight interaction with a connected device such as a gNB or UE and its operating mode e.g., enhanced zero-forcing, minimum mean-squared error, MMSE, MRC/CoMP, or an operating parameter e.g. symbol duration, slot, sub-frames, frame or an operating schedule.

According to an embodiment, changing the operating mode and/or maintaining an operating mode comprises, by the wireless communication network, an open-loop and/or a closed-loop control. Alternatively or in addition, the controller unit may organise the contribution of the RIS by controlling an effect of the RIS on at least one multipath component, MPC, e.g., by controlling the RIS, for example, in an open-loop or closed-loop manner. For example, input for the open-loop or closed-loop control are provided by the controller unit, a UE of the wireless communication network, a gNB of the wireless communication network, a regulator of the wireless communication network, over-the-top, OTT entities of the wireless communication network, another mobile network operator, MNO, a scheduled or event based instruction of the wireless communication network.

According to an embodiment, changing the operating mode and/or maintaining an operating mode comprises, by the wireless communication network, a measurement procedure between at least one transmitter and at least one receiver of the wireless communication network, e.g., having the RIS therebetween.

According to an embodiment, the controller unit is configured for distinguishing between a reconfigurable multipath component, MPC, provided by the RIS and a non-configurable MPC-contribution, e.g., from a collocated scatterer such as based on a measurement, a reference signal, RS, an exposure function, a data base or the like.

As an alternative, the change of RIS configuration can be tightly bound to frame, slot or symbol length and structure. Furthermore, when such changes are synced and coordinated with beamforming at the gNB the RIS may be used as a distributed virtual Transmission/reception Point (TRP) and a single gNB can exploit the macroscopic multiplexing and/or diversity features which result from multi-TRP transmission schemes with non-collocated TRPs. In particular, coherent joint transmission is more simple to be implemented than with real independent gNBs which have to be phase synced to a high precision.

Based on the disclosure of the present invention, embodiments provide for a reconfigurable intelligent surface, RIS, device, comprising:
a reconfigurable intelligent surface configured for providing a multipath component in a wireless communication network;
a RIS panel control unit configured for controlling a property of the reconfigurable intelligent surface;
wherein the RIS panel control unit is configured for indicating RIS information comprising at least one of:
a RIS identifier, serial number, model number, SKU, date of manufacture, MAC address;
   a position of the RIS in space;
   a property, capability, availability, accuracy, reliability or function of the RIS
   a pointer pointing towards further information elements related with the RIS device, e.g., a database entry, a coded information such as a QR code pointing to an IP address or uniform resource locator, URL.

According to an embodiment, the RIS panel control unit is configured for indicating the RIS information using a network exposure function of the wireless communication network; or using a random access message.

According to an embodiment, the RIS device comprises a transmitter unit configured for transmitting the RIS information using a signal and using downlink resources and/or uplink resources of the wireless communication network.

According to an embodiment, the RIS device is adapted for providing the information on RIS capabilities and/or for reconfiguring a sub-structure such as a RIS sub-panel based on a request for reconfiguration received from a network entity, e.g. a RIS controller.

According to an embodiment, the RIS device is adapted for transmitting, e.g., to the wireless communication network, at least one of:
a message for registration, identification of the RIS, e.g., to a gNB and/or UEs
a message for confirmation of commands/configurations
a message for requesting coordinated actions with a gNB and/or other RIS/RRS
a message for disclosing/exposing capabilities to the network (gNBs and/or UEs)
a RIS identifier, serial number, model number, SKU, date of manufacture, MAC address;
a position of the RIS in space;
a property, capability, availability, accuracy, reliability or function of the RIS

According to an embodiment, the RIS device comprises a RIS panel controller and a RIS element controller, e.g., as described in connection with FIG. 14 e.g., being part of a RIS sub-structure, configured for controlling a RIS element or the RIS sub-structure; wherein a communication link between the RIS controller and the RIS panel controller is implemented for at least one of:
using at least one frequency band or bandwidth part, BWP, the RIS is operating on in the end-to-end, e2e, communication link(s), e.g., by providing a multipath component
using a frequency band or BWP being different from the band or BWP the RIS is configurable for in the e2e communication links,
Using the same radio access technology, RAT, like the e2e communication link(s) where the RIS is part of,
using a same message format as used to communicate between other non-RIS network elements in the wireless communication network;
using a different message format e.g. special messages according to a new radio control channel, NRCC, specification
using a different RAT than the e2e communication link(s) are using where the RIS is part of, OR
using a wireless communication network entity or element e.g. a gNB or UE, that belongs to the same or different MNO when compared to a RIS panel

According to an embodiment, the RIS device comprises a receiver unit that is configured for operating on at least one frequency/band where another device of the wireless communication network operates, e.g. a base station is operating on using a standardized wireless protocol (3GPP including 5G-NR) and sending control signals to the RIS receiver.

According to an embodiment, the RIS device is configured for receiving a message indicating information for the RIS about at least one configuration state to be configured/adapted/selected/activated by the RIS, the message originating from:
a RIS controller, e.g., in case the RIS controller is not collocated with the RIS panel;
a network entity involved in a wireless communication link to which the RIS device contributes; wherein the RIS controls a multipath component, MPC, of the RIS device and the RIS controller is at least partially collocated with the RIS panel.
a network element involved in a wireless communication link to which the RIS device contributes; wherein the RIS controls a multipath component, MPC, of the RIS device and the RIS controller is at least partially collocated with the network entity, e.g. a gNB or a UE.
and to operate accordingly.

According to an embodiment, the RIS device is configured for receiving the message in:
a downlink direction, e.g., from a gNB/base station to the RIS receiver
   a PDSCH (Physical Downlink Shared Channel) using system information blocks SIBs or User plane data mapped as unicast or multicast message
   a PDCCH (Physical Downlink Control Channel) and/or downlink control information, DCI
   SSB (System Synchronisation Block), e.g., via a MIB (Master Information Block)
   Control Information Elements (CORESET is a set of physical resources and it carries PDCCH/DCI)
   Coresets (coresets can contain information elements for individual users, a group of users or all users and can therefore be used to address an individual RIS or a group of RIS.
and/or
an uplink direction, e.g. from a UE to the RIS receiver
   a message mapped into RACCH message space
   an ACK/NACK or any other kind of response messages corresponding to a particular DL communication protocol, e.g. gNB and UE are establishing a bi-directional control link, wherein the RIS is in listening mode/role.
   According to an embodiment, the RIS device is configured for receiving the message encrypted or non-encrypted.

According to an embodiment, the RIS device is configured for receiving the message so as to require or not require feedback e.g. ACK/NACK from the recipient and to operate accordingly.

According to an embodiment, the RIS device is configured for receiving the message using a radio access technology, RAT, different from a RAT used for e2e communication, e.g. WiFi, NB-IoT, optical or cable connections and/or to exchange control messages from and between the RIS controller and the RIS.

According to an embodiment, a wireless communication system is provided, e.g., network 130 comprising at least one wireless communication network and a centralised or decentralised controller entity, e.g., the controller unit, a combination of controller units or other distributed entities, for organising a contribution of at least one reconfigurable intelligent surface, RIS, to wireless communication in the wireless communication system.

According to an embodiment, the wireless communication system may operate in a plurality of frequency bands, the wireless communication system having a plurality of RIS associated to same or different frequency bands, wherein the controller entity is adapted for orchestrating and/or coordinating the contribution of the plurality of RIS across the frequency bands.

According to an embodiment, the wireless communication system comprises a plurality of wireless communication networks, each having an associated RIS, wherein the controller entity is adapted for orchestrating and/or coordinating the contribution of the plurality of RIS across the plurality of wireless communication networks.

According to an embodiment, a device or network entity is provided that is configured for operating corresponding to a wireless communication network, a RIS device and/or a wireless communication system described herein; or for cooperating with a wireless communication network, a RIS device and/or a wireless communication system described herein.

According to an embodiment, a method for operating a wireless communication network, a RIS device and/or a wireless communication system described herein.

For example, a method for operation a wireless communications network providing for wireless communication between a first entity and a second entity, the wireless communications adapted to include a reconfigurable intelligent surface, RIS, may comprise
organising a contribution of the RIS to the wireless communication network.

For example, a method for operating a RIS device may comprise:
providing a multipath component in a wireless communication network;
controlling a property of the reconfigurable intelligent surface; and
indicating RIS information comprising at least one of:
   a RIS identifier, serial number, model number, SKU, date of manufacture, MAC address;
   a position of the RIS in space;
   a property, capability, availability, accuracy, reliability or function of the RIS
   a pointer pointing towards further information elements related with the RIS device, e.g., a database entry, a coded information such as a QR code pointing to an IP address or uniform resource locator, URL.

A method for operating a device or network entity may correspond to operate corresponding to a wireless communication network, a RIS device and/or a wireless communication system described herein; or for cooperating with a wireless communication network, a RIS device and/or a wireless communication system described herein.

According to an embodiment a computer readable digital storage medium is provided having stored thereon a computer program having a program code for performing, when running on a computer, a method described herein, e.g., having instructions for one or more devices.

According to an embodiment, a radio signal for performing the operation of a wireless communication network, a RIS device and/or a wireless communication system described herein is provided. According to an embodiment, a computer readable digital storage medium is provided having stored thereon such a signal.

A RIS may have advantages from stakeholders' perspectives
MNOs
   Going from 2.6 GHz to 3.5 GHz requires two-fold increase in number of gNBs
   Capacity is not the primary issue because of 100 MHz in C-band
   Coverage is the issue
   Repeater can fill gaps or holes (usually limited to the spectrum of one MNO)
   RIS can also infill but probably not limited to the spectrum on one MNO
End users
   Might suffer from poor coverage or interference (e.g. indoors)
   Repeaters or RIS can help
   Repeater uses MNO spectrum→requires permits
   RIS is passive and therefore no permit is required
Infrastructure OEMs
   Might lose sales volume to repeater or RIS
   Using beamforming, gNB can interact with repeater and/or RIS-created MPCs
   Provide measurements to RIS controller
   Request RIS for link enhancement or link recovery
Regulator
   To ensure EIRP_{RIS} is within required limits
   Specific absorption rate (SAR) with RIS should be considered across several bands if RIS geometry and configuration creates collimation

Based on the above, embodiments consider a RIS in future NR frameworks

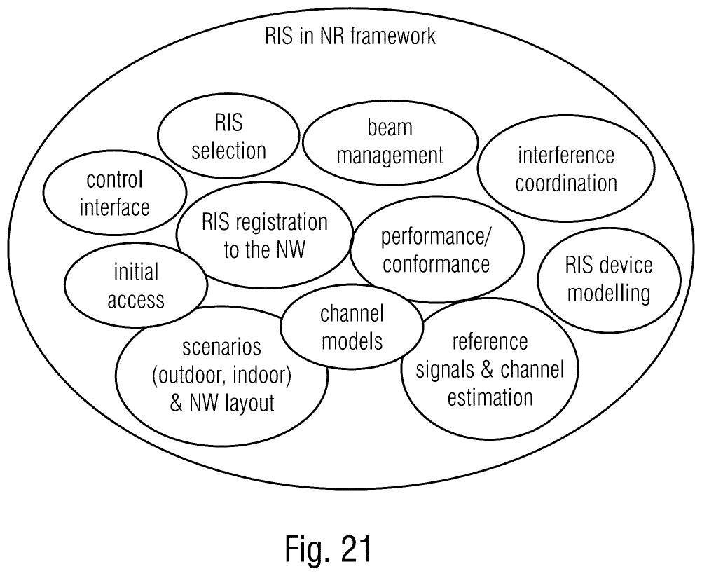

RIS implementations may cover a wide range of capabilities and features. For example, some RIS implementations may rely solely on the passive reflection of radio waves, while more advanced RISs may have signal-processing capabilities, enabling it to perform, e.g. channel estimation, leading to various implementation and deployment options. Nevertheless, one of the first stops in assessing any RIS implementation within the NR standardisation framework can be the considerations on the network-controlled repeaters, which are included as a study item in Rel-18 [7]. This is an amplify and forward (AF) repeater required to have the additional capability to process side information for on/off control, synchronisation and beamforming control while minimising complexity and cost. RISs do not perform power amplification and have no, or, in some cases, have limited signal processing. Still, some of the above identified capabilities and requirements related to the network-controlled repeater would also apply to RIS, as recognised by early standardisation discussions regarding its potential inclusion in Rel-18. RIS has not been incorporated into Rel-18, but its introduction into the NR framework will likely require a number of studies to cover a wide range of topics, as depicted by FIG. 21. These topics include aspects such as channel modelling, considering also near field propagation, simulation methodology and scenarios, RIS device modelling, and a range of PHY topics, including beam management and channel estimation [8], depending on RIS device type. There are also higher-layer aspects to be addressed, such as RIS registration, mobility and RIS selection, as well as control interface design. Embodiments relate to address one or more of the following tasks, namely:
How will RIS be integrated into a wireless network
How will its operation in a wireless network be controlled
What impact will the introduction of RIS have on the 5G-NR beam management framework
How will channel estimation be performed and what impact will the introduction of RIS have on the 5G-NR CSI framework
What impact will the introduction of RIS have on the 5G-NR interference management
   Integration of RIS into Wireless Network

Registration of RIS, including its authentication and authorisation, is one of the first steps to integrating it into the wireless network. RIS registration will enable incorporating RIS properties into wireless link management, as it is envisaged that the network/neighbouring cells will need to be updated about the actual and potential configuration states of various RIS. These configuration states updates may be highly dynamic, depending on the use case. RIS registration to the network will also address the security aspects of RIS operation. However, even in cases where RIS includes some signal processing capability, the functionality required to perform fully-fledged registration, which is present in the current 5G Layer 2 network relays (IAB nodes), is not foreseen. Furthermore, changes to the topology due to switching on/off RIS also need to be efficiently and securely communicated to the network. These functions should be available for all RIS implementations. For example, in centralised implementations, where a central RIS-controller is controlling many fully-passive RIS, RIS-controller can perform these functions on behalf of all RIS. Hence, we envisage a RIS-controller, besides controlling the configuration states of RIS, having the additional functionality to perform registration, authentication/authorisation, as well providing configuration updates on behalf of RIS. In that, it could use a form of exposure function, which would enable standardised and secure communication, providing information about RIS properties, to a e.g. base station, core network, external database or other entity.

FIG. 19 depicts one such a scenario, where a centralised RIS controller has standardised interfaces towards a panel controller and core network and provides an illustration of a centralised RIS-C deployment, where RIS-C communicates with network entities and external database using standardised interfaces FIG. 19 also depicts RIS-C interface towards an external database. Namely, different to the IAB and deployments with network-controlled repeaters, future networks with widely-deployed RIS will likely require repositories of all RIS installations belonging to or managed on behalf of different MNOs. Such repositories would invariably include RIS location, type, frequency range and other properties that may affect MNOs in the area, and would need to be dynamically updated to cater for the controllable radio environment. In this case as well, a standardised interface from RIS-controller, exposing a subset of RIS properties can be used for that purpose.

### RIS Discovery & Considerations on Beam Management

Beam management procedures in 5G-NR are aimed at establishing and maintaining a set of beam pair links, enabling downlink and uplink transmission and reception. These procedures are defined on L1/L2, and essentially include beam establishment, beam refinement and beam recovery in case of a beam failure [10]. When RIS is employed as a passive relay-type RIS, which may be one of the main scenarios in extending the NR-framework, a single link is broken into two cascading links, and there is no longer one-to-one beam pair relationship between a base station and a UE. This has implications for all phases of beam management as it's procedures rely on a frequent information exchange. Some of the aspects to take into consideration are:
As (passive) RIS does not generate synchronisation signals, which identify the cell, cell search with RIS as a passive relay will need to be considered. One of the options could be that only specific Synchronization Signal Blocks (SSBs), generated by the base station, are used to aid RIS discovery.
Although the link between the base station and RIS may be viewed as semi-static, any reconfiguration of it adds to the overhead of the beam management procedure. This is particularly relevant in case of beam tracking or beam failure recovery procedure where, e.g. a different RIS panel may need to utilised to provide beam-tracking or a new set of candidate beams.
Given that RIS may be used only on UL or DL, or that separate RIS (or separate RIS panels) may be used for UL and DL, beam correspondence will not hold, namely, determining e.g. the best receive beam at a base station, based on the best DL transmission beam. This is particularly important for the initial beam establishment, but is also valid for beam adjustment/beam tracking. In this case, separate beam management procedures for uplink and downlink will need to be applied, which creates additional overhead.

In a more advanced RIS implementation, where RIS is a part of a transmitter, e.g. a base station, RIS can take an active role in signalling and modulation [11]. Such implementation removes a hard constraint on the use of e.g. existing design for synchronisation signals, but also opens up possibilities for studying the use of techniques such as index modulation [12].

Channel Estimation with RIS

A successful RISs integration in future cellular deployments requires an extension of new radio (NR) based channel estimation in the uplink, i.e. through sounding reference signals (SRS) and corresponding sounding reference indication (SRI), as well in the downlink direction based on CSI feedback [13], [14]. FIG. 20 illustrates RIS controlled multi-path component changes in a multi-beam communication scenario for both transmitter and receiver. In general, these concepts assume a quasi-static behavior of the propagation environment, however, UL/DL reciprocity for large-scale fading (LSF) can be no longer assumed when introducing RIS in the link between the base station (BS) and user equipment (UE). As mentioned in the previous subsection, each link is now divided into a couple of cascaded links, with different channel dynamics—one between a UE and a RIS, which is highly dynamic, and the other between a base station and a RIS—semi-static. Besides this issue, it is also reasonable to assume that UL and DL communication will take place through different RIS panels on distinct locations. These issues highlight the importance of a receiver detecting a RIS specific signature and, therefore, identifying a RIS link or multi-path component. The use of wireless beacons or specific patterns, e.g. index modulation that relies on the activation states of antennas, subcarriers and other resources, combined with the 5G-NR reference signals, looks like an interesting avenue to explore for detecting and estimating RIS MPCs. Also, designing an extension to the 5G-NR signalling mechanism of transmission configuration indication (TCI), which provides information to the receiver about LSF and spatial relationship between different reference signals, will be critical.

### RIS Control

Control information exchange between the network and RIS is pivotal for the reconfiguration of the radio environment. Hence, detailed mechanisms for control interface, defining in-band or out-band control channels, delay and other requirements for optimisation of the propagation environment given different types of RIS will need to be defined. In the first instance, the NR framework is expected to address a baseline communication scenario between a UE and a base station, featuring RIS, aimed at coverage enhancement, improvement in channel rank or interference suppression. The aspects, relating to, e.g. initial access, beam management or channel estimation will typically be controlled by a base station. In addition to these, the base station will, in coordination with neighbouring base stations, need to control user scheduling in a multi-user environment, mobility management and association/connection of a UE with a RIS, which may be different for UL and DL. These multi-user, multi-RIS scenarios, which address different use cases with a multitude of performance metrics related to, e.g. coverage, rate or energy efficiency, will hugely increase the radio network optimisation complexity. The academic literature is already resorting to AI/ML for resolving complex optimisation with RIS (references). Within 3GPP, the recently approved Rel-18 SI on AI/ML [15] represents an important milestone for the use of AI/ML on the radio interface. This study, while focusing on specific use cases of, e.g. CSI feedback enhancement and beam management, will provide a guideline on how AI/ML framework for RIS may be defined in terms of model generation, inference, requirements for training data, and evaluated in terms of complexity, inference latency and other parameters.

Hence, given the expected complexity of RIS deployments, and the fact that base stations control most aspects of beam/link management, network-controlled RIS will be prevalent. There are, however, cases when placing the RIS control closer to UEs could be viable and advantageous option

### A. RIS Controlled by a UE

Specific deployment scenarios or link constellations may motivate or benefit from a RIS controlled by a UE. Two examples illustrate this:
1) A UE is connected to a satellite via a RIS reflection, circumventing non-line-of-sight (NLOS) between the UE and the satellite. In such a scenario, a single UE is benefiting from the MPCs configured via RIS, therefore the UE is the best choice for controlling RIS, e.g. via an app embedded in the terminal.

A group of UEs are located indoors and suffer from either poor coverage or from cell-edge interference. Such a channel situation is mostly recognisable by a base station, however, the means for resolving it might be limited or not efficient. Assuming the availability of a RIS in or close to the window, the RIS could provide strong MPCs to one of the base station improving SNR and/or SINR for the group of UEs. Since such a group of UEs are the beneficiaries of a suitable RIS configuration, one of them could be a good candidate to control the RIS.

A UE-centric RIS control as motivated by example 1 may be realised by an initial connection and protocol between the RIS controller and the UE. The UE could then initiate e.g. a directional scan towards the RIS and monitor received signals from the targeted satellite. Example 2 can follow the same RIS control principle as describe above, where one terminal is selected as the interface to RIS controller on behalf of the group of terminals

### B. Intervention Mechanisms for RIS Induced Interference

Deployment of RIS may be targeted to suppress interference for users in a certain area. However, RIS deployment for link optimisations, such as coverage or rate improvement will affect multiple cells, causing inter-cell interference, and a change in coverage footprint of a cell, and locality and shape of interference. Since RIS reconfiguration can vary from a rather static to a particularly dynamic case, the resulting interference will follow a similar pattern. At the same time, victim UEs or base stations may not be aware that a RIS reflection may be the root cause of a particular interference component.

5G-NR provides a comprehensive interference measurement framework through CSI-RS. There, a UE can be configured to measure interference on particular CSI-RS resources, enabling it to estimate interference within its cell and trans-missions from other cells. Furthermore, to cater to flexible TDD deployments, one of the more recent additions to the interference framework also enables a UE to measure cross-link interference, i.e. interference from the uplink transmissions nearby. Nevertheless, the underlining feature of the existing framework is that the radio propagation environment is considered non-influenceable and therefore, all mitigation and avoidance mechanisms, such as scheduling and power-control, are directed towards transmitters and receivers. The above underlines the importance of further extensions to the existing interference management framework, whereby RIS-associated MPCa (interference MPCs) can be, on one hand, identified, measured, and reported on, and on the other hand, where the identified interference measurement can be used so that suitable RISs can cancel the interference towards their respective receivers.

### C. Shared RIS Control Among Multiple MNOs

Due to the wideband reflective properties of RIS, any RIS configuration will impact radio signals from at least adjacent or nearby spectrum bands or bandwidth parts. In turn, these portions of spectrum may be operated by the same or different MNOs. Therefore, the need for RIS control coordination across several bands and MNOs is identified as an important issue to be studied with regard to system performance and standardisation impact.

Assuming a scenario where MNO-1 is deploying several RIS within the coverage footprint of one or two adjacent cells, then these RIS will create a potentially non-negligible effect on another co-deployed MNO-2 using an adjacent frequency band. Depending on the deployment correlation of MNO-1 and MNO-2 with an overlapping coverage footprint, two main cases can be distinguished:
1) Collocated or a form of quasi-collocated deployment is assumed when the base stations of MNO-1 and MNO-2 are mounted close to each other e.g. on the same mast and all antennas are facing the same directions and having similar radiation properties, e.g. site sharing or base station sharing deployments
2) A non-collocated/quasi-collocated deployment is given, when the coverage footprints of MNO-1 and MNO-2 overlap, but differences in site locations, antenna directions, radiation patterns etc. are significant.

In case 1 (collocated/quasi-collocated deployment), it is expected that the deployed RIS will have a similar impact for MPCs in the same directions, creating similar benefits for users of MNO-1 and MNO-2 as long as their users are similarly distributed, share similar terminal orientation, density and others. Hence, the users of the two networks should experience similar advantages from RIS as long as they are collocated. Consequently, a joint optimization across the two MNOs is only worthwhile if their users' distribution and link requirements are very different. In that case, inter-MNO coordinated RIS control would be beneficial and needed. In general, other collocated MNOs on the adjacent bands are also expected to benefit to a similar degree to the MNOs on the band that has the active use of RIS deployment.

In case 2 (non-collocated deployment), where base station locations of MNO-1 and MNO-2 and their antenna patterns are different, RIS, with their wide-band reflective properties, will create different MPCs and cause beneficial or disadvantageous effects on users of MNO-2. Consequently, an optimisation for MNO-1 might not result in a similar performance gain for MNO-2 or could even result in performance degradation due to increased inter-cell interference. Hence, to mitigate such im-pact of network optimisation of one MNO onto another, coordination between the RIS based network footprint optimisation should be considered. This could be facilitated by extending the existing CSI/interference management framework. For static and semi-static RIS configurations, such coordination mechanisms can be potentially assisted by machine learning and AI.

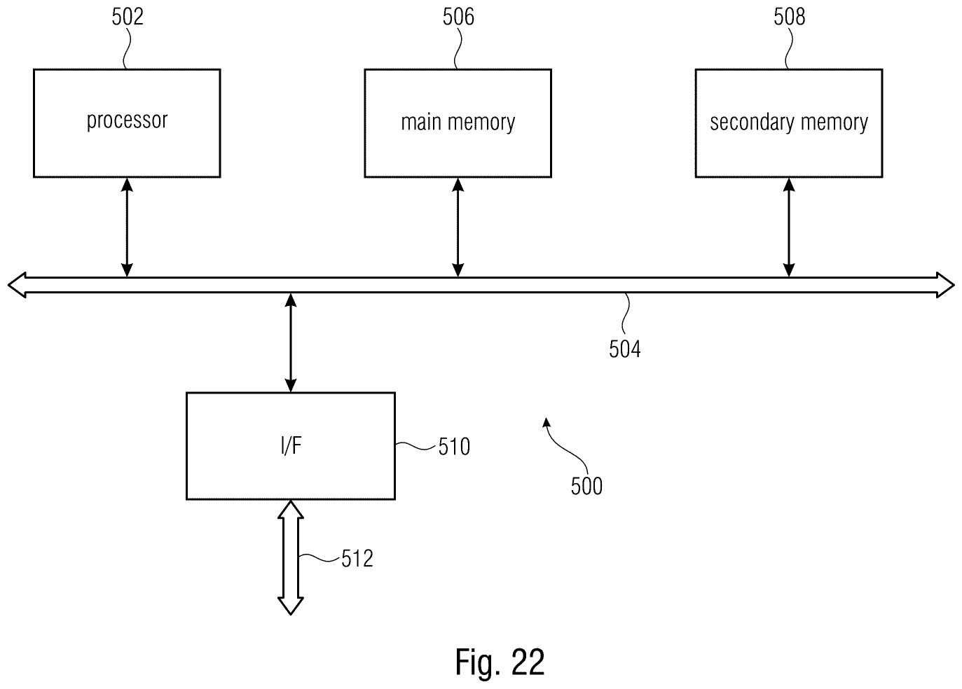

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 22 illustrates an example of a computer system 500. The units or modules as well as the steps of the methods performed by these units may execute on one or more computer systems 500. The computer system 500 includes one or more processors 502, like a special purpose or a general-purpose digital signal processor. The processor 502 is connected to a communication infrastructure 504, like a bus or a network. The computer system 500 includes a main memory 506, e.g., a random-access memory (RAM), and a secondary memory 508, e.g., a hard disk drive and/or a removable storage drive. The secondary memory 508 may allow computer programs or other instructions to be loaded into the computer system 500. The computer system 500 may further include a communications interface 510 to allow software and data to be transferred between computer system 500 and external devices. The communication may be in the from of electronic, electromagnetic, optical, or other signals capable of being handled by a communications interface. The communication may use a wire or a cable, fiber optics, a phone line, a cellular phone link, an RF link and other communications channels 512.

The terms “computer program medium” and “computer readable medium” are used to generally refer to tangible storage media such as removable storage units or a hard disk installed in a hard disk drive. These computer program products are means for providing software to the computer system 500. The computer programs, also referred to as computer control logic, are stored in main memory 506 and/or secondary memory 508. Computer programs may also be received via the communications interface 510. The computer program, when executed, enables the computer system 500 to implement the present invention. In particular, the computer program, when executed, enables processor 502 to implement the processes of the present invention, such as any of the methods described herein. Accordingly, such a computer program may represent a controller of the computer system 500. Where the disclosure is implemented using software, the software may be stored in a computer program product and loaded into computer system 500 using a removable storage drive, an interface, like communications interface 510.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### LIST OF REFERENCES

[1] S. Gong, X. Lu, D. T. Hoang, D. Niyato, L. Shu, D. I. Kim, and Y.-C. Liang, “Toward smart wireless communications via intelligent reflecting surfaces: A contemporary survey,” IEEE Commun. Surv. Tutor., vol. 22, no. 4, pp. 2283-2314, 2020.
[2] Reconfigurable Intelligent Surfaces for 6G Systems: Principles, Applications, and Research Directions
[3] E. C. Strinati, G. C. Alexandropoulos, H. Wymeersch, B. Denis, Sciancalepore, R. D'Errico, A. Clemente, D.-T. Phan-Huy, E. De Car-valho, and P. Popovski, “Reconfigurable, intelligent, and sustainable wireless environments for 6G smart connectivity,” IEEE Commun. Mag., vol. 59, no. 10, pp. 99-105, October 2021.
[4] R. Alghamdi, R. Alhadrami, D. Alhothali, H. Almorad, A. Faisal, S. Helal, R. Shalabi, R. Asfour, N. Hammad, A. Shams, N. Saeed, H. Dahrouj, T. Y. Al-Naffouri, and M.-S. Alouini, “Intelligent surfaces for 6G wireless networks: A survey of optimization and performance analysis techniques,” IEEE Access, vol. 8, pp. 202 795-202 818, 2020.
[5] M. Di Renzo, A. Zappone, M. Debbah, M.-S. Alouini, C. Yuen, J. de Rosny, and S. Tretyakov, “Smart radio environments empowered by reconfigurable intelligent surfaces: How it works, state of research, and the road ahead,” IEEE j. sel. areas commun., vol. 38, no. 11, pp. 2450-2525, November 2020.
[6] R. Liu, Q. Wu, M. Di Renzo, and Y. Yuan, “A path to smart radio environments: An industrial viewpoint on reconfigurable intelligent surfaces,” IEEE WireL. Commun., pp. 1-7, 2022.
[7] 3GPP, “Study on NR Network-controlled Repeaters,” 3rd Generation Partnership Project (3GPP), 3GPP Work Item Description RP-213700, December 2021.
[8] Sony, “Introducing Reconfigurable Intelligent Surfaces for 5G-Advanced,” Sony, TDoc RWS-210306, June 2021.
[9] C. U. ZTE, Sanechips, “Support of Reconfigurable Intelligent Surface for 5G Advanced,” ZTE, Sanechips, China Unicom, TDoc RP-210465, June 2021.
[10] E. Dahlman, S. Parkvall, and J. Skold, 5G NR: The Next Generation Wireless Access Technology. Elsevier Science, 2020. [Online]. Available: https://books.google.de/books?id=PZH9DwAAQBAJ
[11] E. Basar, “Transmission through large intelligent surfaces: A new frontier in wireless communications,” 2019.
[12] E. Basar, M. Wen, R. Mesleh, M. Di Renzo, Y. Xiao, and H. Haas, “Index modulation techniques for next-generation wireless networks,” IEEE Access, vol. 5, pp. 16 693-16 746, 2017.
[13] M. S. Rahman, E. Onggosanusi, H. Si, and J. Cho, “Csi feedback based on space-frequency compression,” in 2020 IEEE 17th Annual Consumer Communications Networking Conference (CCNC), 2020, pp. 1-6.
[14] Z. Liu, S. Sun, Q. Gao, and H. Li, “Csi feedback based on spatial and frequency domains compression for 5 g multi-user massive mimo systems,” in 2019 IEEE/CIC International Conference on Communications in China (ICCC), 2019, pp. 834-839.
[15] 3GPP, “Study on Artificial Intelligence (AI)/Machine Learning (ML) for NR Air Interface,” 3rd Generation Partnership Project (3GPP), 3GPP Work Item Description RP-213599, December 2021.

ABBREVIATIONS

| Abbreviation | Definition | Further description |
|---|---|---|
| 2G | second generation | |
| 3G | third generation | |
| 3GPP | third generation partnership project | |
| 4G | fourth generation | |
| 5G | fifth generation | |
| 5GC | 5G core network | |
| ACK | acknowledgement | |
| ACLR | adjacent channel leakage ratio | |
| AF | amplify and forward | |
| AIM | assistance information message | |
| AMF | access and mobility management function | |
| AP | access point | |
| ARQ | automatic repeat request | |
| AU | antenna unit | |
| BER | bit-error rate | |
| BLER | block-error rate | |
| BS | base station | |
| BT | Bluetooth | |
| BTS | basestation transceiver | |
| BWP | bandwidth part | |
| CA | carrier aggregation | |
| CBG | code block group | |
| CBR | channel busy ratio | |
| CC | component carrier | |
| CCO | coverage and capacity optimization | |
| CHO | conditional handover | |
| CLI | cross-link interference | |
| CLI-RSS | cross-link interference received signal | |
| CN | core network | |
| CP1 | control plane 1 | |
| CP2 | control plane 2 | |
| CQI | channel quality indicator | |
| CSI-RS | channel state information- reference signal | |
| CU | central/centralized unit | |
| D2D | device-to-device | |
| DAI | downlink assignment index | |
| DAPS | dual active protocol stack | |
| DC-CA | dual-connectivity carrier aggregation | |
| DCI | downlink control information | |
| DECT | digitally enhanced cordless telephony | |
| DL | downlink | |
| DMRS | demodulation reference signal | |
| DOA | direction of arrival | |
| DRB | data radio bearer | |
| DRX | discontinuous reception | |
| DU | distributed unit | |
| ECGI | E-UTRAN cell global identifier | |
| E-CID | enhanced cell ID | |
| eLLR | enhanced link-level report | Coined in this application |
| eNB | evolved node b | |
| EN-DC | E-UTRAN-New Radio dual connectivity | |
| EUTRA | Enhanced UTRA | |
| E-UTRAN | Enhanced UTRA network | |
| FD | fulll duplex | |
| FFT | fast Fourier transform | |
| FR1 | frequency range one | |
| FR2 | frequency range two | |
| GMLC | gateway mobile location center | |
| gNB | evolved node B (NR base station)/next | |
| | generation node B base station | |
| GNSS | global navigation satellite system | |
| GPS | global positioning system | |
| GSCN | global synchronization channel number | |
| HARQ | hybrid automatic repeat request | |
| IAB | integrated access and backhaul | |
| ICS | initial cell search | |
| ID | identity/identification | |
| IIOT | industrial Internet of things | |
| IoT | internet of things | |
| KPI | key-performance indicator | |
| LCS | location services | |
| LMF | location management function | |
| LPP | LTE positioning protocol | |
| LTE | long-term evolution | |
| MAC | medium access control | |
| MCG | master cell group | |
| MCR | minimum communication range | |
| MCS | modulation and coding scheme | |
| MDT | minimization of drive tests | |
| MIB | master information block | |
| MIMO | multiple-input/multiple-output | |
| MLR | measure, log and report | |
| MLRD | MLR device | |
| MNO | mobile network operator | |
| MPC | multi-path component | |
| MR-DC | multi-RAT dual connectivity | |
| NACK | negative acknowledgement | |
| NB | node B | |
| NCGI | new radio cell global identifier | |
| NES | network energy saving | |
| NG | next generation | |
| ng-eNB | next generation eNB | node providing E-UTRA user |
| | | plane and control plane |
| | | protocol terminations towards |
| | | the UE, and connected via the |
| | | NG interface to the 5GC |
| NG-RAN | either a gNB or an ng-eNB | |
| NR | new radio | |
| NR-U | NR unlicensed | NR operating in unlicensed |
| | | frequency spectrum |
| NTN | non-terrestrial network | |
| NW | network | |
| OAM | operation and maintenance | |
| OEM | OEM original equipment manufacturer | |
| OFDM | orthogonal frequency-division multiplexing | |
| OFDMA | orthogonal frequency-division multiple | |
| | access | |
| Open RAN | open radio access network | |
| OTT | OTT over-the-top | |
| PBCH | physical broadcast channel | |
| PC5 | interface using the sidelink channel for D2D | |
| | communication | |
| PCI | physical cell identifier | Also known as PCID |
| PDCCH | physical downlink control channel | |
| PDCP | packet data convergence protocol | |
| PDSCH | physical downlink shared channel | |
| PER | packet error rate | |
| PHY | physical | |
| PLMN | public land mobile network | |
| PLMN | public land mobile network | |
| PPP | point-to-point protocol | |
| PPP | precise point positioning | |
| PRACH | physical random access channel | |
| PRB | physical resource block | |
| PSCCH | physical sidelink control channel | |
| PSFCH | physical sidelink feedback channel | |
| PSSCH | physical sidelink shared channel | |
| PUCCH | physical uplink control channel | |
| P-UE | pedestrian UE; not limited to pedestrian UE, | |
| | but represents any UE with a need to save | |
| | power, e.g., electrical cars, cyclists, | |
| PUSCH | physical uplink shared channel | |
| QCL | quasi colocation | |
| RA | random access | |
| RACH | random access channel | |
| RAIM | receiver autonomous integrity monitoring | |
| RAN | radio access networks | |
| RAT | radio access technology | |
| RB | resource block | |
| RF | radio frequency | |
| RIM | radio access network information | |
| RIM-RS | RIM reference signal | |
| RIS | reconfigurable intelligent surface | |
| RLC | radio link control | |
| RLF | radio link failure | |
| RLM | radio link monitoring | |
| RNTI | radio network temporary identifier | |
| RP | resource pool | |
| R-PLMN | registered public land mobile network | |
| RRC | radio resource control | |
| RRS | reconfigurable reflective surface | |
| RS | reference symbols/signal | |
| RSRP | reference signal received power | |
| RSRQ | reference signal received quality | |
| RSSI | received signal strength indicator | |
| RSTD | reference signal time difference | |
| RTOA | relative time of arrival | |
| RTT | round trip time | |
| RU | radio unit | |
| SA | standalone | |
| SBI | service based interface | |
| SCG | secondary cell group | |
| SCI | sidelink control information | |
| SDU | service data unit | |
| SI | system information | |
| SIB | sidelink information block | |
| SINR | signal-to-interference-plus-noise ratio | |
| SIR | signal-to-interference ratio | |
| SL | sidelink | |
| SNR | signal-to-noise ratio | |
| SON | self-organising network | |
| SOTA | state-of-the-art | |
| SPI | system presence indicator | |
| SR | smart repeater | |
| SRS | sounding reference signal | |
| SS | synchronization signal | |
| SSB | synchronization signal block | |
| SSID | service set identifier | |
| SS-PBCH | sounding signal/physical broadcast | |
| SSR | state space representations | |
| sTTI | short transmission time interval | |
| TAC | tracking area code | |
| TB | transport block | |
| TDD | time division duplex | |
| TDOA | time difference of arrival | |
| TIR | target integrity risk | |
| TRP | transmission reception point | |
| TSG | technical specification group | |
| TTA | time-to-alert | |
| TTI | transmission time interval | |
| UCI | uplink control information | |
| UE | user equipment | |
| UL | uplink | |
| UMTS | universal mobile telecommunication system | |
| URLLC | ultra-reliable low latency communication | |
| UTRAN | universal trunked radio access network | |
| V2I | vehicle-to-infrastructure | |
| V2N | vehicle-to-network | |
| V2P | vehicle-to-pedestrian | |
| V2V | vehicle-to-vehicle | |
| V2x | vehicle-to-everything | |
| VoIP | voice over Internet protocol | |
| VRU | vulnerable road user | |
| V-UE | vehicular UE | |
| WCS | wireless communication system | |
| WI | work item | |
| WLAN | wireless local area network | |
| WUS | wake-up signal | |

1. A device such as a user equipment, UE, configured for operating in a wireless communications network that provides wireless communication between a first entity and a second entity, the wireless communication adapted to comprise a reconfigurable intelligent surface, RIS;
wherein the device is configured or configurable for determining a RIS specific parameter to acquire a feedback information;
wherein the device is to report, to the wireless communication network, a feedback that comprises the feedback information.

2. The device of claim 1, wherein the RIS specific parameter is related to a RIS-specific function or a multi-path component, MPC, of the wireless communication provided or contributed by the RIS.

3. The device of claim 1, wherein the RIS specific parameter comprises at least one of
a reflection state of the RIS;
a position of the RIS;
an orientation of the RIS;
a direction of a multi path component provided or contributed by the RIS;
a polarization or frequency translation; and
a capability of the RIS.

4. The device of claim 1, wherein the feedback is at least a part of a measurement report provided by the device.

5. The device of claim 1, wherein the device is to determine the RIS specific parameter to indicate a beam generated or reflected by the RIS.

6. The device of claim 1, wherein the device is configured or configurable to participate in a procedure to determine a communication configuration of the wireless communication in which the device is the first entity and according to which an optimization of a communication parameter is acquired at least for a wireless communication between the second entity and the RIS; between the device and the RIS; and/or between the first entity and the second entity via the RIS; to acquire the RIS-specific parameter as indicating a result of the procedure.

7. The device of claim 1, wherein the device is configured or configurable to provide the feedback information to indicate a channel property and/or about a link quality of a wireless communication link used by the device.

8. The device of claim 7, wherein the channel property indicated in the feedback information relates to a multipath component, MPC, associated with a use of a RIS of the wireless communication network; and/or
wherein the link quality indicated in the feedback information relates to a link comprising a multipath component, MPC, associated with a use of a RIS of the wireless communication network.

9. A method to determine a communication setting in a wireless communications network that provides wireless communication between a first entity and a second entity, the wireless communication adapted to comprise a reconfigurable intelligent surface, RIS, the method comprising:
operating the first entity to use a multipath component, MPC, of the wireless communication network provided or contributed by the RIS;
operating the second entity to use the MPC;
changing at least one of a first operation parameter of the first entity with respect to the use of the MPC; a second operation parameter of the second entity with respect to the use of the MPC; and a configuration parameter of the RIS to change the MPC; and
evaluating a result of the changing to determine the communication setting that matches a predefined communication criterion.

10. A wireless communications network providing for wireless communication between a first entity and a second entity, the wireless communication adapted to comprise a reconfigurable intelligent surface, RIS;
wherein the wireless communication network comprises a controller unit preconfigured, configured or configurable for organising a contribution of the RIS to the wireless communication network.

11. The wireless communication network of claim 10, wherein the controller unit is part of a base station or a user equipment being the first entity

12. The wireless communication network of claim 10, wherein a device of the wireless communication network being one of the first and second entity is configured or configurable for determining a RIS specific parameter to acquire a feedback information; wherein the device is to report, to the wireless communication network, a feedback that comprises the feedback information; and is configured or configurable to provide the feedback information to indicate a channel property and/or about a link quality of a wireless communication link used by the device; wherein the wireless communication network or an entity thereof is adapted to determine, from the feedback information a configuration parameter of a wireless communication link between the first entity and the second entity using the RIS and/or to perform link optimization of the link.

13. The wireless communications network of claim 10, wherein the controller unit is configured for discovering the RIS and to provide a signal to the wireless communications network to comprise the RIS into the wireless communication to organise the contribution of the RIS.

14. The wireless communications network of claim 13, wherein for discovering the RIS, the controller unit is adapted for accessing measurement results, e.g., based on a reference signal, validating and/or verifying a RIS or a multipath component, MPC, provided/contributed by the RIS to the wireless communication.

15. The wireless communications network of claim 13, wherein for discovering the RIS, the controller unit is configured for initiating, instructing, requesting measurements or measurement reports of the contribution of a RIS to the wireless communication, e.g., based on a reference signal, validating and/or verifying a RIS or a multipath component, MPC, provided/contributed by the RIS to the wireless communication.

16. The wireless communications network of claim 10, wherein the controller unit is configured for discovering a multipath component, MPC, provided by the RIS and to report the MPC to the wireless communications network; wherein the wireless communications network is configured for using the MPC responsive to the report.

17. The wireless communications network of claim 16, wherein the controller unit is configured for discovering, identifying, recognising and/or detecting the MPC based on at least one of
a measurement performed by an entity internal or external to the wireless communications network;
a reference signal transmitted by an entity internal or external to the wireless communications network;
accessing a database;
perform a validation of the MPC;
perform a verification of the MPC.

18. The wireless communications network of claim 16, wherein the RIS, e.g., deployed in a radio propagation environment such as the wireless communications network is identifiable; wherein the RIS or an MPC provided by the RIS is part of a channel measurement and reporting procedure in the wireless communications network and/or of an optimization of one or more links between network nodes in the wireless communication network.

19. The wireless communications network of claim 16, wherein the controller unit is configured for evaluating an association of a detected MPC with the RIS or a different RIS or with a plurality of RISs.

20. The wireless communication network of claim 16, wherein the MPC forms a part of a communication between the first entity and the second entity in the wireless communication network, wherein the MPC is based or dependent on a location of a first entity, of a second entity and/or on a location of the RIS or on the locations of a plurality of RISs.

21. The wireless communications network of claim 16, wherein the controller unit is configured for discriminating between a RIS-related MPC and a non-RIS related MPC; wherein at least one of the first entity, the second entity and the controller unit are configured for deciding about using the RIS-related MPC for the wireless communication based on the MPC-related information.

22. The wireless communications network of claim 21, wherein the MPC-related information comprises at least one of:
a capability information associated with the RIS;
an availability information associated with the MPC;
a characteristic of the MPC;
a cost for using the MPC.

23. The wireless communications network of claim 21, wherein the controller unit is configured for discriminating the RIS-related MPC from the non-RIS related MPC based on a measurement performed by an entity internal or external to the wireless communications network; e.g. based on a reference signal, RS, transmitted by an entity internal or external to the wireless communications network.

24. The wireless communication network of claim 23, wherein the RIS comprises a plurality of RIS sub-structures such as sub-panels that are configurable as separate RISs, wherein each sub-structure is associated with a sub-structure specific MPC identifiable e.g. based on a reference signal, RS.

25. The wireless communication network of claim 24, wherein a predetermined activation pattern of at least one of sub-carriers, time-slots and RIS panels and/or their activation order is implemented; wherein a device in the wireless communication network is configured, e.g. via a system information block, SIB, RRC, to measure on these RSs according to the predetermined activation patterns.

26. The wireless communications network of claim 10, wherein the controller unit is configured for identifying the RIS and to associate a RIS identifier with the RIS so as to distinguish the RIS from a different RIS in the wireless communications network; wherein the wireless network is adapted for wireless communication by selectively using the RIS based on the RIS identifier to organise the contribution of the RIS.

27. The wireless communications network of claim 26, wherein the controller unit is configured for associating a capability information comprising at least one of:
a position of the RIS;
an orientation of the RIS;
an operating frequency range [band] of the RIS;
a phase shifting capability of the RIS comprising granularity of phase shifts;
a beamforming capability of the RIS;
a polarization capability of the RIS;
an operating mode of the RIS;
operating frequency;
an availability of the RIS;
an ownership [responsibility/provider] of the RIS;
with the RIS identifier to organise the contribution of the RIS.

28. The wireless communication network of claim 27, wherein at least one of the first entity, the second entity and the controller unit is configured for controlling the communication and/or the RIS using the RIS identifier and dependent from the capability information.

29. The wireless communication network of claim 28, wherein at least one of the first entity, the second entity and the controller unit has access to a database having stored therein a plurality of RIS identifiers and associated capability information and is configured for selecting a RIS for forming a part of the communication dependent from the capability information.

30. The wireless communications network according to claim 26, wherein the controller unit is configured for identifying the RIS and at least one sub-structure, e.g., a subpanel, thereof; wherein the controller unit is configured for providing the RIS identifier and for associating a sub-structure identifier with the sub-structure; wherein the controller unit is configured for providing the sub-structure identifier.

31. The wireless communication of claim 26, wherein the controller unit is configured for acquire or perform a measurement result, e.g., based on a reference signal, RS, a validation result and/or a verification result for identifying the RIS.

32. The wireless communication network of claim 26, wherein the RIS is associated with the RIS identifier in the wireless communication network; and wherein the RIS comprises at least one sub-structure, the sub-structure associated with a sub-structure identifier; and associated with the RIS identifier forming a main ID for one or more sub-structures of the RIS.

33. The wireless communication network of claim 26, wherein the RIS identifier uniquely identifies the RIS in space and/or its configuration.

34. The wireless communication network of claim 26, wherein the controller unit is adapted for identifying the RIS and/or capabilities of the RIS based on a network exposure function.

35. The wireless communication network of claim 34, wherein the exposure function defines different levels of functionality, e.g., depending on whether a RIS interface is intra-system or inter-system.

36. The wireless communication network of claim 34, wherein the exposure function provides for a registration of the RIS.

37. The wireless communication network of claim 34, wherein the RIS comprises an interface for providing the exposure function, wherein the interface is configured for operating in-band or out-of-band of the wireless communication network for the exposure function.

38. The wireless communications network of claim 10, wherein the controller unit is configured to acquire information about the RIS and to provide the information to at least one of:
a base station;
a neighbouring cell;
a user equipment.

39. The wireless communications network of claim 10, being configured for changing an operating mode of the RIS for the wireless communication.

40. The wireless communications network of claim 39, wherein the operating mode is changed to one of:
a coverage enhancement mode;
a signal-processing based mode;
an interface mitigation mode
a power optimization mode;
a sensing mode [could comprise surveillance/observation]

41. The wireless communication network of claim 39, configured for changing the operating mode
statically;
semi-statically, e.g., using predefined or calculated phase shift values; and/or
dynamically, e.g., using predefined or calculated phase shift values

42. The wireless communication network of claim 39, wherein changing the operating mode is related to at least one of
coverage enhancements (e.g., RSRP-based);
signal-processing based, e.g., to perform beam tracking for a certain time duration such as a few milliseconds; and/OR
tight interaction with a connected device such as a gNB or UE and its operating mode e.g., enhanced zero-forcing, minimum mean-squared error, MMSE, MRC/CoMP, or an operating parameter e.g. symbol duration, slot, sub-frames, frame or an operating schedule.

43. The wireless communication network of claim 39, wherein changing the operating mode and/or maintaining an operating mode comprises, by the wireless communication network, an open-loop and/or a closed-loop control.

44. The wireless communication network of claim 39, wherein changing the operating mode and/or maintaining an operating mode comprises, by the wireless communication network, a measurement procedure between at least one transmitter and at least one receiver of the wireless communication network, e.g., having the RIS therebetween.

45. The wireless communication network of claim 39, wherein the controller unit is configured for distinguishing between a reconfigurable multipath component, MPC, provided by the RIS and a non-configurable MPC-contribution, e.g., from a collocated scatterer such as based on a measurement, a reference signal, RS, an exposure function, a data base or the like.

46. The wireless communication network of claim 10, wherein the controller unit is to organise the contribution of the RIS by controlling an effect of the RIS on at least one multipath component, MPC, e.g., by controlling the RIS, for example, in an open-loop or closed-loop manner.

47. The wireless communication network of claim 46, wherein input for the open-loop or closed-loop control are provided by the controller unit, a UE of the wireless communication network, a gNB of the wireless communication network, a regulator of the wireless communication network, over-the-top, OTT entities of the wireless communication network, another mobile network operator, MNO, a scheduled or event based instruction of the wireless communication network.

48. The wireless communication network of claim 10, wherein the controller unit is to organise the contribution of the RIS controlling e.g., at least one desired or useful signal in a multi-user scenario, e.g. one user in the middle and the other user at the edge of coverage, for example, based on RIS sub-panels, frequency-band-dependent, based on a measurement, a scheduling and/or a data base.

49. The wireless communication network of claim 10, wherein the controller unit is to organise the contribution of the RIS by bandwidth part, BWP switching or frequency band switching.

50. The wireless communication network of claim 10, wherein the controller unit is to organise the contribution of the RIS based on an implication/action/functionality associated with CSI reporting/availability delay or channel quality being unacceptable.

51. The wireless communication network of claim 10, wherein the controller unit is to organise the contribution of the RIS based on measurements collected from receivers belonging to more than one mobile network operator, e.g., using corresponding interfaces and/or protocols.

52. The wireless communication network of claim 10, wherein the controller unit is to organise the contribution of the RIS by controlling at least one of:
the complete RIS,
multiple RIS in parallel or in series,
sub-panels, e.g. forming co-prime structures etc., a selection of codebooks to be applied to the structures or other more adaptive ways similar to digital beamforming,
any combination thereof.

53. The wireless communication network of claim 10, wherein the RIS contributes to a communication in at least a first cell and a second cell being part of the same or of different wireless communication networks;
wherein the RIS is associated with one cell of the first and the second cells as a primary RIS cell and wherein the RIS is associated with the other cell of the first and the second cells as a secondary cell being subordinated to the primary cell, e.g., in terms of requesting and controlling reconfiguration of the particular RIS or its contribution.

54. The wireless communication network of claim 53, being configured for forwarding a configuration request from devices associated with the primary cell and/or the secondary cell directly or indirectly, e.g., using a gNB to gNB over e.g. X2, to the primary cell, e.g., a base station thereof; wherein the wireless communication network is configured for processing the configuration request;
wherein the controller unit associated with the primary cell is adapted for coordinating/orchestrating a RIS configuration considering inputs/requests from intra-primary-cell end-to-end links, intra-secondary-cell end-to-end links, inter-cell configuration requests and/or measurement reports.

55. The wireless communication network of claim 10, wherein, the controller unit is configured for receiving a request for a RIS reconfiguration or a report about a multipath component, MPC, comprising the RIS:
Initiated/provided by a first network device to which a RIS is being/became part of an e2e link in a wireless communication system, WCS
Initiated/provided by a second network device directly or indirectly connected to the first network device that acts as a forwarder/proxy for the second device, e.g., experiencing the RIS associated to at least one of its end-to-end, e2e, MPCs.

56. The wireless communication network of claim 10, wherein the RIS controller is adapted for considering inputs such as reports and/or requests from a plurality of bands and/or several MNOs for controlling and configuring the RIS.

57. The wireless communication network of claim 10, wherein the RIS is a first RIS, wherein the controller unit is for organising a contribution of a plurality of RIS comprising the first RIS, the plurality of RIS being operated by a same or by different mobile network operators.

58. The wireless communications network of claim 10, wherein the RIS is part of a first section of the wireless communication network and a second section of the wireless communication network; wherein the controller unit is configured for negotiating a use of the RIS for the first section and the second section; and/or
wherein the RIS contributes to the wireless communication inside the wireless communication network and to a communication outside the wireless communication network; wherein the controller unit is configured for negotiating with a controller unit at least influencing the wireless communication outside the wireless communication network about a use of the RIS.

59. The wireless communication network of claim 58, wherein the first section is controlled by a first network operator, wherein the second section is controlled by a second network operator.

60. The wireless communication network of claim 59, wherein the controller unit as adapted to negotiate at least one of an interface, a protocol and a schedule associated with the RIS between the network operators.

61. The wireless communications network of claim 10, being configured for identifying and/or registering the RIS to the network and/or a network entity, e.g., by the controller unit or the RIS itself as a network entity.

62. The wireless communications network of claim 10, being configured for determining a master controller of the RIS, e.g., having impact to several links of the same or different MNOs, e.g., by the controller unit.

63. The wireless communications network of claim 10, being configured for determining or controlling at least one entity to be able to request an action from the RIS, e.g., users similar to DL-beamforming or MNOs similar to a repeater configuration, priorities, authorities, e.g., by the controller unit.

64. The wireless communications network of claim 10, being configured for determining or controlling at least one entity to be able to request an action from the RIS and at least a further r network entity, e.g. a gNB or a UE or a further RIS.

65. The wireless communications network of claim 10, being configured for reconfiguring at least one multipath component, MPC in a static or slow manner and/or in a dynamic or fast manner, e.g., by the controller unit.

66. The wireless communications network of claim 10, being configured for configuring one or more RIS for supporting one or more MPCs of at least one wireless link; and for updating a configuration of the one or more RIS at a time scale, e.g., static, slow, dynamic, fast, corresponding to a coherence time of the wireless signal transferred using the MPCs relevant to the wireless link(s), the update initiated by the controller unit.

67. The wireless communications network of claim 10, being configured for calibration of the RIS, evaluation of the process of aging, e.g., of a metasurface and/or the impact of the environment on the accuracy, e.g., by the controller unit.

68. The wireless communications network of claim 10, being configured for providing information or instructions to at least one apparatus/entity of the wireless communication network, for example, UEs, where the apparatus may use a multipath component, MPC, wherein the apparatus is requested to assist in calibration or contribution of the RIS, or determining whether RIS is properly calibrated or contributing/performing correctly, e.g., by the controller unit.

69. The wireless communications network of claim 10, being configured for orchestrating a plurality of RIS contributing for a communication between a plurality of entities in the wireless communication network.

70. The wireless communications network of claim 69, being configured for orchestrating the plurality of RIS to achieve an overall optimisation result for the wireless communication.

71. The wireless communications network of claim 69, wherein the plurality of RIS are deployed by same or different mobile network operators, MNOs.

72. The wireless communications network of claim 10, wherein the RIS is configured, e.g., through a RIS controller, for providing at least one of:
a registration in the wireless communications network;
an identification in the wireless communications network;
a confirmation for confirming a received command and/or a configuration;
a request of coordinated actions with a gNB and/or other RIS
an exposure to the wireless communication network;
a capability of the RIS, e.g., using a capability report;
a validation of the RIS, e.g., using a validation report;
a verification of the RIS, e.g., using a verification report
an authenticity of the RIS, e.g., using an authenticity report

73. The wireless communication network of claim 72, wherein the RIS is configured for a provision via a database or via the RIS itself.

74. The wireless communications network of claim 10, wherein the controller unit is configured for mapping commands for the RIS to transport and/or control channels of the wireless communications network, the commands, e.g., broadcasted by a gNBs of the wireless communications network e.g. in a master information block, MIB, or system information block, SIB.

75. The wireless communication network of claim 10, wherein the controller unit is implemented at least in parts at the first entity and/or the second entity and/or a central entity of the wireless communication network.

76. The wireless communication network of claim 10, wherein in connection with changing/controlling one multipath component, MPC, at least one member of the wireless communication network is adapted for measuring/observing an effect on the DL and/or UL channel of a wireless end-to-end (e2e) link of the wireless communication network a wireless transmitter and a wireless receiver placed between the start and the end of the wireless link and/or a part thereof, e.g., a half-way.

77. The wireless communication network of claim 10, being configured for providing a measurement feedback and/or action request from a receiving network entity; wherein the receiving network entity is part of a particular e2e wireless link or of another link; operated in a same or different band, by a same or different gNB in a same or different cell or by a same or different MNO.

78. The wireless communication network of claim 77, wherein a measurement being subject of feedback is performed and/or reported by at least one of:
a gNB/base station end of the wireless link, e.g. uplink
a UE end of the wireless link, e.g. downlink
the RIS along the e2e link
another network element, e.g. a repeater in the e2e link
any other receiver equipped network element which is not part of the particular e2e wireless link to be optimized or reported about wherein such said receiver is subject to a change of received signal originating from the transmitter (start) of the e2e wireless link itself or from the RIS involved in the e2e link, e.g. as becoming a victim of interference.

79. The wireless communication network of claim 76, wherein the wireless communication network is configured for transmitting a control message or a further control message to a RIS controller or to a different network element involved in the e2e wireless link with the RIS.

80. The wireless communication network of claim 79, wherein the control message or the further control message comprises at least one of:
a selection of specific configurations or configuration parts (input angle vs. output angle at the RIS)→similar to type I feedback
a combination of specific configurations or configuration parts with and w/o particular weighting→similar to type II feedback
a request to increase or reduce a particular signal strength into a particular direction/sector/spatial segment
a request to reduce interference power
a request to avoid or configure particular phase and/or amplitude of a reflected signal.

81. The wireless communication network of claim 10, wherein the wireless communication network is configured for mapping a signal to a RIS controller to an available transport channel of the wireless communication network which provides a direct or indirect connectivity between the reporting/requesting network element and the RIS controller.

82. The wireless communication network of claim 10, comprising a middleman-like entity or an aggregation point device to receive feedback/requests from one or multiple entities, and configured for prioritizing/ordering/merging/weighting/selecting/combining or otherwise pre-processing the received signals before forwarding a result thereof to the RIS controller as input/feedback values.

83. The wireless communication network of claim 10, comprising a single controller or a multitude of controllers for controlling the RIS.

84. The wireless communication network of claim 10, configured for changing a configuration of the RIS based on assignment of radio resources within a frame structure, a slot structure or a symbol length and/or structure or configuration of the wireless communication network.

85. The wireless communication network of claim 10, configured for changing a configuration of the RIS synchronised and coordinated with beamforming at the at least one of the first entity and the second entity, e.g., a gNB, wherein the wireless communication network is adapted to control the RIS to serve as a distributed virtual Transmission/reception Point (TRP).

86. The wireless communication network of claim 10, wherein at least one of the first entity and the second entity comprises at least one of:
a base station;
a repeater;
an IAB node;
a relay node;
a user equipment;
a central entity of the wireless communication network, e.g. a third party controller, RNC, core network, CN.

87. The wireless communication network of claim 10, wherein the controller unit is configured/adapted for changing the contribution of a RIS-created MPC
statically;
semi-statically and/or
dynamically.

88. The wireless communication network of claim 87, wherein the controller unit is adapted for changing the contribution in intervals or sequences regularly or irregularly.

89. The wireless communication network of claim 87, wherein the controller unit is adapted for changing the contribution of a RIS-created MPC based on a known or predicted behaviour of a changing radio propagation environment providing an impact to link management, link optimization and resource scheduling of one and/or a plurality of end-to-end, e2e links of the wireless communication network.

90. The wireless communication network of claim 87, wherein the controller unit is for aligning a RIS configuration to changes in accordance with an assignment of radio resources, e.g., aligned and/or synchronized with, at least one of:
a radio frame period of the wireless communication network;
a slot period of the wireless communication network;
a symbol period of the wireless communication network;
a short symbol period of the wireless communication network;
a combination of the above.

91. The wireless communication network of claim 90, wherein the alignment is with respect to a communication link within a primary cell or a secondary cell to which the RIS contributes.

92. A reconfigurable intelligent surface, RIS, device, comprising:
a reconfigurable intelligent surface configured for providing a multipath component in a wireless communication network;
a RIS panel control unit configured for controlling a property of the reconfigurable intelligent surface;
wherein the RIS panel control unit is configured for indicating RIS information comprising at least one of:
a RIS identifier, serial number, model number, SKU, date of manufacture, MAC address;
a position of the RIS in space;
a property, capability, availability, accuracy, reliability or function of the RIS
a pointer pointing towards further information elements related with the RIS device, e.g., a database entry, a coded information such as a QR code pointing to an IP address or uniform resource locator, URL.

93. The RIS device of claim 92, wherein the RIS panel control unit is configured for indicating the RIS information using a network exposure function of the wireless communication network; or using a random access message.

94. The RIS device of claim 92, wherein the RIS device comprises a transmitter unit configured for transmitting the RIS information using a signal and using downlink resources and/or uplink resources of the wireless communication network.

95. The RIS device of claim 92, wherein the RIS device is adapted for providing the information on RIS capabilities and/or for reconfiguring a sub-structure such as a RIS sub-panel based on a request for reconfiguration received from a network entity, e.g. a RIS controller.

96. The RIS device of claim 92, wherein the RIS device is adapted for transmitting, e.g., to the wireless communication network, at least one of:
a message for registration, identification of the RIS, e.g., to a gNB and/or UEs
a message for confirmation of commands/configurations
a message for requesting coordinated actions with a gNB and/or other RIS/RRS
a message for disclosing/exposing capabilities to the network (gNBs and/or UEs)
a RIS identifier, serial number, model number, SKU, date of manufacture, MAC address;
a position of the RIS in space;
a property, capability, availability, accuracy, reliability or function of the RIS.

97. The RIS device of claim 92, wherein the RIS device comprises a RIS panel controller and a RIS element controller, e.g., being part of a RIS sub-structure, configured for controlling a RIS element or the RIS sub-structure; wherein a communication link between the RIS controller and the RIS panel controller is implemented for at least one of:
using at least one frequency band or bandwidth part, BWP, the RIS is operating on in the end-to-end, e2e, communication link(s), e.g., by providing a multipath component
using a frequency band or BWP being different from the band or BWP the RIS is configurable for in the e2e communication links,
Using the same radio access technology, RAT, like the e2e communication link(s) where the RIS is part of,
using a same message format as used to communicate between other non-RIS network elements in the wireless communication network;
using a different message format e.g. special messages according to a new radio control channel, NRCC, specification
using a different RAT than the e2e communication link(s) are using where the RIS is part of, OR
using a wireless communication network entity or element e.g. a gNB or UE, that belongs to the same or different MNO when compared to a RIS panel.

98. The RIS device of claim 92, wherein the RIS device comprises a receiver unit that is configured for operating on at least one frequency/band where another device of the wireless communication network operates, e.g. a base station is operating on using a standardized wireless protocol (3GPP comprising 5G-NR) and sending control signals to the RIS receiver.

99. The RIS device of claim 92, wherein the RIS device is configured for receiving a message indicating information for the RIS about at least one configuration state to be configured/adapted/selected/activated by the RIS, the message originating from:
a RIS controller, e.g., in case the RIS controller is not collocated with the RIS panel;
a network entity involved in a wireless communication link to which the RIS device contributes; wherein the RIS controls a multipath component, MPC, of the RIS device and the RIS controller is at least partially collocated with the RIS panel.
a network element involved in a wireless communication link to which the RIS device contributes; wherein the RIS controls a multipath component, MPC, of the RIS device and the RIS controller is at least partially collocated with the network entity, e.g. a gNB or a UE and to operate accordingly.

100. The RIS device of claim 99, wherein the RIS device is configured for receiving the message in:
a downlink direction, e.g., from a gNB/base station to the RIS receiver
a PDSCH (Physical Downlink Shared Channel) using system information blocks SIBs or User plane data mapped as unicast or multicast message
a PDCCH (Physical Downlink Control Channel) and/or downlink control information, DCI
SSB (System Synchronisation Block), e.g., via a MIB (Master Information Block)
Control Information Elements (CORESET is a set of physical resources and it carries PDCCH/DCI)
Coresets (coresets can comprise information elements for individual users, a group of users or all users and can therefore be used to address an individual RIS or a group of RIS.
and/or
an uplink direction, e.g. from a UE to the RIS receiver
a message mapped into RACCH message space
an ACK/NACK or any other kind of response messages corresponding to a particular DL communication protocol, e.g. gNB and UE are establishing a bi-directional control link, wherein the RIS is in listening mode/role.

101. The RIS device of claim 99, wherein the RIS device is configured for receiving the message encrypted or non-encrypted.

102. RIS device of claim 99, wherein the RIS device is configured for receiving the message so as to require or not require feedback e.g. ACK/NACK from the recipient and to operate accordingly.

103. RIS device of claim 99, wherein the RIS device is configured for receiving the message using a radio access technology, RAT, different from a RAT used for e2e communication, e.g. WiFi, NB-IoT, optical or cable connections and/or to exchange control messages from and between the RIS controller and the RIS.

104. A wireless communication system comprising at least one wireless communication network and a centralised or decentralised controller entity for organising a contribution of at least one reconfigurable intelligent surface, RIS, to wireless communication in the wireless communication system.

105. The wireless communication system of claim 104, operating in a plurality of frequency bands, the wireless communication system having a plurality of RIS associated to same or different frequency bands, wherein the controller entity is adapted for orchestrating and/or coordinating the contribution of the plurality of RIS across the frequency bands.

106. The wireless communication system of claim 104, comprising a plurality of wireless communication networks, each having an associated RIS, wherein the controller entity is adapted for orchestrating and/or coordinating the contribution of the plurality of RIS across the plurality of wireless communication networks.

107. A device or network entity configured for operating corresponding to a wireless communication network, a RIS device and/or a wireless communication system described herein; or for cooperating with a wireless communication network, a RIS device and/or a wireless communication system described herein.

108. A method for operating a wireless communication network, a RIS device and/or a wireless communication system described herein.

109. A non-transitory digital storage medium having a computer program stored thereon to perform the method according to claim 9 or the method for operating a wireless communication network, a RIS device and/or a wireless communication system described herein,
when said computer program is run by a computer.

110. A signal for performing the operation of a wireless communication network, a RIS device and/or a wireless communication system described herein.

111. A computer readable digital storage medium having stored thereon a signal according to claim 110.
